(19) United States
(12) Patent Application Publication
(10) Pub. No.: US 2017/0083769 A1
(43) Pub. Date: Mar. 23, 2017

(54) Method For Segmenting And Annotating Recorded Video Of Tennis Play Based On Motion/Position Of Players And Tennis Ball In Video

(71) Applicant: ZonalTennis LLC, Austin, TX (US)

(72) Inventor: Christo Van Rensburg, Austin, TX (US)

(73) Assignee: ZonalTennis LLC, Austin, TX (US)

(21) Appl. No.: 15/268,314

(22) Filed: Sep. 16, 2016

Related U.S. Application Data
(60) Provisional application No. 62/220,795, filed on Sep. 18, 2015.
(60) Provisional application No. 62/275,918, filed on Jan. 7, 2016.

(51) Int. Cl. G06K 9/00; H04N 5/247; H04N 5/77; A63B 71/02

(52) U.S. Cl. CPC G06K 9/00724; A63B 71/02; H04N 5/247; H04N 5/77; A63B 2225/50

(57) ABSTRACT

Methods and systems for training a tennis player based upon the recorded, preferably the video recorded, location of the player's feet on a court during a tennis racquet stroke during an actual tennis match and providing training to the player based upon an analysis of the match by overlaying the video recording of the player's shots with an outline of a partitioned court including segments which may be numbered, lettered, color coded or all three. Preferably, the analysis is performed at a location remote from the player and the match.

### CROSS-REFERENCE TO RELATED APPLICATIONS

This application claims the benefit of U.S. Provisional Patent Application No. 62/220,795 filed Sep. 18, 2015 and U.S. Provisional Patent Application No. 62/275,918 filed Jan. 7, 2016, the contents of which are incorporated herein by reference in their entirety.

### TECHNICAL FIELD

The present disclosure relates generally to systems and methods for automatically providing customized training instruction and feedback to a sports player based on recorded play, in particular for tennis.

### BACKGROUND

Several systems for capturing and analyzing tennis play and providing feedback have been developed.

US 2015/0018990 teaches a Smart-court system, adaptive to a constrained sport environment, for enabling real time analysis and debriefing of sport activities is provided herein. The Smart-court system is comprised of: (i) an automatic recording system comprising a plurality of video cameras located in a court, arranged to real-time (RT) recording of a sport session and utilizing an automatic calibration and stabilization module; and (ii) a data processing system comprising: (a) a capture module for grabbing a video stream; (b) an objects' detector module arranged to extract during the RT sport session, the objects from the foreground of each frame; (c) an event module for automatically analyzing, the motion and the activities of the tracked objects for automatically identifying and classifying events, creating a synchronized event log and calculating statistics that occurred during the RT sport session; and (d) a presentation module enabling to perform instant debriefing, combined biomechanical and tactical analysis of the video.

US 2014/0180451 teaches a system designed to capture and analyze a trajectory of a tennis ball during various activities related to the play of a game of tennis. The system may be configured to provide immediate feedback that may be utilized by a player to improve their performance as well as provide entertainment value above and beyond what is normally associated with the play of a game of tennis. Further, the system may be operable for use in an area where tennis is normally played during normal playing activities, such as player playing a game or practicing on an outdoor tennis court. The system may be operable to account for factors associated with its ambient environment, such as wind, temperature and humidity.

US 2006/0252017 teaches the definition of the dynamic movement parameters of a material object during sports competitions or training and makes it possible to improve a judgment objectivity during said sports competitions. A footmark trajectory resulting from the interaction of an object with surrounding objects or environment is recorded in an infrared spectral range. The dynamic of modifications of infrared footmarks in different spectral ranges are recorded. The trajectories of shadows formed by external infrared sources are recorded. The system comprises an infrared camera, a computer and a mechanical oscillation receiver. Said infrared camera can be provided with a system of optical filters for modifying the spectral range of the sensitivity thereof.

### SUMMARY OF THE PREFERRED EMBODIMENTS OF THE INVENTION

In accordance with the teachings of the present disclosure, systems and methods for annotating a video recording of a game may be immediately provided to a player with statistical feedback and analysis.

According to one aspect of the invention, there is provided a method for the training of a player based upon recorded player court location, said method comprising: partitioning a tennis court opposite a side of a player to be trained into different target ball placement segments and an area outside of and contiguous with the baseline of a tennis court on a side of a player to be trained into different feet location segments to form an outline or diagram; assigning as desired target ball placement segments on the outline or diagram of the side of the court opposite the player to be trained in which a ball struck by the player lands in light of the location of the player during the racquet stroke in a feet location segment of the outline or diagram; positioning at least one video camera in view of a tennis court at a location for recording a tennis match of a player to be trained, the match including multiple racquet strokes by the player to be trained; providing at least one storage device in communication with the video camera for storing at least one video recording made with the at least video camera of (i) the player's court location in a feet location segment during different racquet strokes of the player during the match, and (ii) the landing location of balls struck by the player in a target ball placement segment in the court opposite the player; video recording with the at least video camera a live tennis match of the player to be trained; storing the video recording of the player's match on the at least one storage device; communicating the recording of the player's tennis match to an analyzer; playing back the video recording of the tennis match for the analyzer; categorizing, during play back, each racquet stroke of the player based upon (i) the player's location in a feet location segment of the outline or diagram, and (ii) the resulting landing location of each ball struck by the player in a target ball placement segment on the side of the tennis court opposite the player on the outline or diagram; identifying and labeling, according to the player's location in a feet location segment of the outline or diagram, each racquet stroke of the player that resulted in a ball landing in a target ball placement segment on the side of the court opposite the player on the outline or diagram; grouping, according to the location of the player in a feet location segment of the outline or diagram for subsequent display to the player, the portions of the video recording of the player's racquet strokes that resulted in a ball landing in a desired target ball placement segment on the side of the court opposite the player of the outline or diagram; optionally, overlaying the segmented outline or diagram of a tennis court over the tennis court in the recorded match of each portion in the video recording wherein the identified and labelled racquet strokes of the player that resulted in a ball landing in a desired target ball placement segment on the side of the court opposite the player on the outline or diagram; optionally, grouping, for subsequent display to the player, the video portions of the racquet strokes of the player from a specific feet location segment of the outline or diagram that did not result in a ball landing in a desired target ball placement segment on the side of the court opposite the player of the outline or diagram; labelling as desired shots for subsequent display to the player, the grouping of the portions of the video recording wherein racquet strokes of the player resulted in a ball landing in a desired target ball placement segment on the side of the court opposite the player of the outline or diagram; storing the groupings of the portions of the video recording on a storage device; and transmitting or providing access to the video portion grouping to the player for display to the player and training of the player.

A further aspect of the invention provides a method for the training of a player based upon recorded player court location, said method comprising: partitioning a tennis court opposite the side of a player to be trained into an upside down U-shaped target ball placement segment extending (i) the entire width of the court in front of the net extending from about 5 to 7 feet away from the net, and (ii) down the side boundaries of the court extending from the boundaries into the court from about 5 to about 7 feet, and partitioning the area inside of and contiguous with the baseline of the tennis court on the side of a player to be trained into a feet location segment to form an outline or diagram; assigning as desired the upside down u-shaped target ball placement segment on the side of the court opposite the player to be trained for a ball struck by the player to land in light of the location of the player during the racquet stroke in a feet location segment; positioning at least one video camera in view of a tennis court at a location for recording a tennis match of a player to be trained, the match including multiple racquet strokes by the player to be trained; providing at least one storage device in communication with the video camera for storing at least one recording made with the at least one video camera of (i) the player's court location in a feet location segment during different racquet strokes of the player during the match, and (ii) the landing location of balls struck by the player in the court opposite the player in the upside down u-shaped target ball placement segment; video recording with the at least one video camera a live tennis match of the player; storing the video recording of the player's match on the storage device; transmitting, communicating or providing access to the stored recording of the player's tennis match to an analyzer; playing back the video recording of the tennis match for the analyzer; categorizing, during play back, each racquet stroke of the player based upon (i) the player's position on the court in a feet location segment of the outline or diagram, and (ii) the resulting landing location of each ball struck by the player in the upside down u-shaped target ball placement segment on the side of the tennis court opposite the player of the outline or diagram; identifying and labeling, according to the player's location in a feet location segment of the outline, each racquet stroke of the player that resulted in a ball landing in the upside down u-shaped target ball placement segment on the side of the court opposite the player of the outline; grouping, according to the location of the player in a feet location segment of the outline for subsequent display to the player, the portions of the recording of the player's racquet strokes that resulted in a ball landing in the upside down u-shaped target ball placement segment on the side of the court opposite the player of the outline; optionally, overlaying the segmented outline of a tennis court over the tennis court of the recorded match of each portion in the video recording wherein the identified and labelled racquet strokes of the player that resulted in a ball landing in the desired upside down u-shaped target ball placement segment on the side of the court opposite the player of the outline; optionally, grouping, for subsequent display to the player, the overlaid video portions of the racquet strokes of the player from the feet location segment of the outline that resulted in a ball not landing in the desired upside down u-shaped target ball placement segment on the side of the court opposite the player of the outline; labelling as desired for subsequent display to the player, the grouping of the portions of the video recording wherein racquet strokes of the player from the feet location segment of the outline resulting in a ball landing in the desired upside down u-shaped target ball placement segment on the side of the court opposite the player of the outline; storing the groupings of the overlaid portions of the video recording on a storage device; and transmitting, communicating or providing access to the video portion grouping to the player for display to the player and training of the player.

According to another aspect of the invention, there is provided a method for the remote training of a player based upon the player's recorded feet location in or outside of a tennis court, said remote training method comprising: positioning a handheld device in view of a tennis court at a location behind a baseline of the tennis court for recording a tennis match of the player to be trained, the recording including multiple stroke/return sequences between players, the handheld device including: a non-transitory computer readable media having stored thereon a tennis training application, a camera, a touch screen display, and a processor, wherein said processor upon execution of the processing application is configured for: video recording with the camera tennis stroke/return sequences involving the player to be trained; storing the video recording on the non-transitory computer readable media; communicating the recording of the player's tennis match to an analyzer; displaying on the display a feedback video received from the analyzer; connecting the analyzer in telecommunication with the handheld device, wherein the analyzer includes: a non-transitory computer readable media having stored thereon analyzing software, and a processor, wherein said processor upon execution of the analyzing software is configured for: identifying the tennis court lines in the video recording to partition the tennis court opposite a side of a player to be trained into different desired target ball placement segments to form a court outline or diagram, and to partition the tennis court on a side of the player to be trained into either (1) different numbered player feet location segments located in an area outside of and contiguous with the baseline of the tennis court, or (2) different numbered player feet location segments located inside of and contiguous with the baseline of the court to form a court outline or diagram; tracking movement of the tennis ball in the video recording to identify locations in the video recording where the tennis ball has changed direction from a trajectory path caused by a player striking the tennis ball or the tennis ball bouncing off the court; cutting the video recording into stroke/return sequence clips based on when a player strikes the tennis ball; identifying and labeling, according to the player's location segment of the court outline or diagram, each racquet stroke of the player that resulted in a ball landing in a desired target ball placement segment on the side of the court opposite the player on the court outline or diagram; grouping, according to the location of the player in a feet location segment of the outline or diagram for subsequent display to the player, the portions of the video recording of the player's racquet strokes that resulted in a ball landing in a desired target ball placement segment on the side of the court opposite the player of the outline or diagram; overlaying the segmented court outline or diagram of the tennis court over each portion in the video recording wherein the identified and labelled racquet strokes of the player resulted in a ball landing in a desired target ball placement segment on the side of the court opposite the player on the court outline or diagram; annotating the trajectory of the tennis ball during separate video clips; generating a feedback video comprising multiple video clips comprising overlaid target ball placement segments, annotated trajectories, and grouping statistics; and transmitting the feedback video to the handheld device.

### BRIEF DESCRIPTION OF THE DRAWINGS

A more complete understanding of the present embodiments may be acquired by referring to the following description taken in conjunction with the accompanying drawings, in which like reference numbers indicate like features, and wherein:

FIG. 1 illustrates a baseliner embodiment of the present invention;

FIG. 2 illustrates an attacker embodiment of the present invention;

FIG. 3 illustrates a lesson embodiment of the present invention according to the baseliner embodiment of FIG. 1;

FIG. 4 illustrates another lesson embodiment of the present invention according to the baseliner embodiment of FIG. 1;

FIG. 5 illustrates the lesson of FIG. 3 based on the score or an important point in a match;

FIG. 6 illustrates the lesson of FIG. 4 based on the score or an important point in a match;

FIG. 7 a lesson embodiment of the present invention according to the attacker embodiment of FIG. 2;

FIG. 8 illustrates the lesson of FIG. 7 based on the score or an important point in a match;

FIG. 9 illustrates a server embodiment of the present invention;

FIGS. 10, 10.1 and 10.2 provide illustrations of feedback displays, which provide feedback information.

FIGS. 11 and 11.1 provide illustrations of feedback displays, which provide feedback information.

FIGS. 12, 12.1, 12.2, 13, 13.1, 13.2 13.3 and 14 provide illustrations of feedback displays, which provide feedback information.

FIGS. 15-21 illustrate a defensive red zone time baseliner embodiment of the present invention;

FIGS. 22-29 illustrate a neutral baseliner embodiment of the present invention;

FIGS. 30-37 illustrate a neutral red zone time baseliner embodiment of the present invention;

FIGS. 38-53 illustrate an offensive baseliner embodiment of the present invention; and

FIGS. 54-64 illustrate an offensive red zone baseliner embodiment of the present invention.

FIGS. 65.1 and 65.2 provide illustrations of a “Neutral” feedback display, wherein actual footage of a recorded game is annotated to show the path traveled by the ball and the zones in which the players where positioned when contact was made with the ball, and wherein statistical information is provided regarding play to/from the zones.

FIGS. 65.3 and 65.4 provide illustrations of a “Defense” feedback display, wherein actual footage of a recorded game is annotated to show the path traveled by the ball and the zones in which the players where positioned when contact was made with the ball, and wherein statistical information is provided regarding play to/from the zones.

FIGS. 66.1 and 66.2 provide illustrations of video recording wherein motion detection software has identified objects (players and tennis ball) in the recording that are in motion.

FIG. 67 shows a system of the present invention wherein a local system comprises a camera, a storage device, a processor, a transmitter/receiver and a display, and a remote system comprises a transmitter/receiver and an analyzer.

FIG. 68 shows grid segments for a tennis court generated by system software for overlaying on a tennis court in a video recording.

### DETAILED DESCRIPTION

According to an embodiment, the methods and systems of the present disclosure provide heretofore unknown training and coaching methods utilizing the below described embodiments wherein a player may be trained, e.g., remotely—not with mere stroke statistics—but with coaching and strategy provided to the player via mobile or web application in the form of a tennis court partitioned into segments, blocks and/or colors to display strategic issues and to teach players how to use the court to their advantage in a real life video recording of the player in match situations.

The present methods and systems may comprise lessons for each situation—ball and player location and match score—during a tennis match. For example, according to some embodiments, to simplify the lessons and for a player to reach his/her potential, the court is divided or partitioned into segments, blocks or boxes, e.g., preferably colorful blocks and/or numbered segments or boxes to form an outline or diagram of court. These segments, blocks or boxes are used to identify (and later categorize) the location of the player's feet in and around the court, sometimes referred to herein as feet location segments or boxes. In addition, according to some preferred embodiments of the present method and system, the court opposite the player is also divided into or partitioned into segments, blocks or boxes to identify (and later categorization) desired target ball placement areas on the court opposite the player to be trained. According to an embodiment, the present method and system of coaching tracks the ball from the player's racquet to the assigned desired target ball placement segment. According to a further embodiment, every time a player is in position during a point, the present system and method may track the path of the ball and accumulate the recordings of the placement of each shot of the ball during the recorded match to determine and later display how many times the player executed a shot placement correctly into the desired assigned target ball placement blocks or segments. According to a still further embodiment, the present method and system may comprise allowing a player access by logging into an assigned account. A tennis court outline with blocks and segments, preferably color coded and/or numbered, may be provided according to the training or coaching package purchased by the player. Ball counts will be displayed in the blocks or segments of the court outline or diagram. The player, according to some embodiments, may select or click on a feet location block or segment or a number in a feet location block or segment (representing the number of shots from the block or segment during the recorded match) and all of the ball counts of shots taken from a given feet location segment or block will be displayed while a video of those recorded shots may be played and viewed by the player to be trained, e.g., with or without an overlay of the blocks, segments, or colored areas of the court over the recorded court in the match video.

According to one embodiment, the present invention is directed to a method for the remote training of a player based upon the player's recorded feet location in or outside of a tennis court. The method may comprise partitioning the tennis court opposite a side of a player to be trained into different desired target ball placement segments or boxes to form a court outline or diagram, and partitioning the tennis court on the side of the player to be trained into either (1) different numbered player feet location segments located in an area outside of and contiguous with the baseline of the tennis court, or (2) different numbered player feet location segments located inside of and contiguous with the baseline of the court to form a court outline or diagram. The method may further comprise positioning at least one video camera in view of the tennis court at a location for recording a tennis match of the player to be trained, the match including multiple racquet strokes by the player to be trained. The method of the present invention may also comprise providing at least one storage device in communication with the video camera for storing at least one video recording made with the at least one video camera of (i) the player's location in a numbered feet location segment during different racquet strokes of the player during the match, and (ii) the landing location of balls struck by the player in the desired target ball placement segments in the court opposite the player. The method of the present invention according to this embodiment also comprises video recording with the at least video camera a live tennis match of the remote player to be trained, storing the video recording of the player's match on the at least one storage device, communicating the recording of the player's tennis match to an analyzer, playing back the video recording of the tennis match for the analyzer, categorizing, e.g. by the analyzer during play back, each racquet stroke of the player based upon (i) the player's location in a feet location segment of the court outline or diagram, and (ii) the resulting landing location of each ball struck by the player in a desired target ball placement segment on the side of the tennis court opposite the player on the court outline or diagram. The invention, according to this embodiment, may also comprise identifying and labeling, according to the player's location in a feet location segment of the court outline or diagram, each racquet stroke of the player that resulted in a ball landing in a desired target ball placement segment on the side of the court opposite the player on the court outline or diagram and grouping, according to the location of the player in a feet location segment of the outline or diagram for subsequent display to the player, the portions of the video recording of the player's racquet strokes that resulted in a ball landing in a desired target ball placement segment on the side of the court opposite the player of the outline or diagram. Optionally, the present inventive method according to one embodiment may also comprise overlaying the segmented court outline or diagram of the tennis court over each portion in the video recording wherein the identified and labelled racquet strokes of the player resulted in a ball landing in a desired target ball placement segment on the side of the court opposite the player on the court outline or diagram. Still further and according to an embodiment, the present inventive method may optionally, comprise grouping, for subsequent display to the player, the video portions of the racquet strokes of the player from a specific feet location segment of the outline or diagram that did not result in a ball landing in a desired target ball placement segment on the side of the court opposite the player of the outline or diagram. The present invention may also comprise storing the grouping or groupings of the portions of the video recording on a storage device and transmitting or providing access to the video portion grouping or groupings to the player for display to the player and remote training of the player.

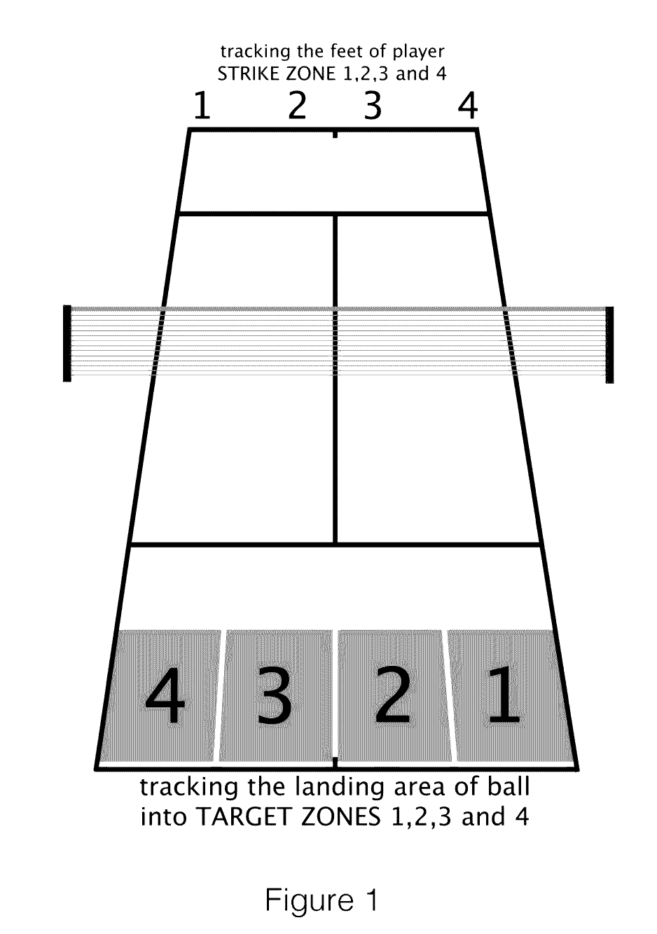

The present invention, according to one embodiment, is directed to a method for the training of a player, for example a remote player, based upon the recorded location of a player, preferably, a player's feet location on a tennis court. According to an embodiment, the method may be directed to training a player including but not limited to a remote player, for baseline play. According to a baseline training embodiment, the present invention may comprise (i) partitioning or segmenting the outline of a tennis court opposite the side of a player to be trained into different numbered segments or colored areas to form a diagram or outline, (called target zones) for example, preferably four different numbered segments or colored areas for baseline training (see, e.g., FIG. 1), and (ii) partitioning the area outside of and contiguous with the baseline of an outline of a tennis court on the side of a player to be trained into different numbered segments or colored areas, for example, also preferably four different numbered segments or colored areas. See, for example, FIG. 1. The present invention, according to one embodiment, may also comprise assigning certain numbered segments or colored areas as “desired” target ball placement segments (called target zones) on the opposite side of the court from the player for a ball struck by the player to land in light of the location of the player, preferably the player's feet in a numbered feet location segment or box (called strike zone), during the racquet stroke from a numbered feet location segment or colored area (called strike zone).

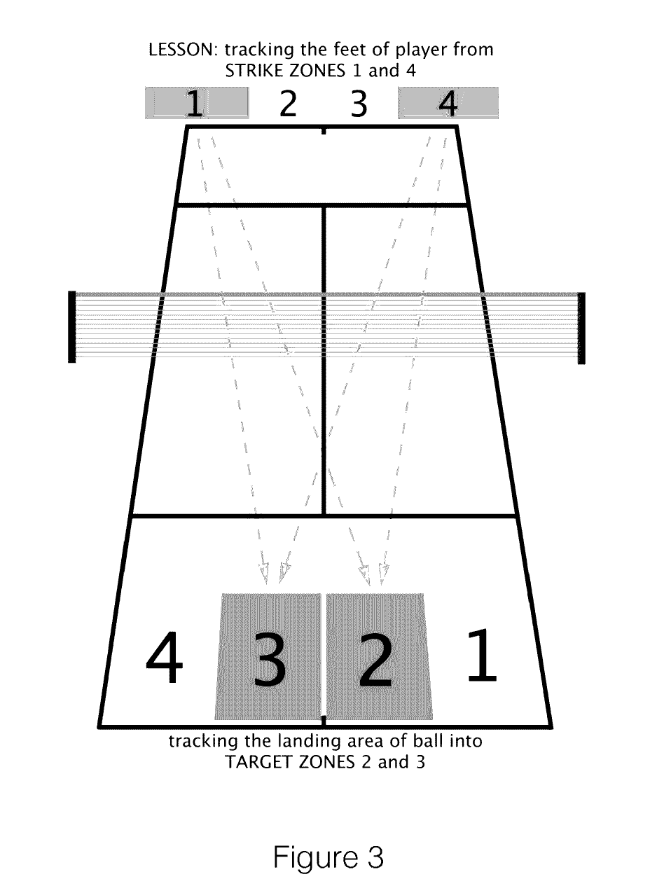

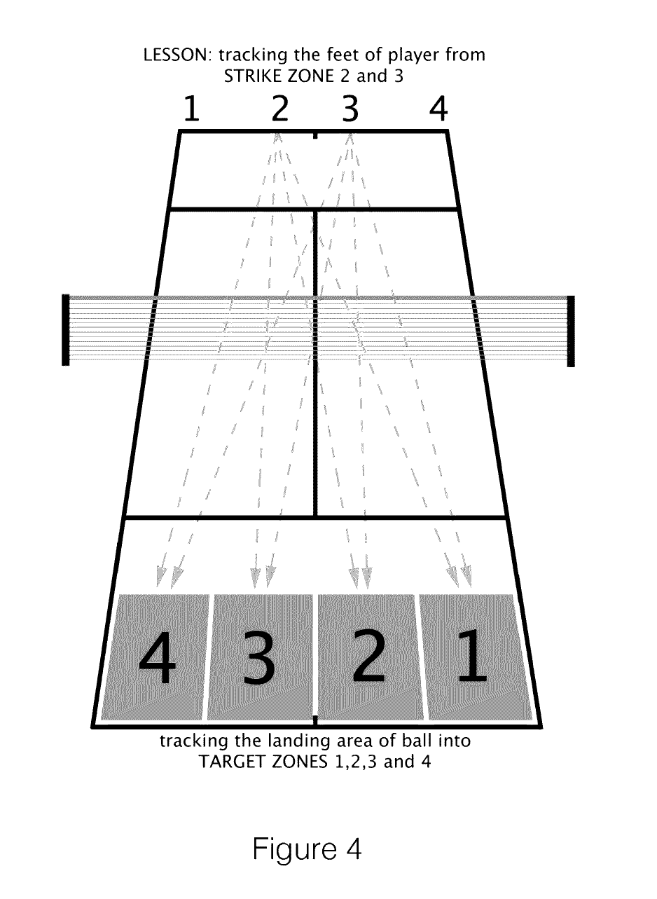

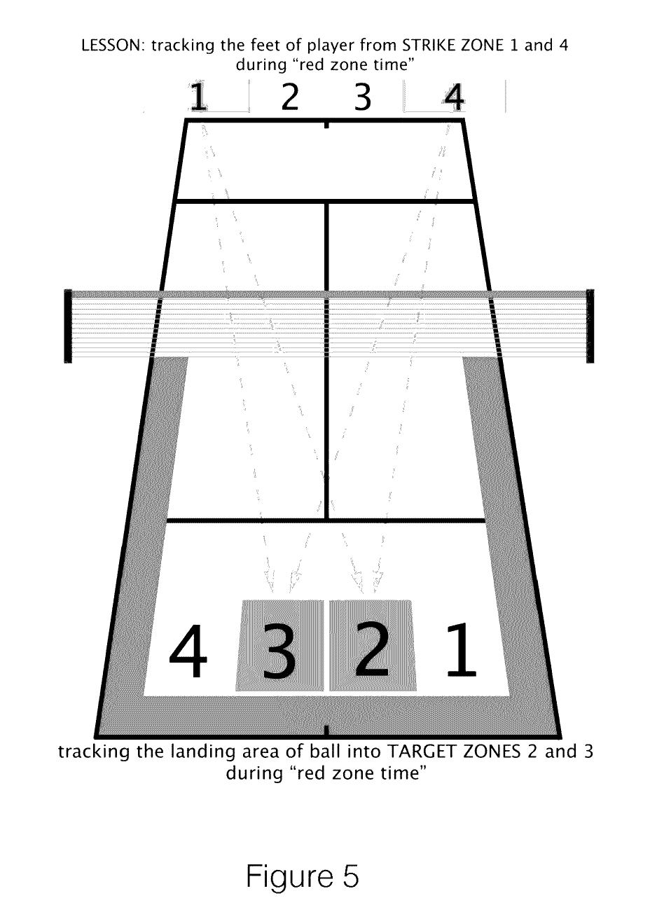

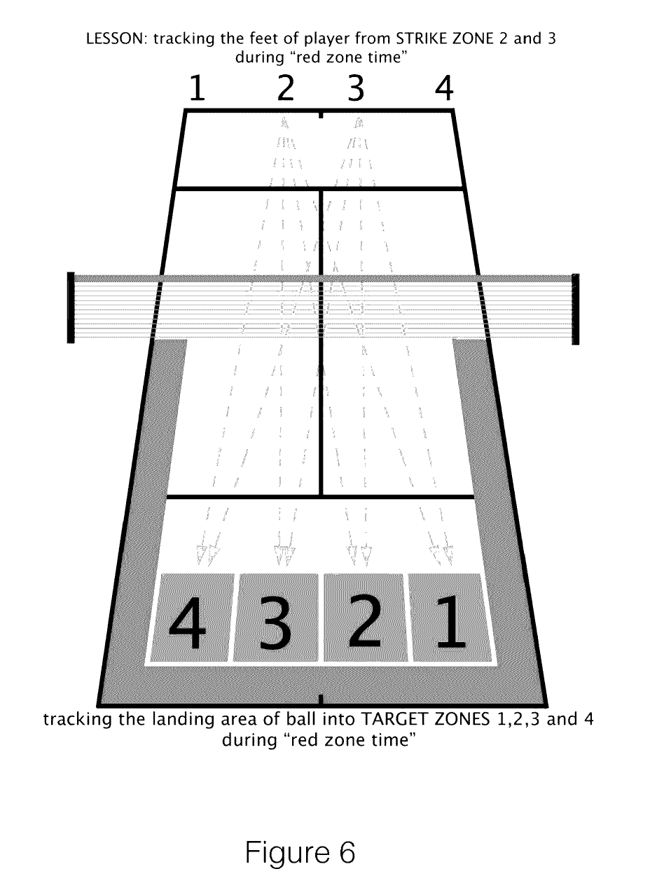

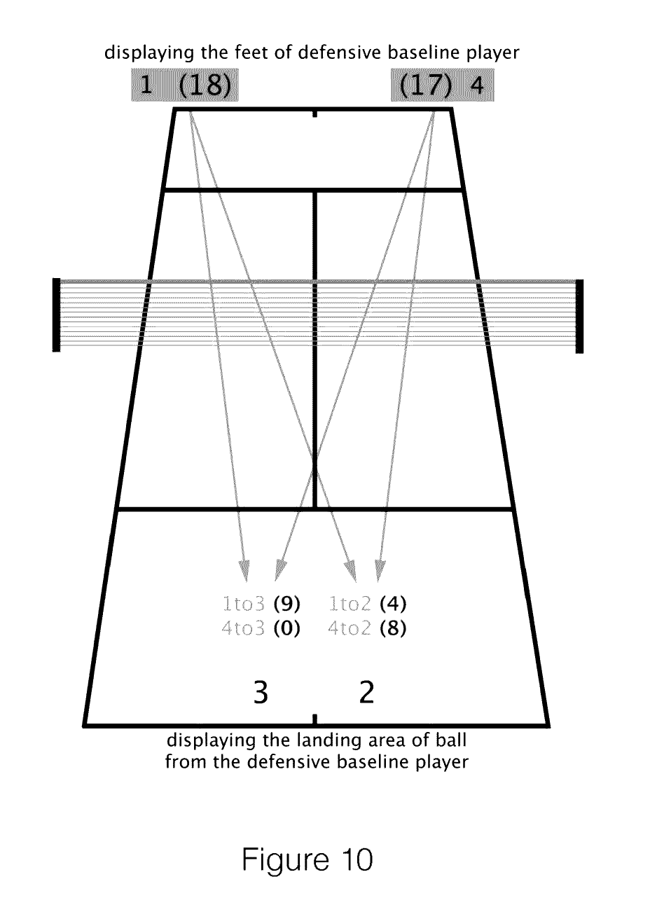

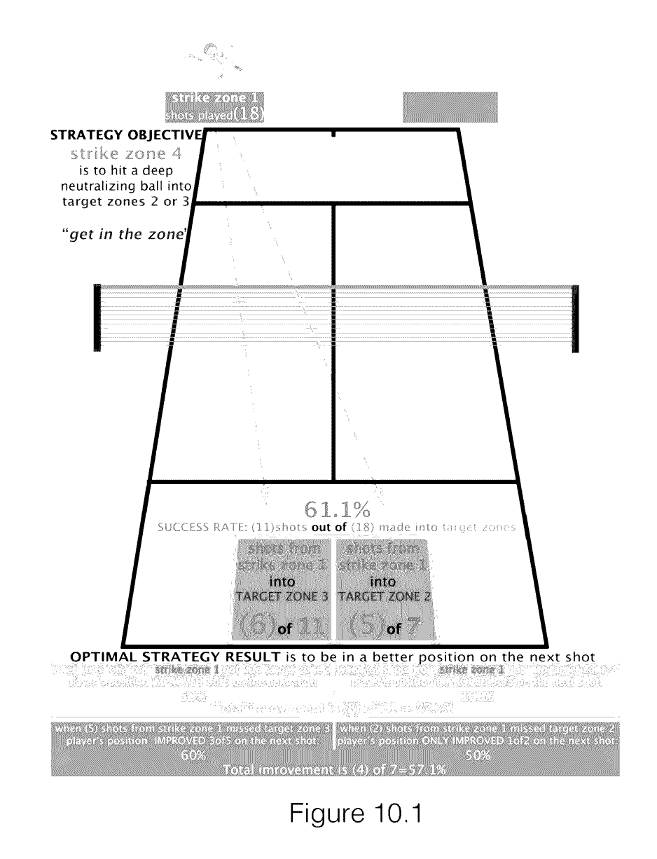

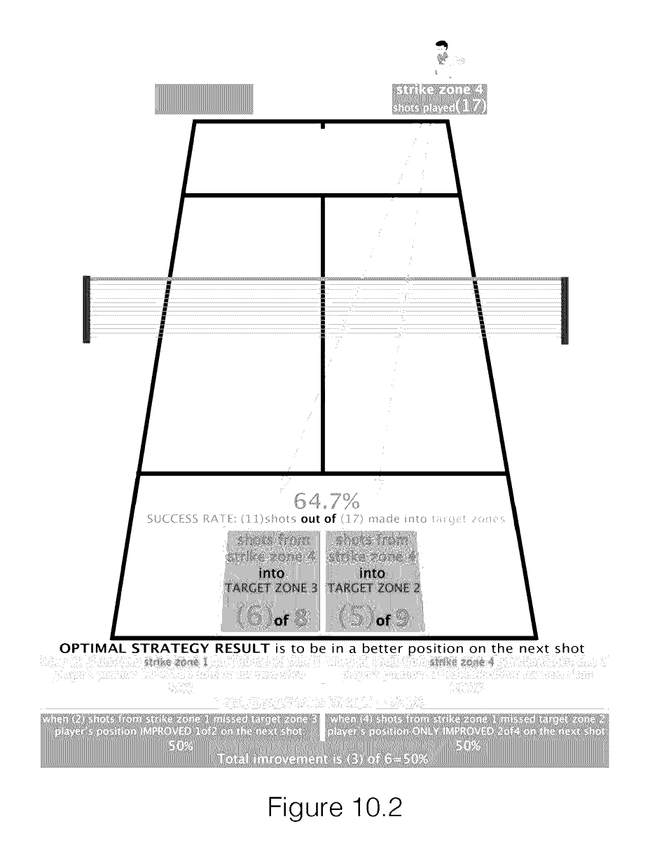

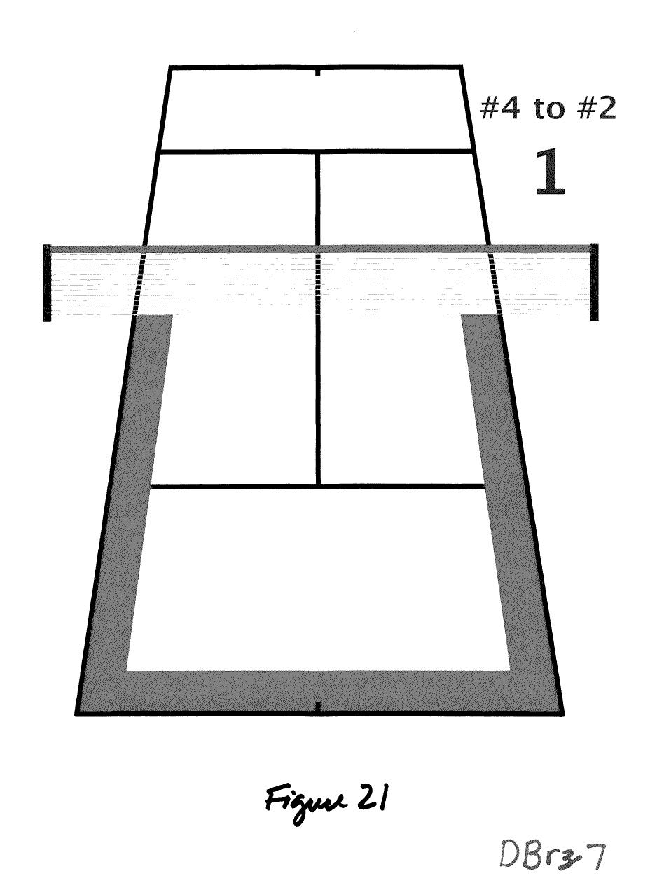

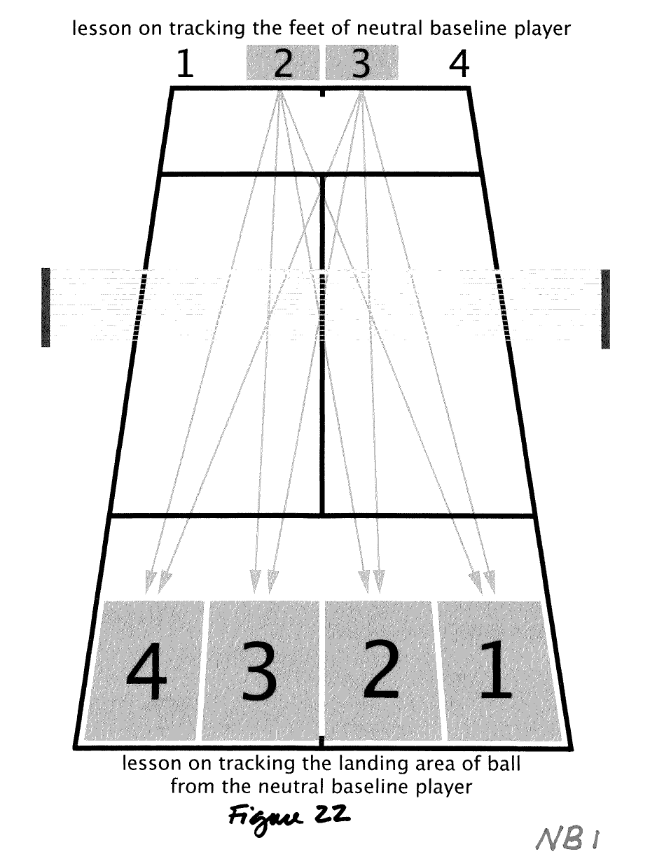

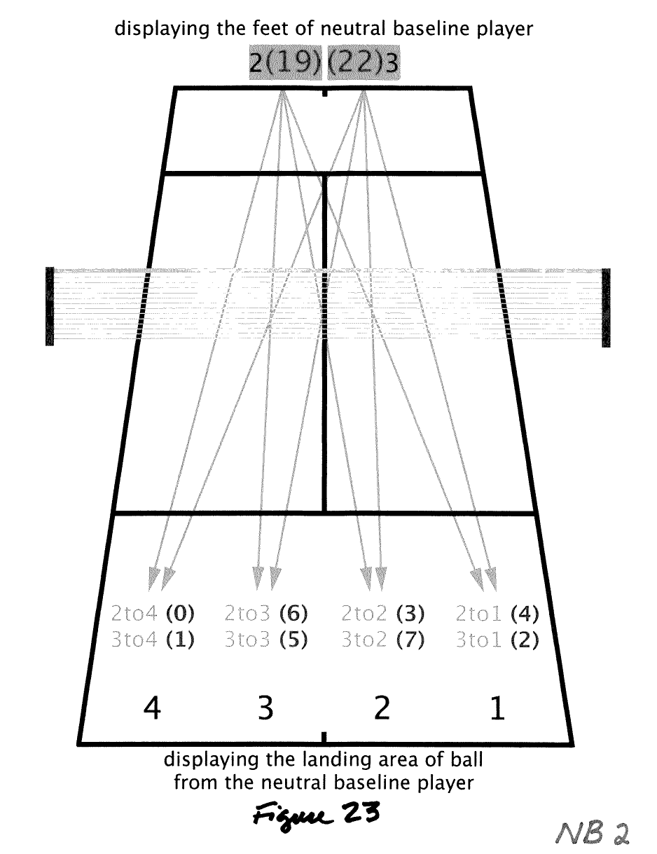

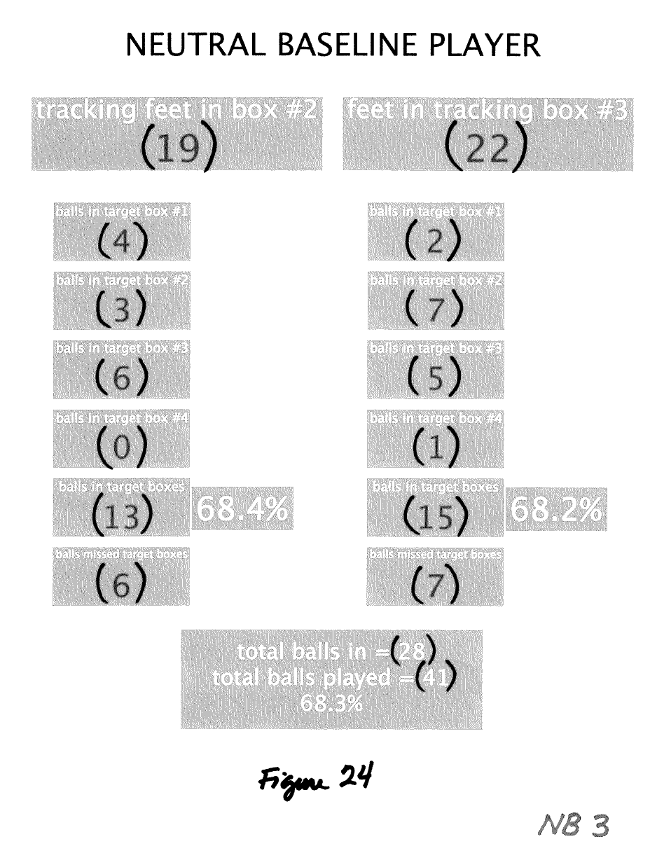

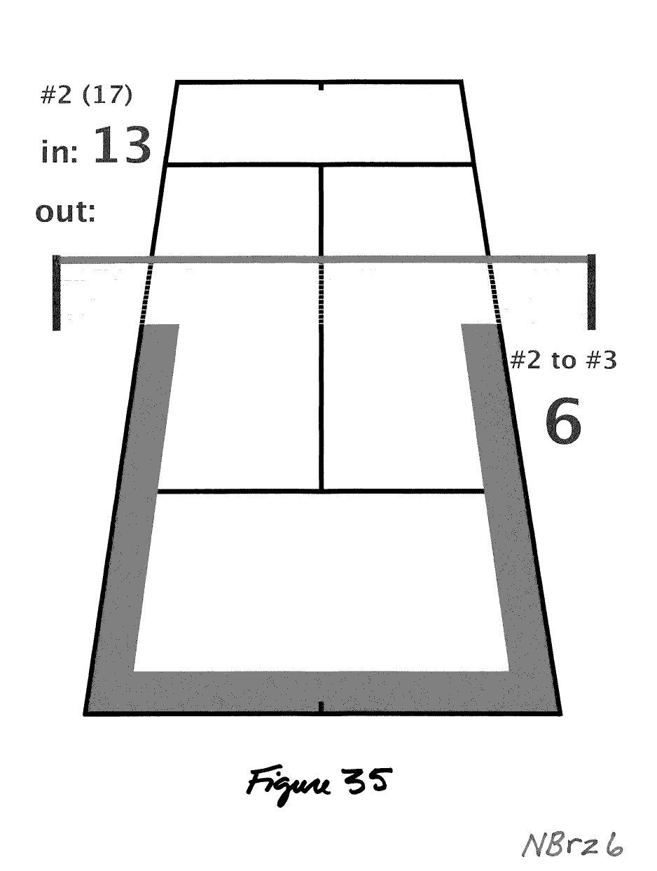

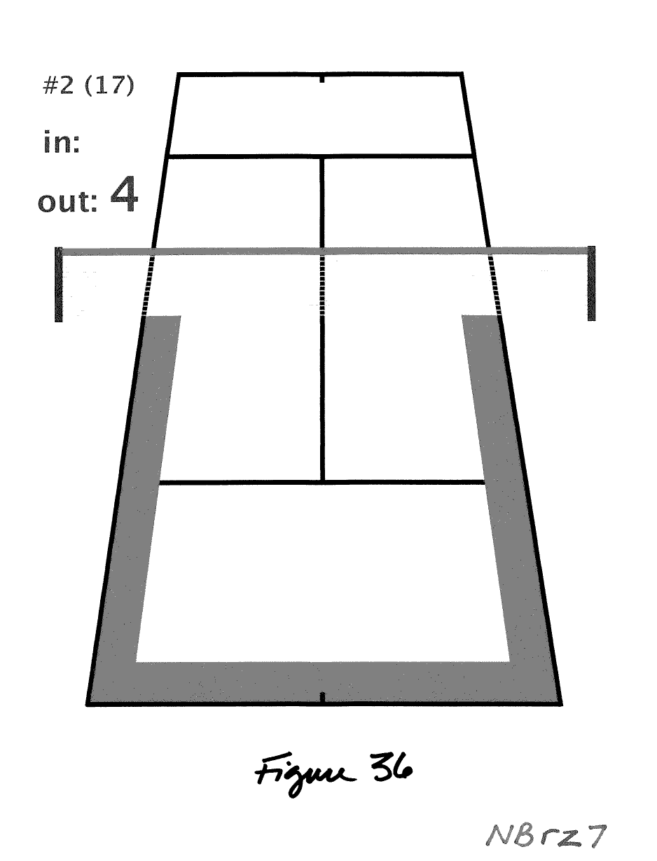

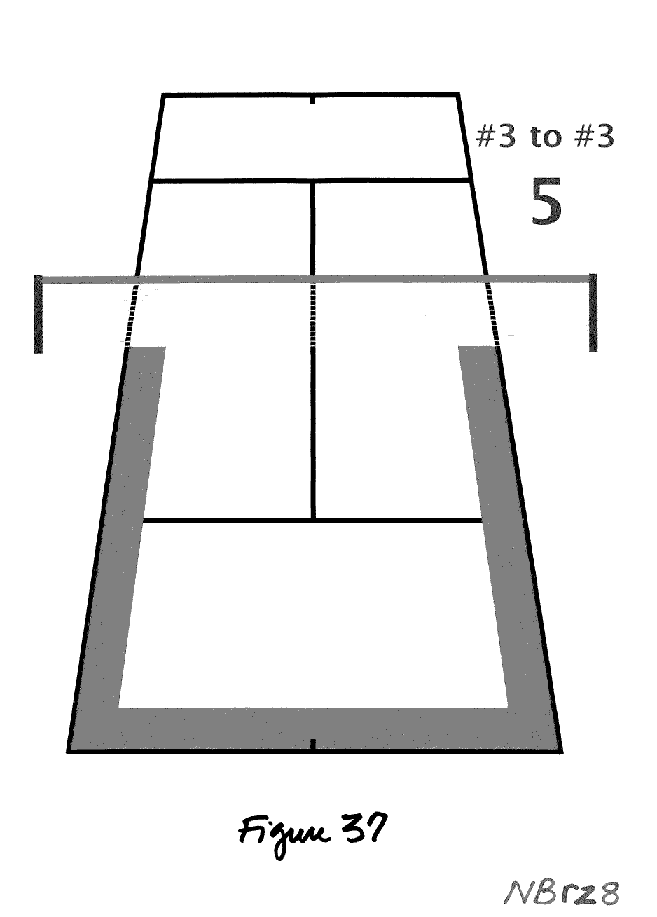

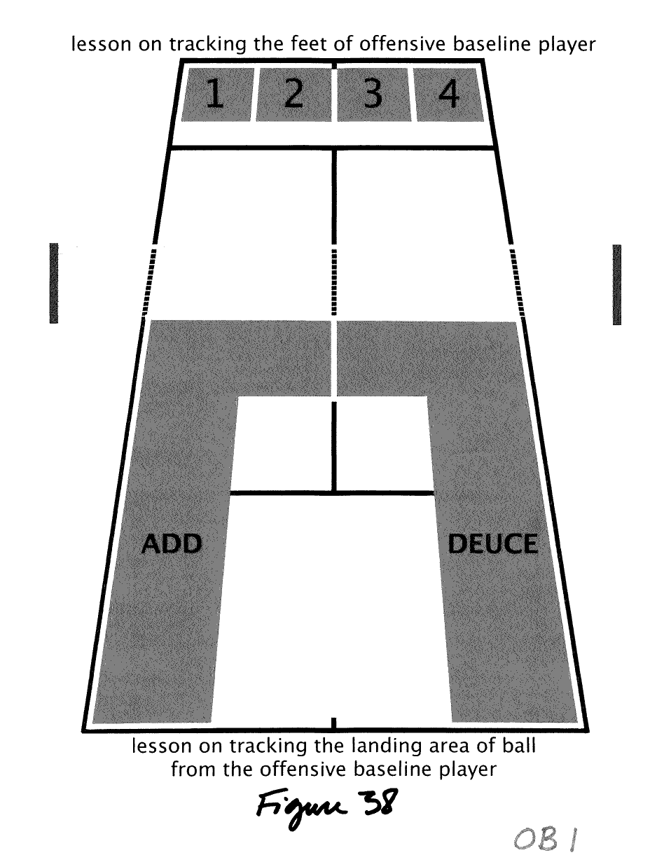

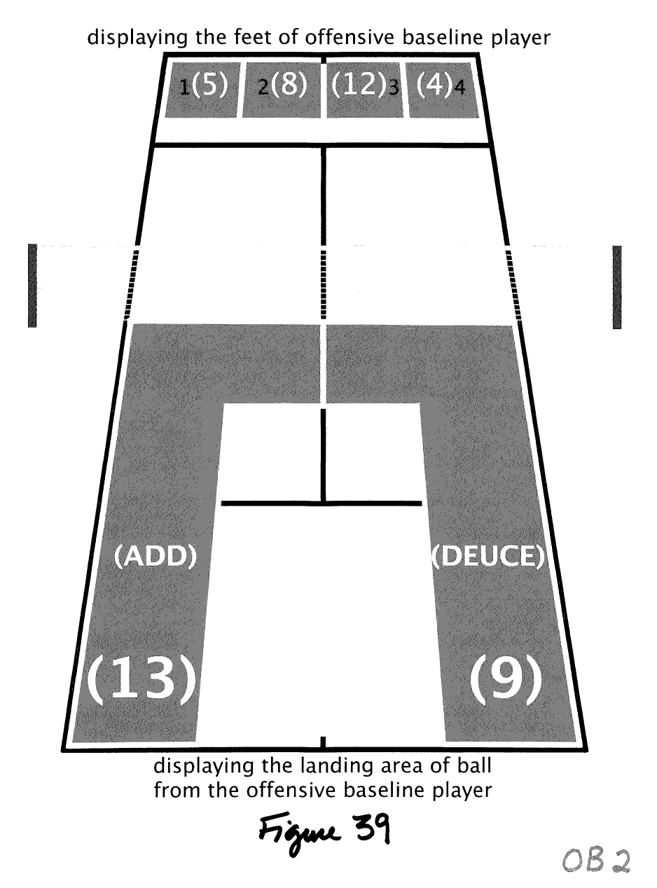

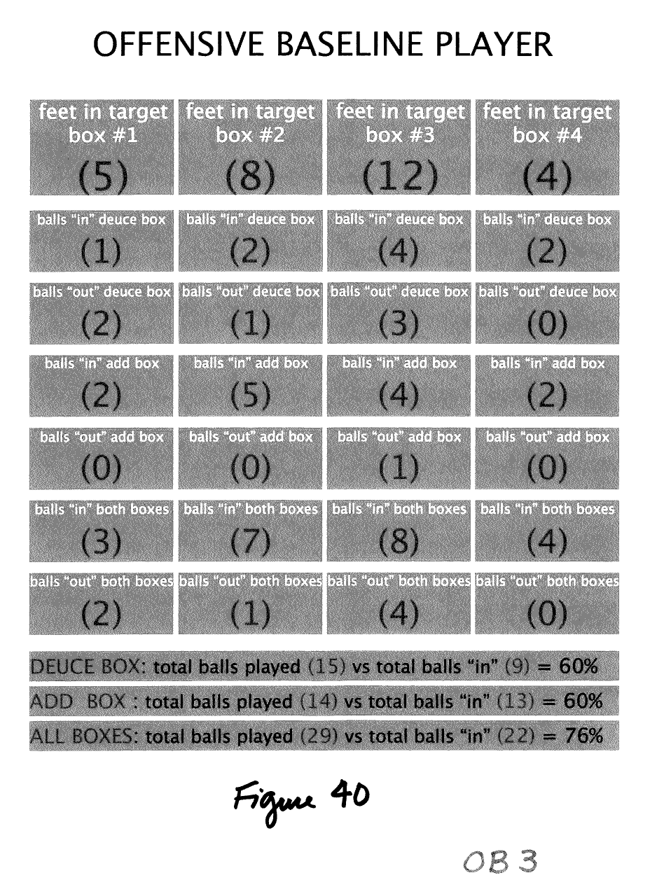

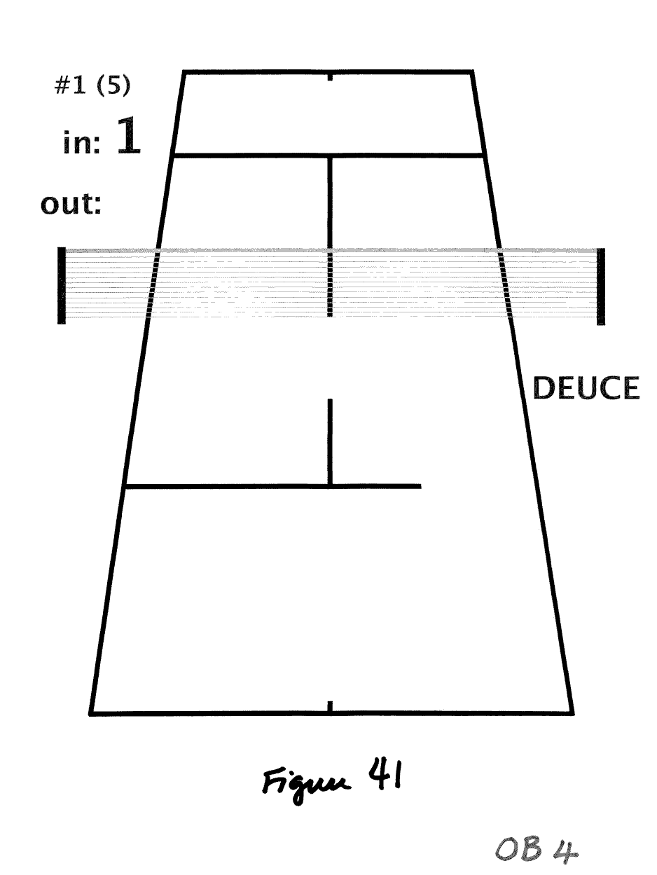

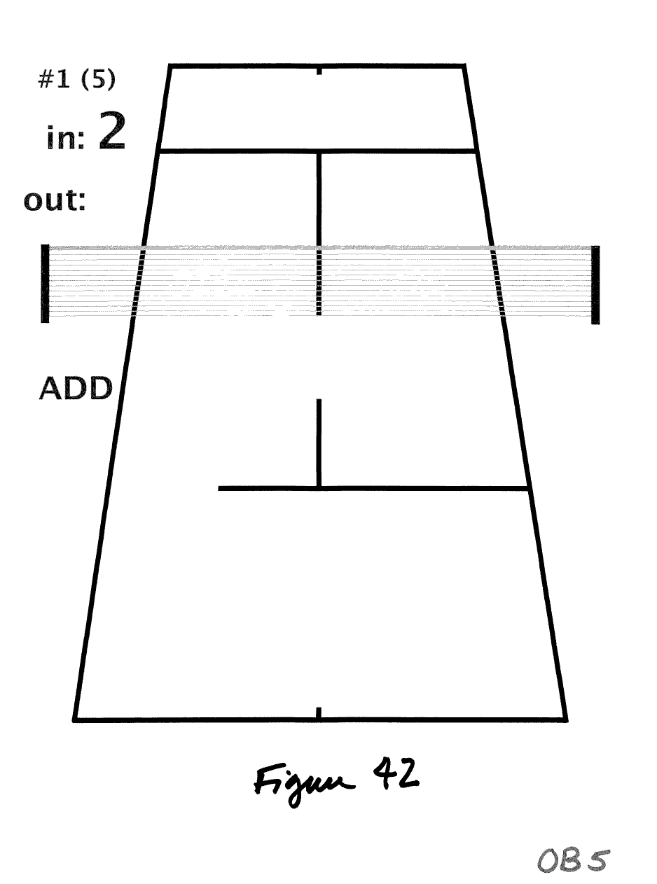

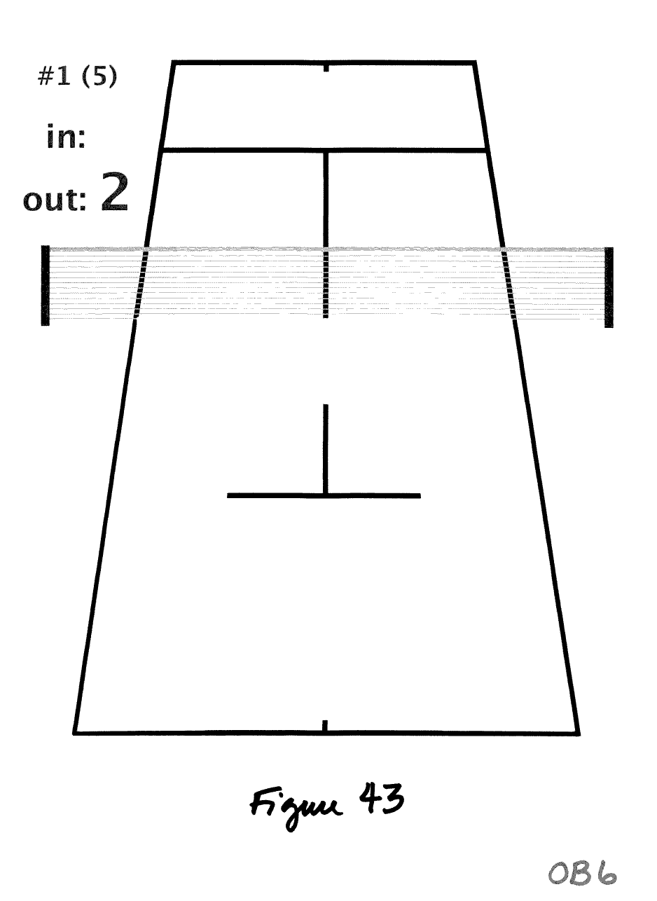

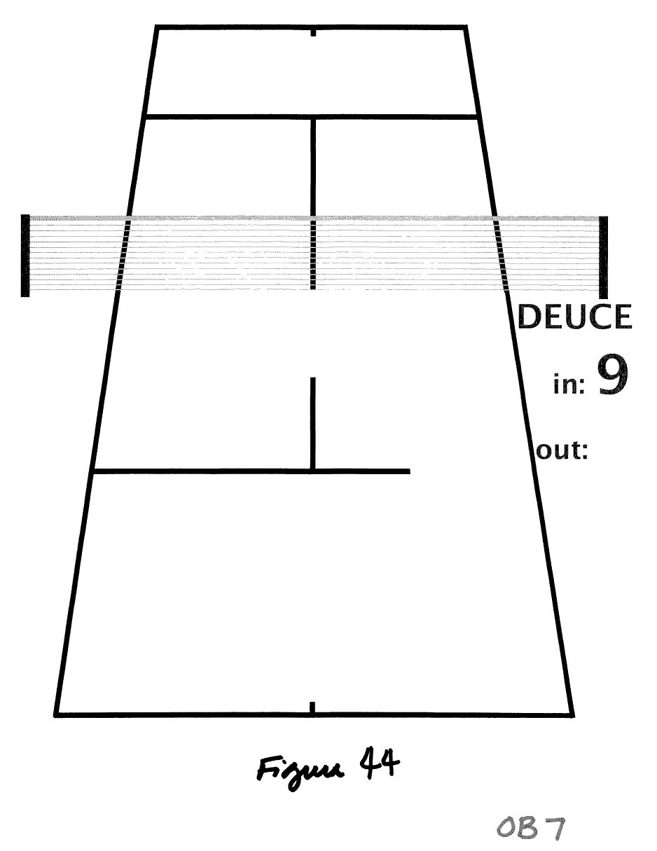

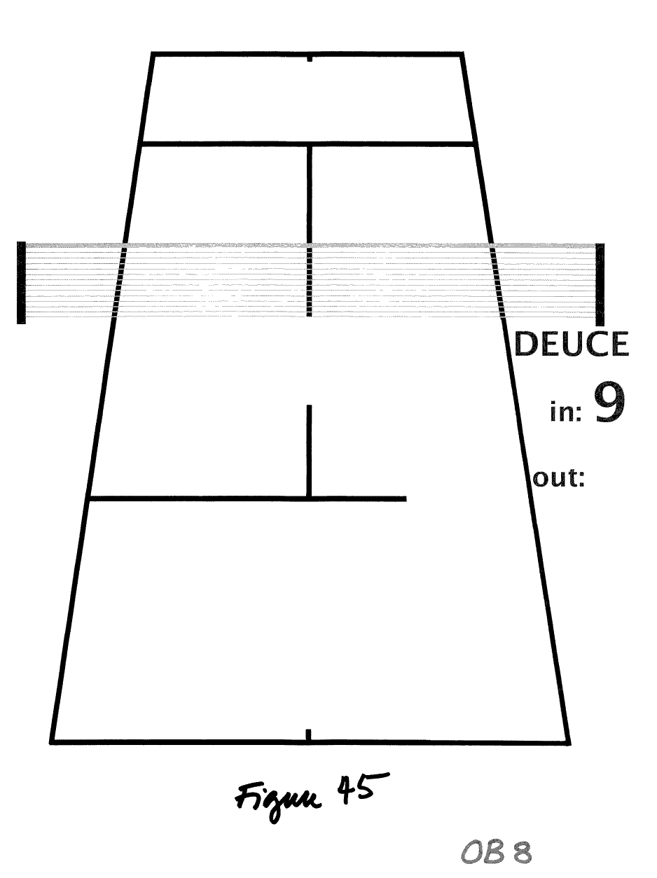

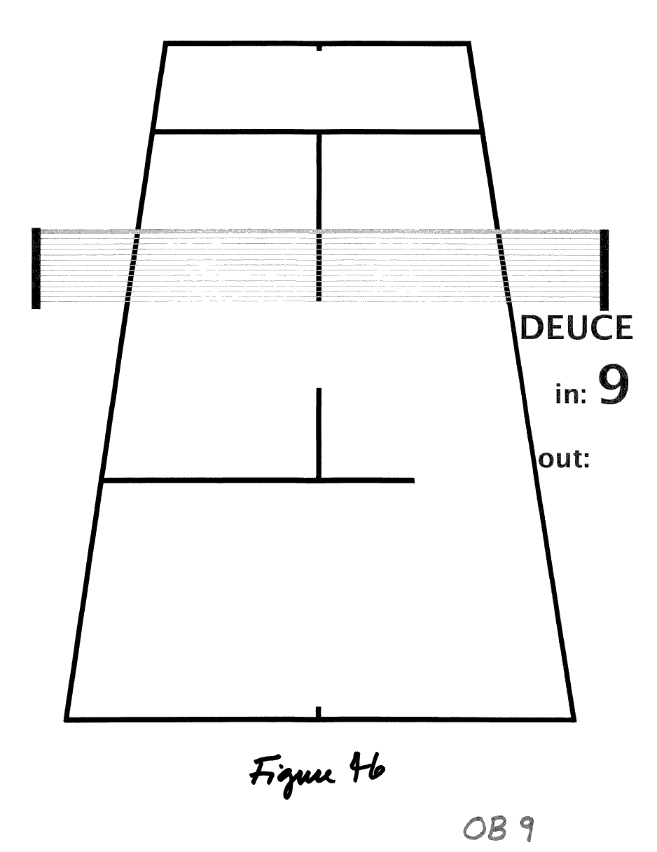

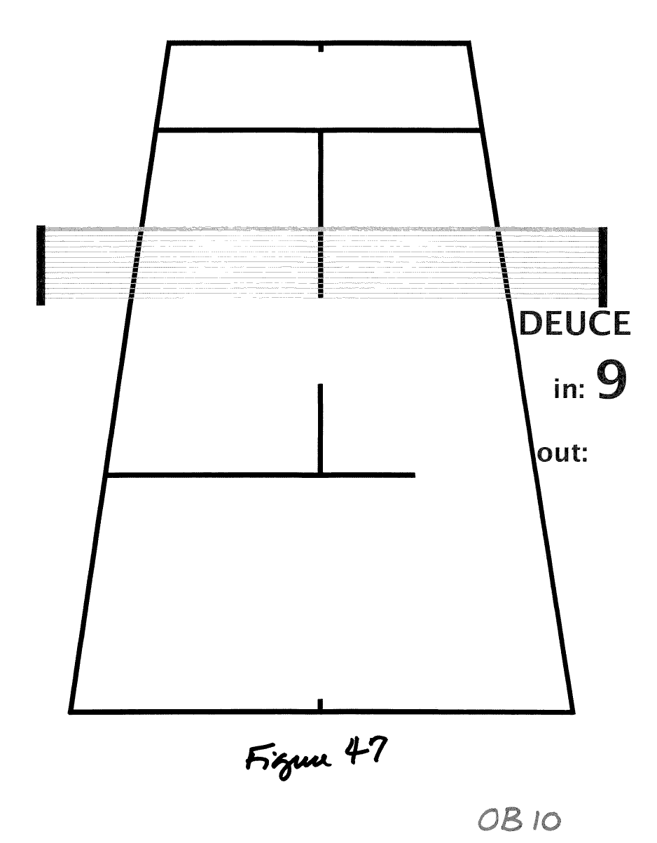

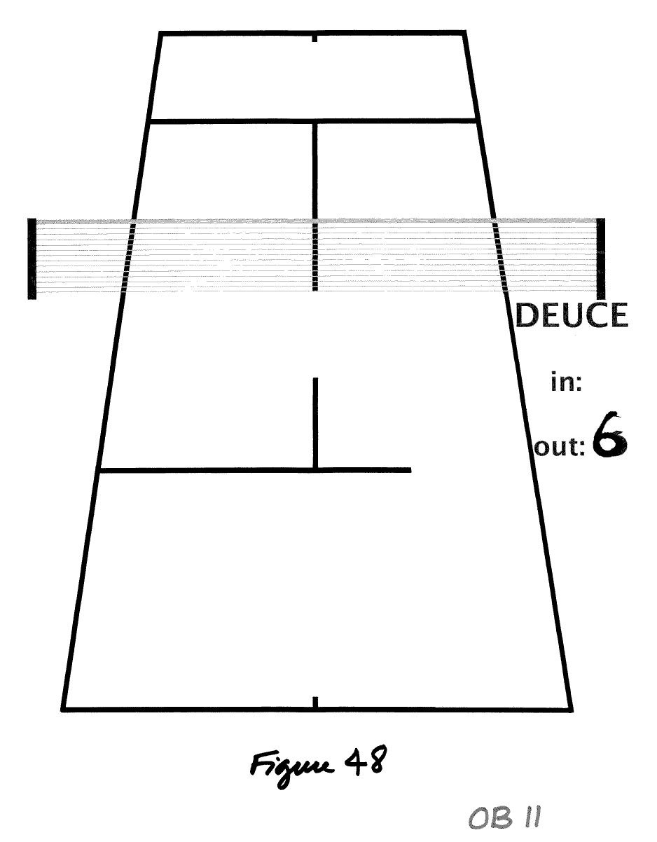

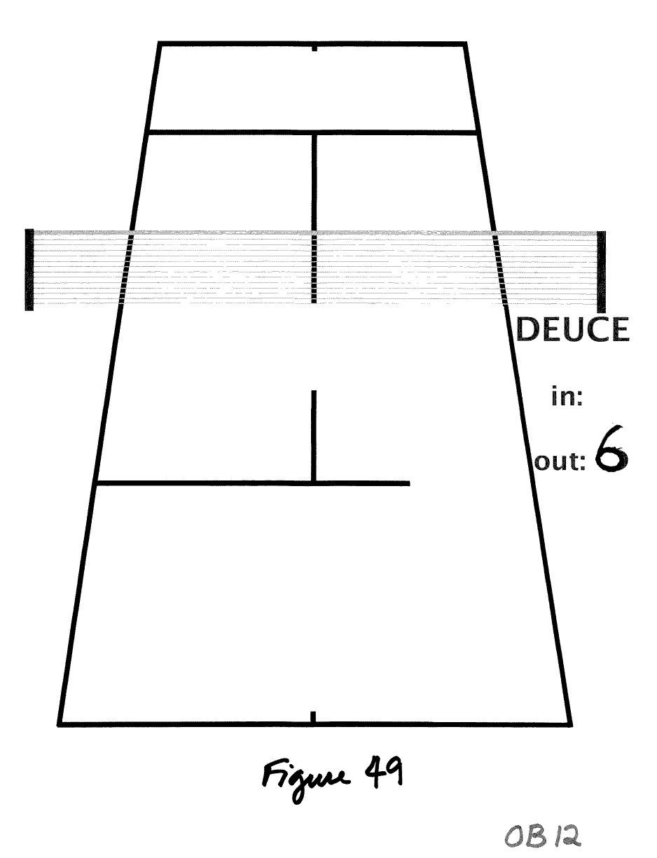

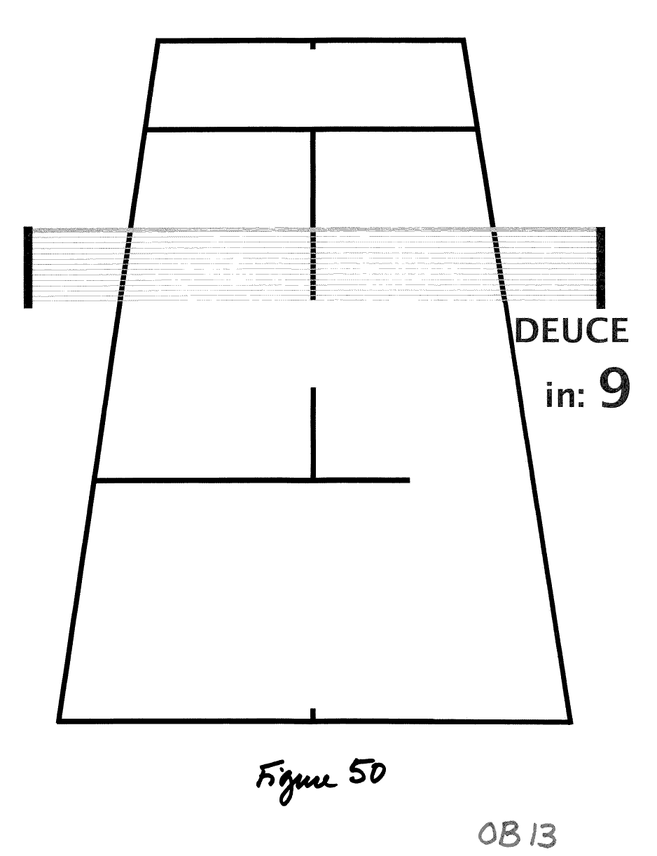

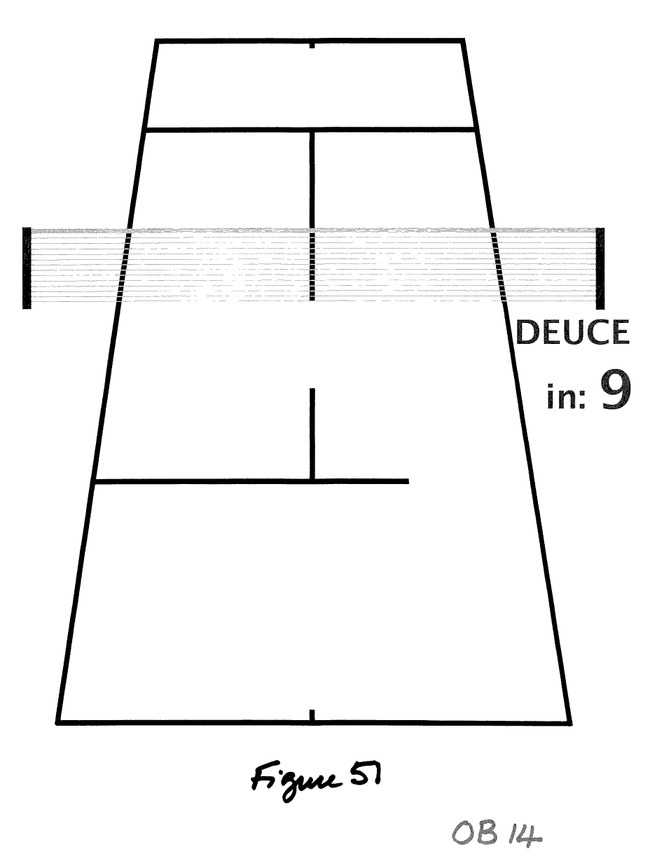

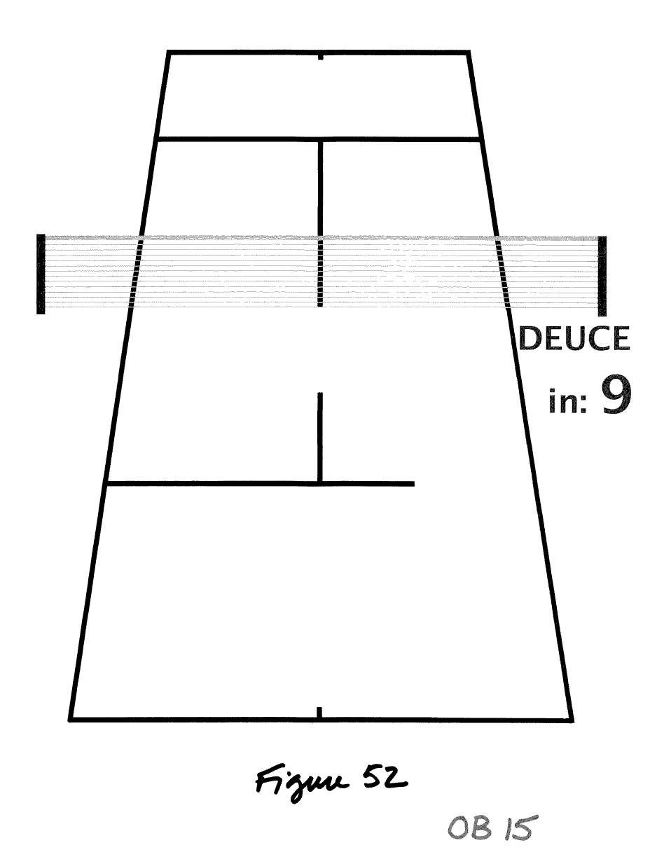

In addition, according to further embodiments, the invention may comprise teaching or training the player with regard to different match strategies, e.g., target ball placement, depending upon the circumstances of the match, for example, the score of the current game and/or the score of the match and the player's location on the court, preferably his/her feet location in a feet location segment (called strike zone). Consequently, according to some embodiments, the invention may comprise a defensive baseliner (“DB”) lesson or strategy, a neutral baseliner (“NB”) lesson or strategy and/or an offensive baseliner (“OB”) lesson or strategy training. Examples of these training embodiments are illustrated in FIGS. 3, 10, 10.1, 10.2, 11, 11.1, 12, 12.1, 12.2, 13, 13.1, 13.2, 13.3, 14, FIGS. 22-29, and FIGS. 38-53, respectively. These are examples only, described as illustrative of the training and teaching lessons of the present invention and are not meant to be limiting of the invention and/or the claims of the present application and other embodiments, not described herein, may still fall within the claims of the present application.

For example, with regards to the DB player lesson or strategy, the player will have options regarding which shots she/he would like to view and/or receive training on, preferably, through positive visual video feedback utilizing embodiments of the present invention applied to the recorded match play of the player to be trained. Whenever, according to some embodiments, the player makes a choice by selecting or clicking on a numbered feet location segment or a colored area or a numeral in the display (preferably displayed in parenthesis), video clips or playback of the player's recorded match may play according to the player's feet location, for example, his/her feet location in a feet location segment or box during a shot. Once the player clicks-on or selects a numeral in a feet location segment or area or a feet location segment, area or box, video clips or playback of the player's recorded match may, e.g., play in the following order: (1) all shots of the player while his/her feet were located in a feet location segment or colored area resulting in a ball landing in a desired target ball placement segment or colored area according to a lesson or strategy, and (2) all the shots wherein the player missed placing the ball in a desired target ball placement segment(s) or colored area(s) while a player's feet were located in a given feet location segment or colored area from the player's side of the court according to a given lesson or strategy.

On the display, according to some embodiments, e.g., FIG. 10, the player may choose to click-on or select any numeral, preferably presented in parenthesis. For example, preferably, the player may click-on or select the numeral “(18)” in the display and see clips or video play back of every shot the player took during his/her recorded match while the player's feet were located in a feet location numbered segment, area or box #1 first, with the ball landing in a desired target ball placement numbered segments or boxes #2 or #3 of the opposite court (9+4=13 shots) and second, with the ball not landing in a desired target ball placement numbered segment (18−13=5 shots). In an embodiment, the player may choose to view the above described shots with or without the numbered or colored areas overlaid on the court of the video playback of the player's match.

FIG. 10.1 illustrates a feedback image wherein 6+5=11 shots landed in the desired target ball placement numbered segments or boxes #2 or #3, and 18-(6+5)=7 shots did not land in the desired target ball placement numbered segments or boxes #2 or #3.

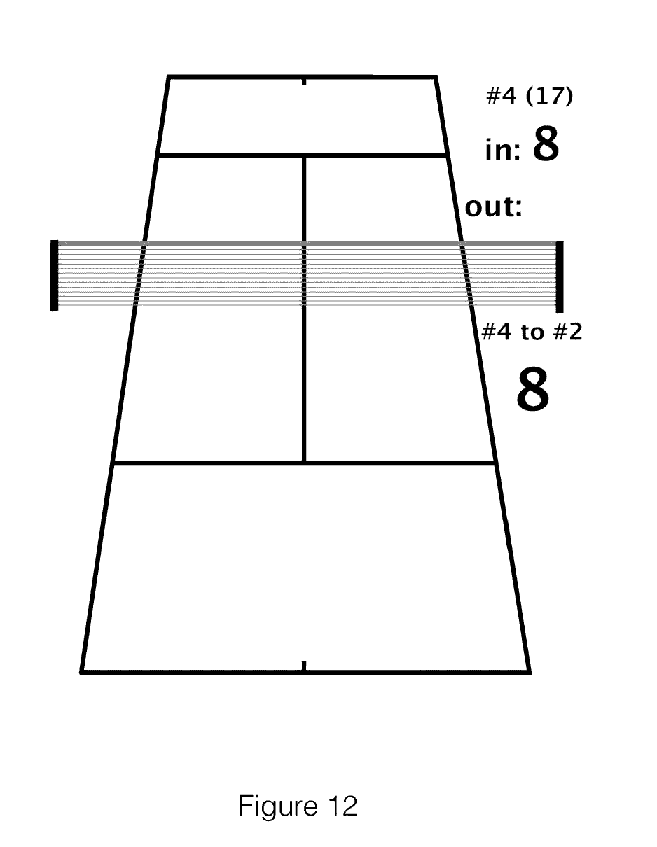

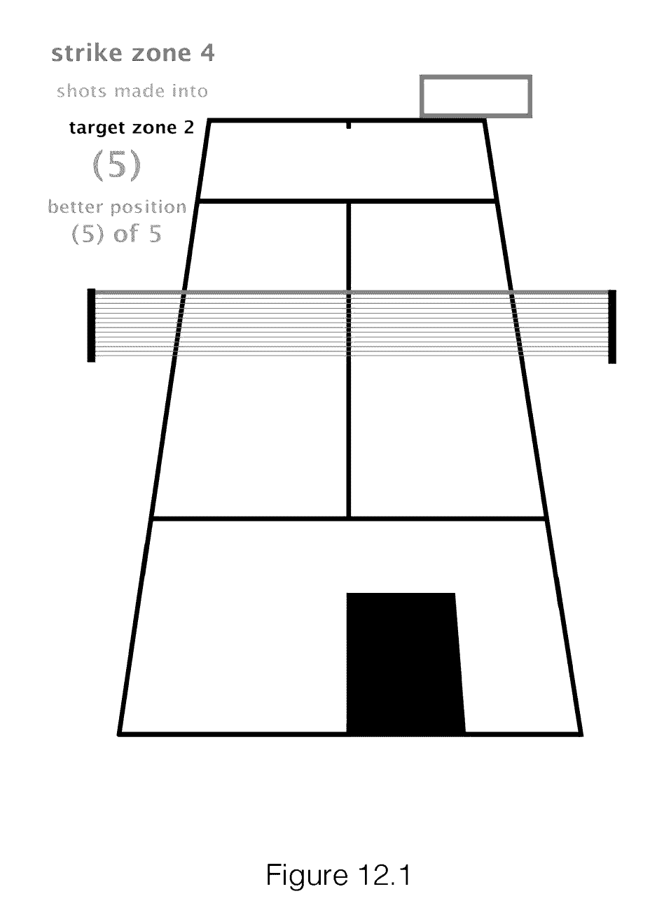

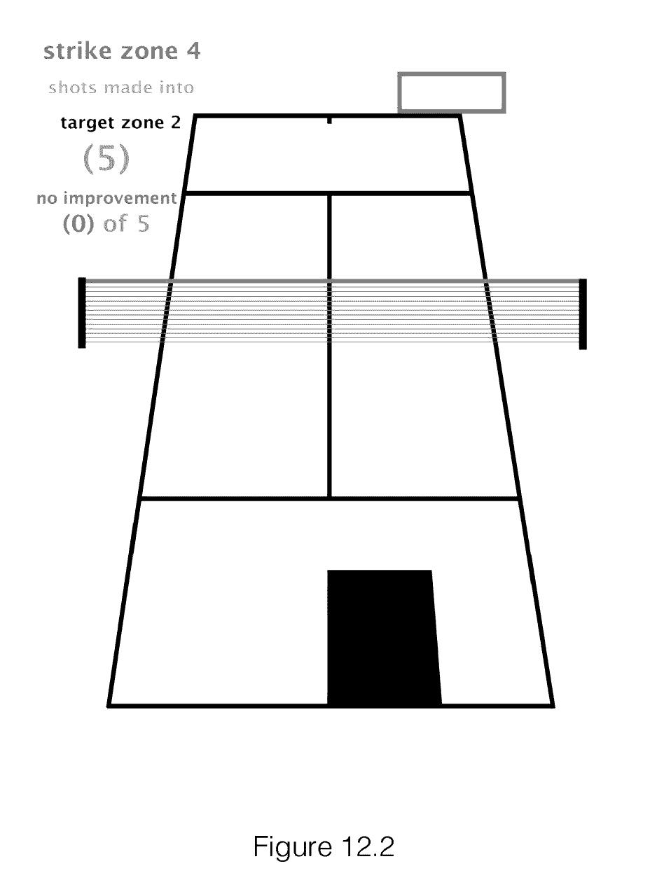

Referring to FIG. 10.2 as an example, if the player clicks on “(17)” on the outline or diagram illustrated in the top right hand corner in numbered feet location segment or box #4, according to a preferred embodiment, the court overlay as illustrated in FIGS. 12.1 may appear over the clips or video playback of the player's recorded match wherein the player's feet where located in numbered feet location segment or box #4 shown in FIG. 10.2. The player may now view, for training purposes, all of his/her shots played while his/her feet were located in numbered feet location segment or box #4 with his/her ball landing in a desired target ball placement segment or box, for example, numbered target ball placement segment #2 and/or #3 of the opposite court. For example, according to one embodiment as shown in FIG. 12.1 or 12.2 all shots taken while the player's feet were located in feet location segment or box #4 with the ball landing in ball placement segment or box #2 of the opposite court are played back for positive reinforcement training of the player with or without segment or area overlays on the clips or the video playback on the actual court of the player's recorded match.

In addition, and according to some embodiments, additional information, as illustrated in FIGS. 13.1 and 13.2 may appear on the display, e.g., information or data in preferably different colors. The strike zone color text may match the color of the strike zone that was assigned to the lesson, in this case it was red, but it can also be other colors depending on the lesson that is created. “Shots made into” FIG. 12.1 text may be in green, indicating that it was good because green means good. “Target zone” text may be blue because the target zones on the tennis court may be blue. The (5) may be in the color green because 5 balls were hit into the target zones and green means good. The feedback screens may also indicate whether the player's position improved on his/her next shot (see FIGS. 13.1 and 13.2) or whether his/her position did not improve on his/her next shot after his/her ball landed in the target zone. FIG. 13.1 “better position” (3) of 6 is in the color green because green means good. In FIG. 13.3, “better position” (8) of 11 is in the color green because green means good, and “no improvement” (3) of 11 is in red because red means not good.

In FIG. 12.1, “better position (5) of 5”, text stays green because the 5 were all the balls that landed into the target zone 2 regarding shots taken by the player during his/her match with his/her feet located in numbered segment or box #4, e.g., shot statistics (“stats”).

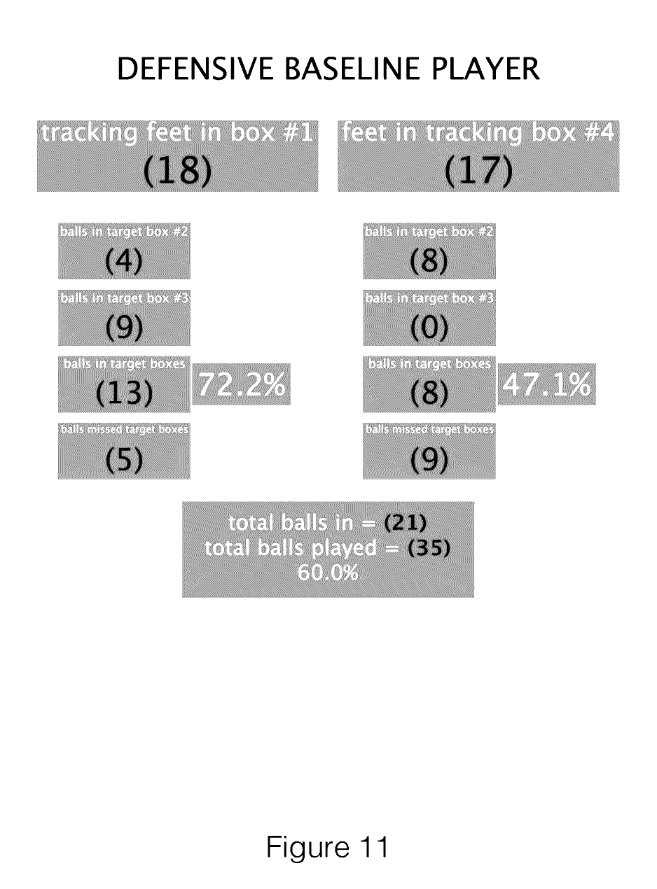

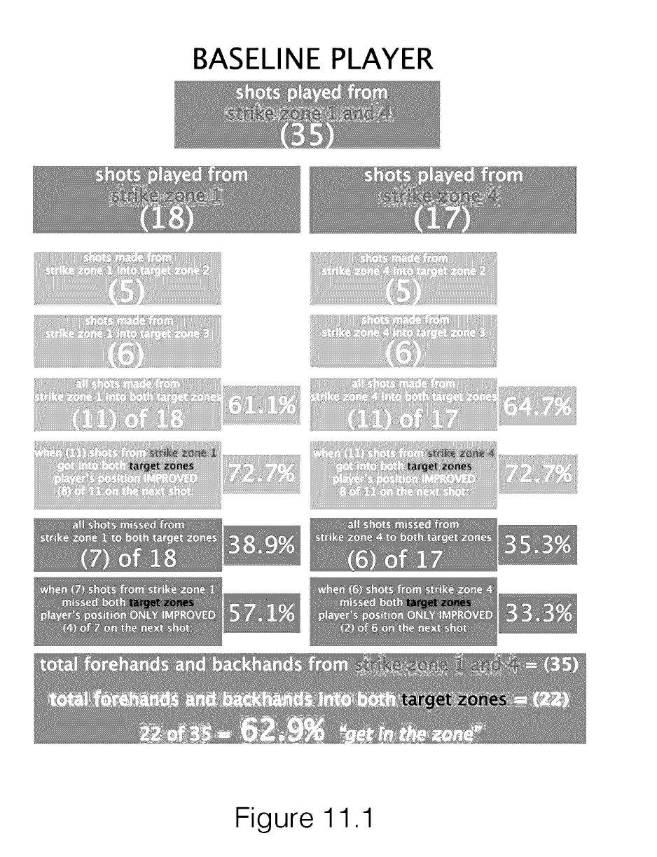

Referring back to the screen illustrated in FIG. 11, if the player clicks on “(9)” displayed under “balls missed target boxes”, then the recording of all of the player's 9 missed shots from feet location box or segment #4 that did not land in the desired ball landing segments #2 or #3 will be played back with or without overlay of the court numbered segments or boxes as desired.

As listed in FIG. 11.1, the player only made 5 shots (“shots made from strike zone 4 into target zone 2”) while his/her feet were located in feet location segment or box #4 resulting in a ball landing in a desired target ball placement segment or box #2. And as discussed above, clicking on the “(5)” in FIG. 11.1 and/or in FIG. 10.2 in target ball placement segment or box #2 on the court opposite the player, preferably gives the player access to the video playback or clips of the player's recorded match of each of his/her 5 shots made while the player's feet were located in feet location segment or box #4 resulting in the ball landing in desired target ball placement segment or box #2 of the opposite court.

According to one embodiment and referring to FIG. 11.1, if the player clicks on “(6)” in the “all shots missed from strike zone 4 to both target zones” an overlay or diagram as shown in FIGS. 13.1 and 13.2 will appear over the clips or video playback of the actual court during the player's recorded match of the “6” missed shots wherein the shots taken by the player while his/her feet were located in feet location segment 4 did not result with a ball landing in the desired target ball placement segments or boxes #2 or #3 in the opposite court which are illustrated as one big segment in FIGS. 13.1 and 13.2 (but could also be illustrated as segments or boxes #2 and #3). Hyperlinks from FIG. 13.1 may show 3 clips where the player's position improved. Hyperlinks from FIG. 13.2 may show 3 clips where the player's position did not improve.

Referring back to FIG. 10.2, according to another embodiment, if a player to be trained clicks on the hyperlink “(5)” in desired target ball placement segment or box #2 of the opposite court, an overlay or diagram, e.g., as shown in FIGS. 12.1 and 12.2, may optionally appear and the player may now be linked to or view only the clips or video playback of the 5 balls he/she hit while his/her feet were located in feet location segment or box #4 resulting with a ball landing in the desired target ball placement segment or box #2 with the overlay or diagram visible, preferably faintly visible not to interfere with the player's viewing of the playback of the video recording of the shots. Data, for example as shown in FIGS. 12.1 and 12.2 may appear alongside next to the court as a reference so that the player understands what he/she is viewing.

In addition, the same concept of displays and interaction will be available to the player for training regarding all “numbers” listed in parenthesis or shown in the outlines/displays/diagrams illustrated throughout this disclosure, e.g., in FIGS. 11, 11.1, 17, 24, 32, 40, and 56, i.e., all shots represented by a numeral on a display or outline that are displayed in parenthesis may be selected or clicked-on by the player and the player will be linked to or given access to view recorded video play back with or without the court overlay and/or numbered and colored segments. Preferably, all numerals in parenthesis (preferably shown in any color) on which a player may select or click-on are “live” and result in giving the player access to the video clips or playback of his/her shots made and/or missed during the recorded match represented by the numeral with and without an overlay of the court outline or diagram over the video clips or playback of those specific shots.

As shown according to one example embodiment, the invention may include a display for viewing by the player of the statistics of the player's recorded match provided by the analyzer for a given lesson and/or strategy. For example, as shown, once the recording of the player's match is received, the analyzer analyzes the match and provides data or stats of the match, for example, as shown and categorized for a defensive baseliner strategy or lesson in FIG. 10, 10.1, 10.2, 11.1 As shown in FIG. 11.1, the analyzer according to this lesson or teaching strategy tracks and categorizes the player's shots during the match to provide data or stats regarding the shots taken by the player while his or her feet were located in feet location segment or box #1 (called strike Zone 1)(along the baseline) and feet location segment or box #4 (called strike Zone 4)(also along the baseline) as illustrated in FIG. 10, 10.1, 10.2, 11.1. As shown in FIG. 11.1, the analyzer reported from analyzing the recording of the player's match, “(18)” “shots played from strike zone 1” taken by the player while the player's feet were in feet location segment or box #1 and “(17)” “shots playedfrom strike zone 4” shots taken by the player while the player's feet were located in feet location segment or box #4. Still referring to FIG. 11.1 and underneath the “shots played from strike zone 1” section, the analyzer may also analyze the recorded match and report “shots made from strike zone 1 into target zone 2”, “shots made from strike zone 1 into target zone 3”, “all shots made from strike zone 1 into both target zones”, “when shots from strike zone 1 got into both target zones player's position improved on next shot”, “all shots missed from strike zone 1 to both target zones”, “when shots from strike zone 1 missed both target zones player's position only improved on the next shot” with preferably, a percentage. As shown in FIG. 11.1, the analyzer reports and displays that while the player's feet were in feet location segment or box #1, (called strike Zone 1) “shots made from strike zone 1 into target zone 2” (5) balls landed in target ball placement segment or box #2 (called target zone 2) according to the lesson. As discussed herein, the player may select or click-on “(5)” shots in the “shots made from strike zone 1 into target zone 2”” and be linked to or view 5 clips or video playback of his/her recorded match of the (5) shots represented by the “(5),” e.g., all 5 shots taken by the player while the player's feet were located in feet location segment or box #1 (called strike Zone 1) that resulted in a ball landing in the desired target ball placement box or segment #2 (called target zone 2) according to a defensive baseline lesson or strategy.

Likewise, as shown in FIG. 11.1, the analyzer, after analyzing the recording of the player's match, may also provide and display data or stats on the same metrics as discussed above regarding shots attempted by the player while the player's feet were in feet location box or segment #1, (called strike Zone 1) for shots taken while the player's feet were located in feet location segment or box #4 (called strike Zone 4). Consequently, as shown in FIG. 11.1 on the right hand side underneath “shots played from strike zone 4” section, the analyzer may also analyze and report stats and data from the recorded match of balls hit by the player while her/his feet were in feet location box or segment #4 (called strike Zone 4) “shots made from strike zone 4 into target zone 2”, “shots made from strike zone 4 into target zone 3”, “all shots made from strike zone 4 into both target zones”, “when shots from strike zone 4 got into both target zones player's position improved on next shot”, “all shots missed from strike zone 4 to both target zones”, “when shots from strike zone 4 missed both target zones player's position only improved on the next shot” preferably also reporting a percentage as illustrated. As discussed above, the player may click-on or select any numeral in parenthesis and obtain a link to or a play back or clips of the recording for the shots represented by the numeral in a given section of the display—for example, all balls hit from feet location box or segment #4 (called strike Zone 4) to desired target ball placement segment or box #2 (called target zone 2) analyzed and reported by the analyzer from the recorded match as “(5)” “shots made from strike zone 4 into target zone 2” shots in the FIG. 11.1 example display. According to an embodiment, if the player clicks on “(11)” in the “all shots made from strike zone 4 into both target zones” on the screen illustrated in FIG. 11.1, the screen illustrated in FIG. 13.3 will appear to play back the video of the 11 shots made into the target boxes.

Still referring to FIG. 11.1, the analyzer may also analyze the recording of the player's match and provide or report for a given lesson or strategy, e.g., a baseliner, as reported in FIG. 11.1, summary stats or data, e.g., as shown at the bottom of FIG. 11.1, “total forehands and backhands into both target zones=(22)”—e.g., 22 total balls landing in the desired target placement boxes or segments for the strategy or lesson, here for a baseliner, segments or boxes #2 and #3 from feet location boxes # land #4″; and/or “total forehands and backhands from strike zone 1 and 4=(35)” while the player's feet were located in feet location segments or boxes #1 and #4. The numerals in the summary section may or may not be “live” and thus, may or may not link the player to be trained to clips or video playback (with or without overlays) of all shots summarized as discussed above. For example, according to an embodiment, if a player clicks on “(22)” listed next to “total forehands and backhands into both target zones” on the screen illustrated in FIG. 11.1, then video play back of the player's shots will play in the following sequence: (1) lowest numbered player's feet location box or segment (called strike Zone) into the lowest numbered ball landing area box or segment (called target Zone) until all shots made from the feet location box or segment (called strike Zone) into all ball landing areas or segments (called target Zones) have been played back; and then (2) the next highest numbered player's feet location box segment (called strike Zone) into the lowest numbered ball landing segment or box (called target Zones) until all shots made from the feet location box or segment (called strike Zone) into all ball landing area segments or boxes (called target Zones) have been played back. Specifically, according to one embodiment, after clicking on “(22)” on the screen illustrated in FIG. 11.1, the sequence of the video play back of shots made would be displayed as follows:

(1) 5 shots made from #1 feet location box or segment (called strike Zone 1) to #2 ball landing area, segment or box (called target Zone 2);

(2) 6 shots made from #1 feet location box or segment (called strike Zone 1) to #3 ball landing area, segment or box (called target Zone 3);

(3) 5 shots made from #4 feet location box or segment (called strike Zone 4) to #2 ball landing area, segment or box (called target Zone 2); and

(4) 6 shots made from #4 feet location box or segment (called strike zone 4) to #3 ball landing area, segment or box (called target Zone 3).

According to another embodiment, and referring again to the screen illustrated in FIG. 11.1, if the player clicks on “(35)” displayed next to the “total forehands and backhands from strike zone 1 and 4” the sequence of the video play back of shots played would be displayed as follows:

(1) 5 shots made from #1 feet location box or segment (called strike Zone 1) to #2 ball landing area, segment or box (called target Zone 2);

(2) 6 shots made from #1 feet location box or segment (called strike Zone 1) to #3 ball landing area, segment or box (called target Zone 3);

(3) 5 shots made from #4 feet location box or segment (called strike Zone 4) to #2 ball landing area, segment or box (called target Zone 2); and

(4) 6 shots made from #4 feet location box or segment (called strike zone 4) to #3 ball landing area, segment or box (called target Zone 3);

(5) 7 missed shots from feet location box or segment #1 (called strike Zone 1); and

(6) 6 missed shots from feet location box or segment #4.

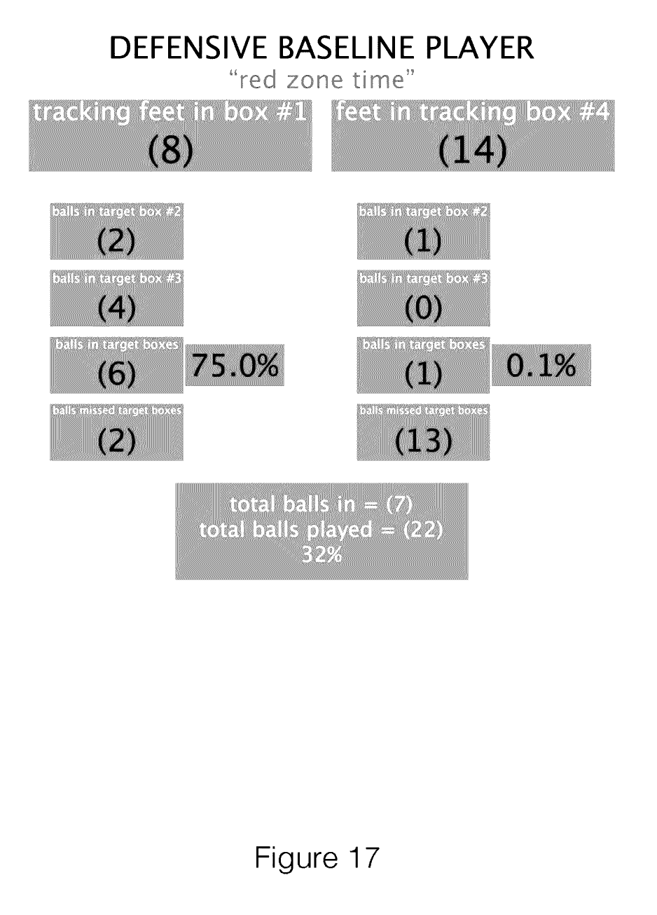

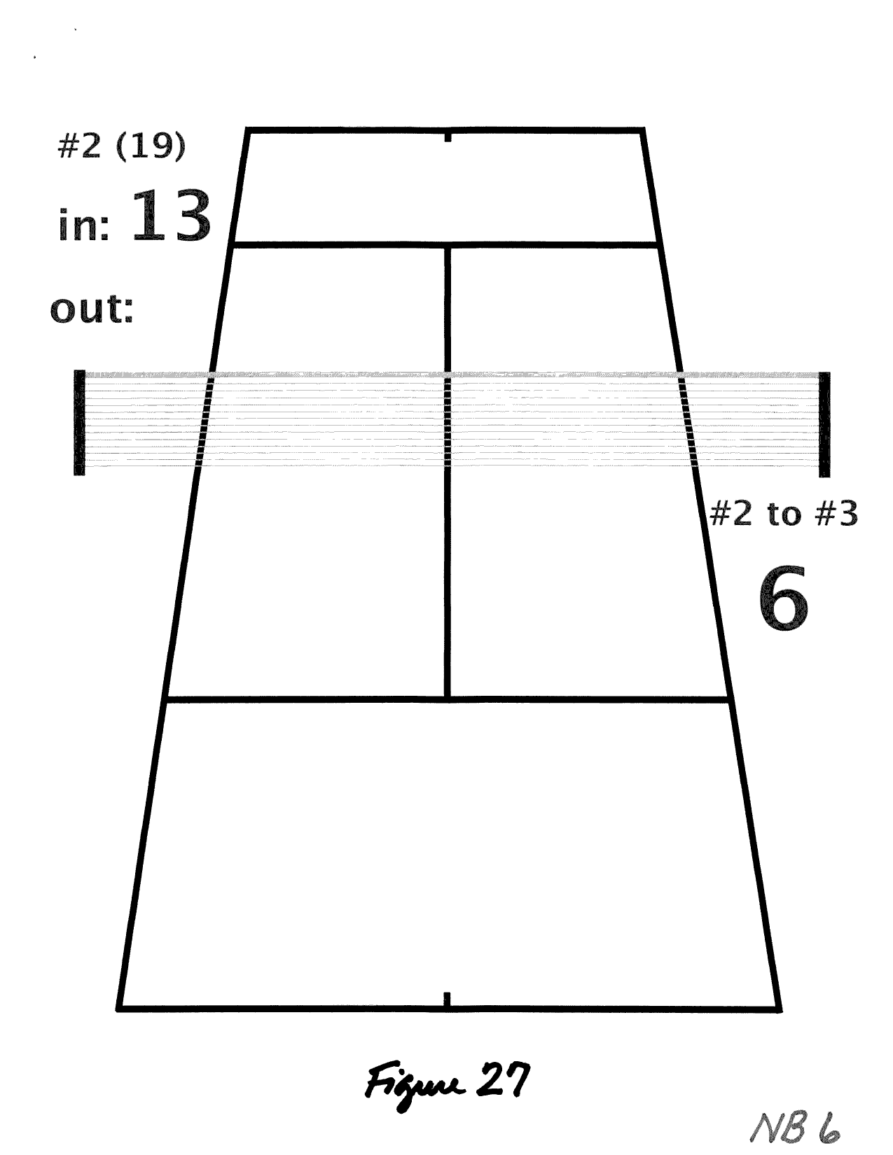

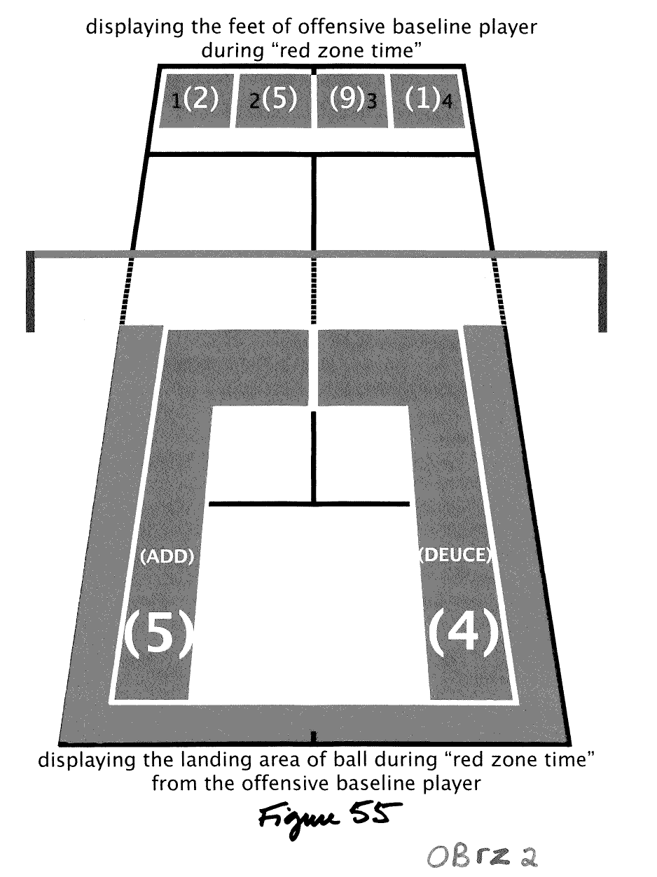

Similar data and/or stats as discussed above regarding a defensive baseliner, may be analyzed and provided or reported by the analyzer from an analysis of the player's recorded match for various other lessons and teaching strategies having the same interactivity to link the player to specific clips or video playback of shots meeting the clicked-on or selected criteria represented generally by a numeral in parenthesis in a section of each display. See for example, FIGS. 17, 24, 32, 40 and 56.

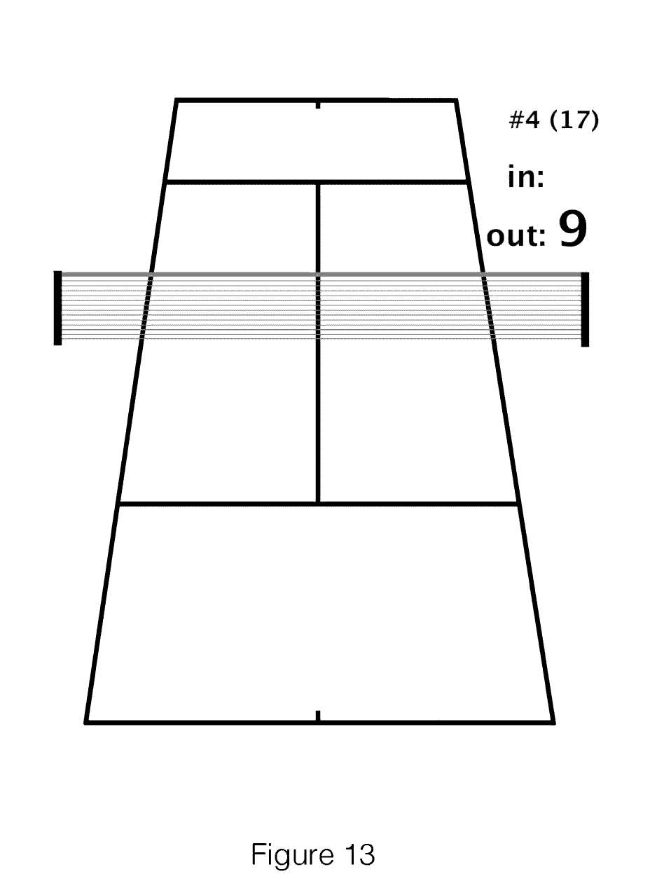

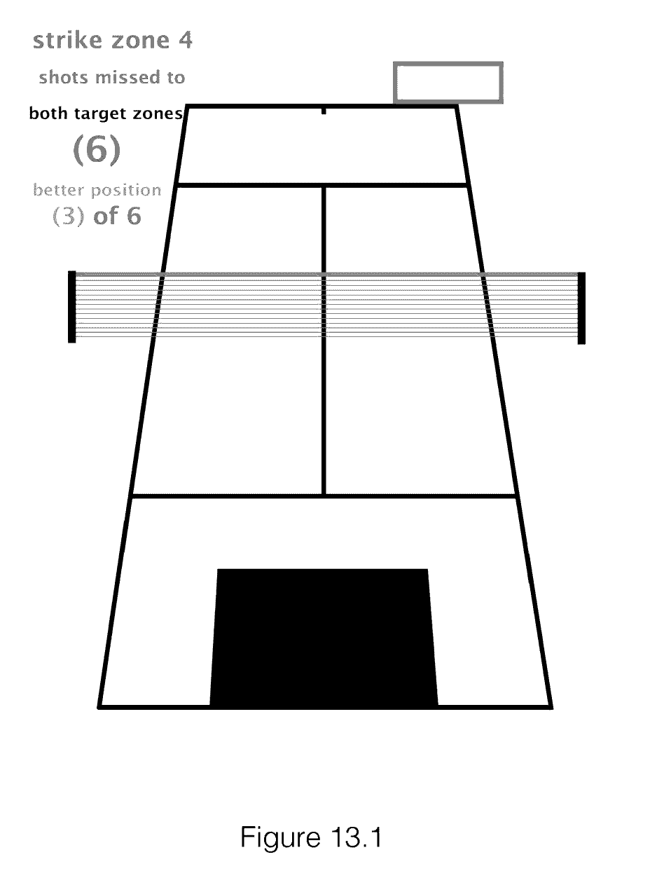

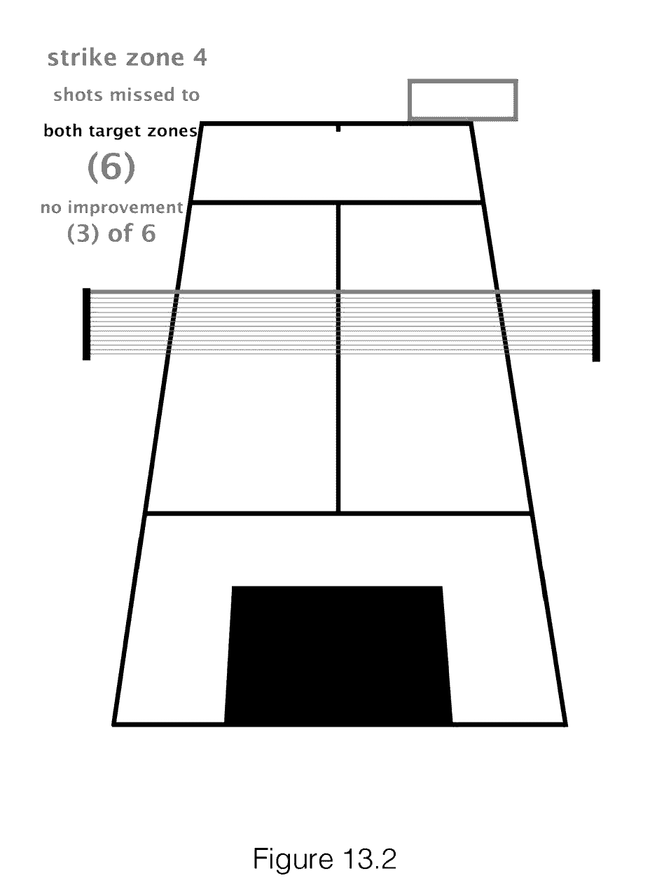

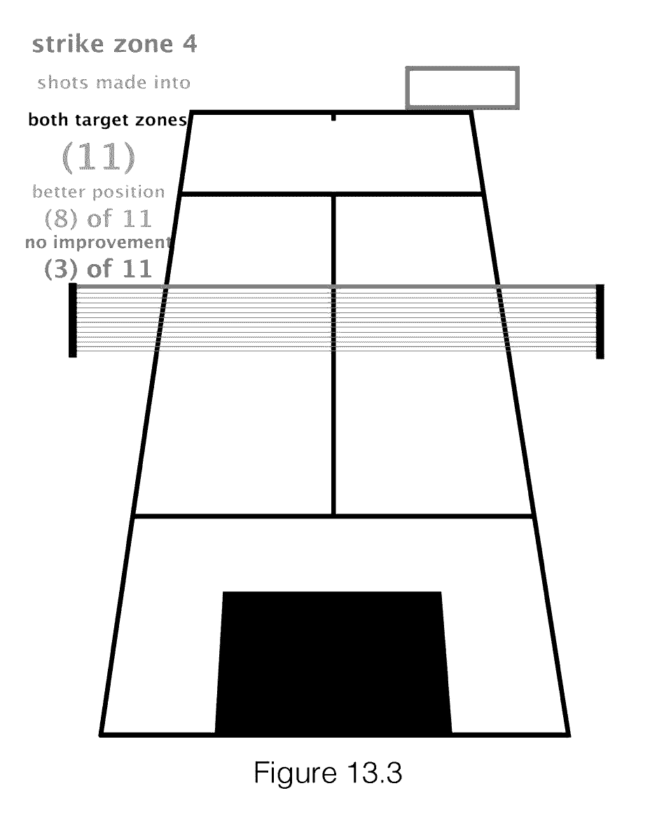

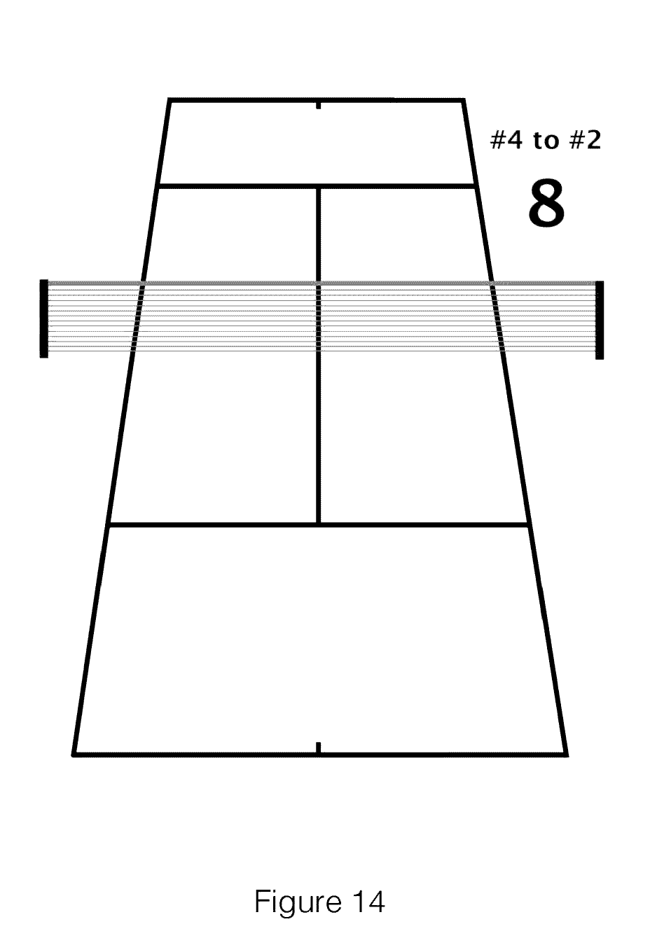

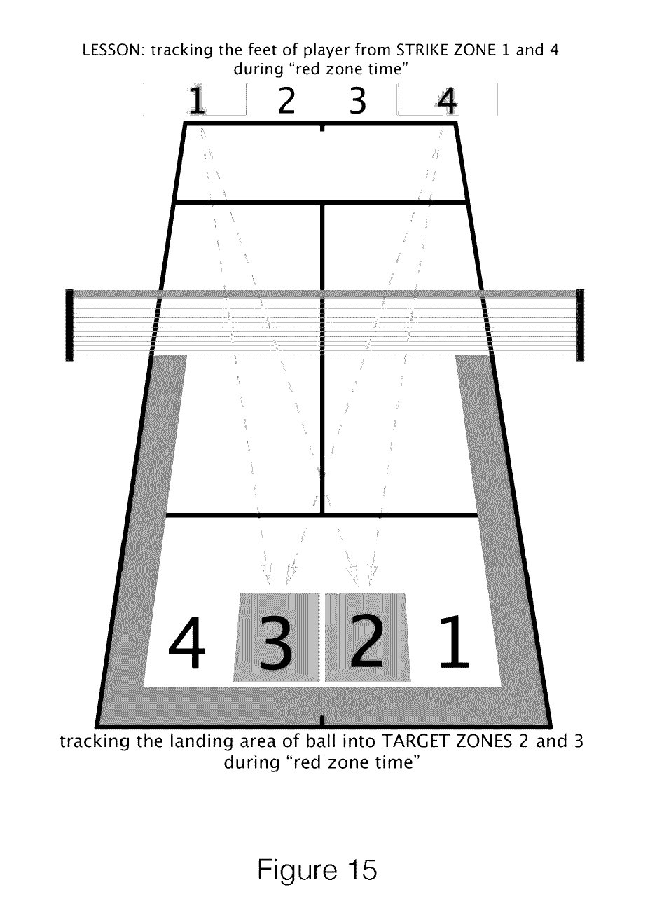

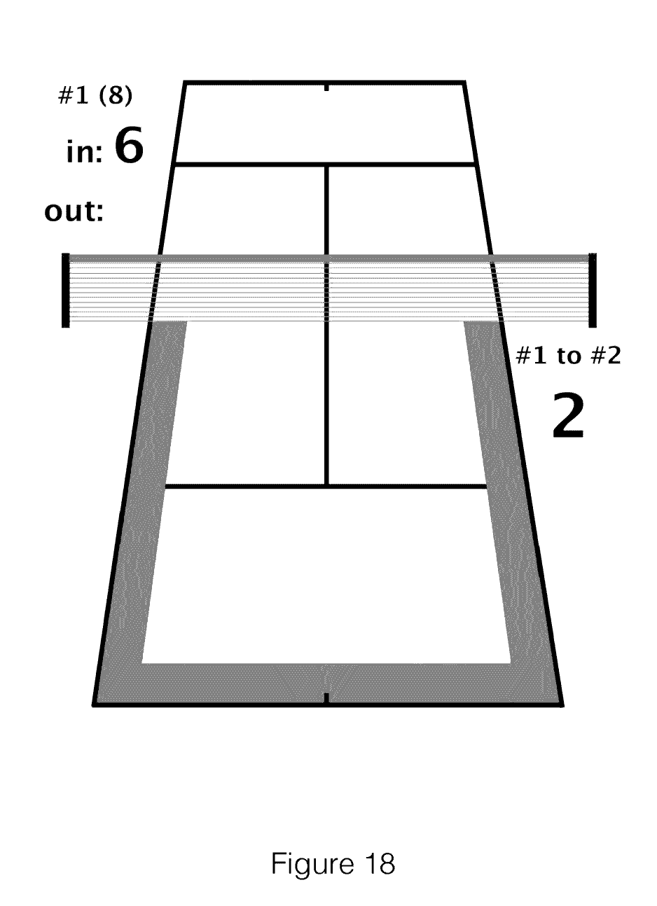

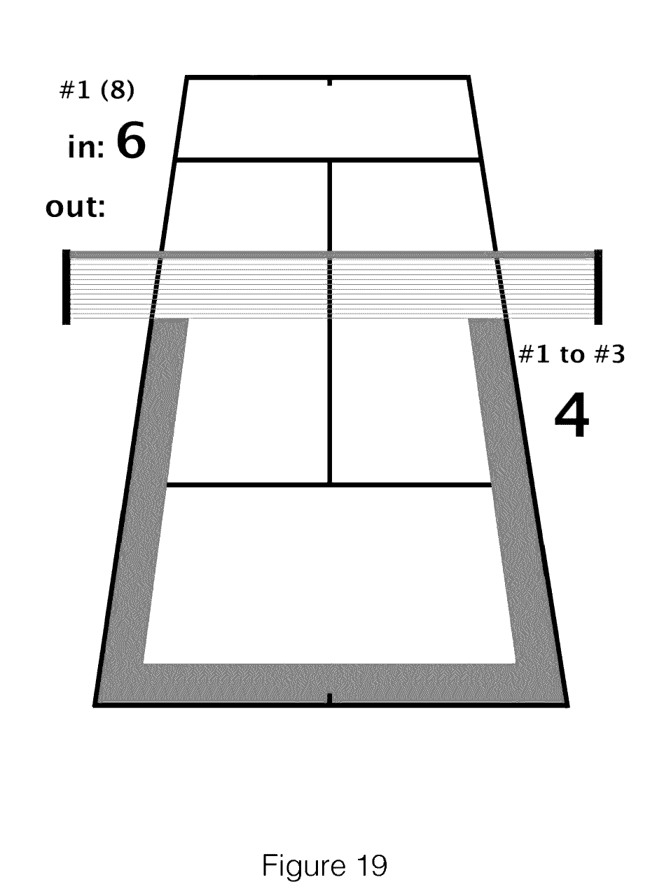

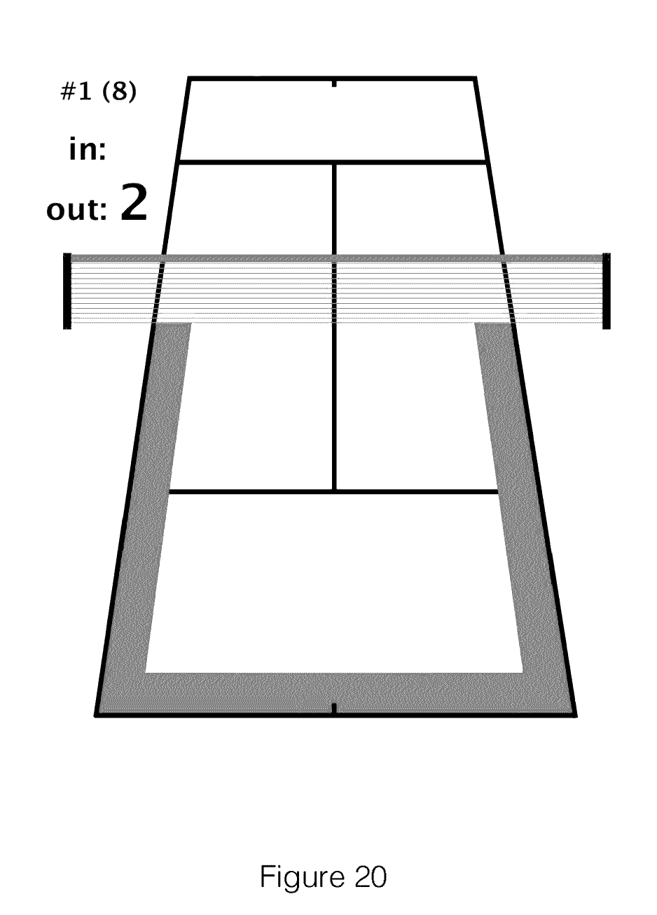

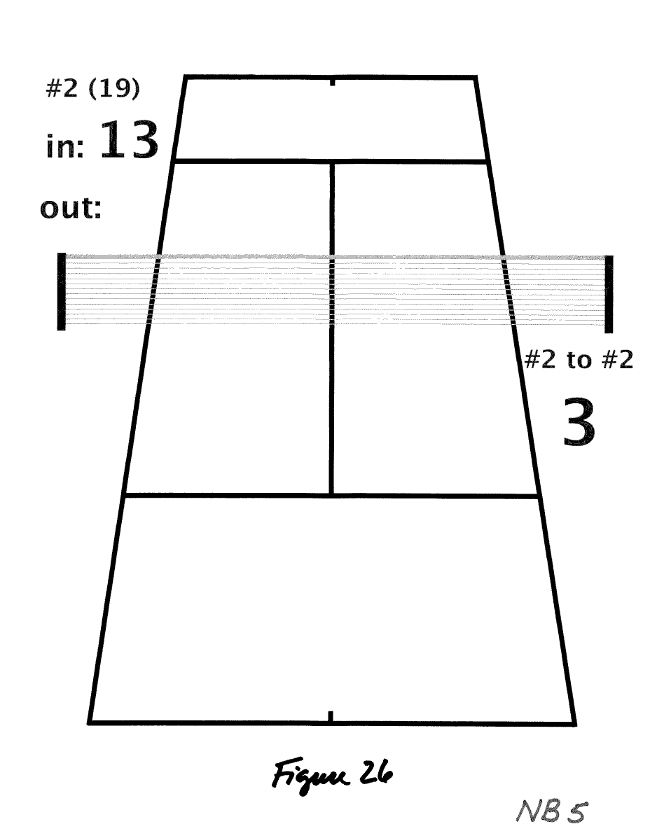

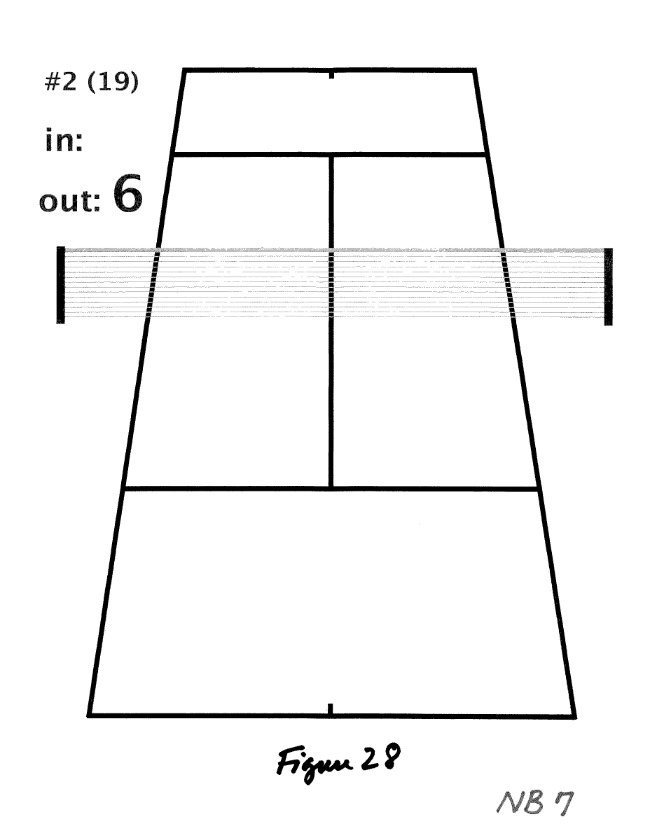

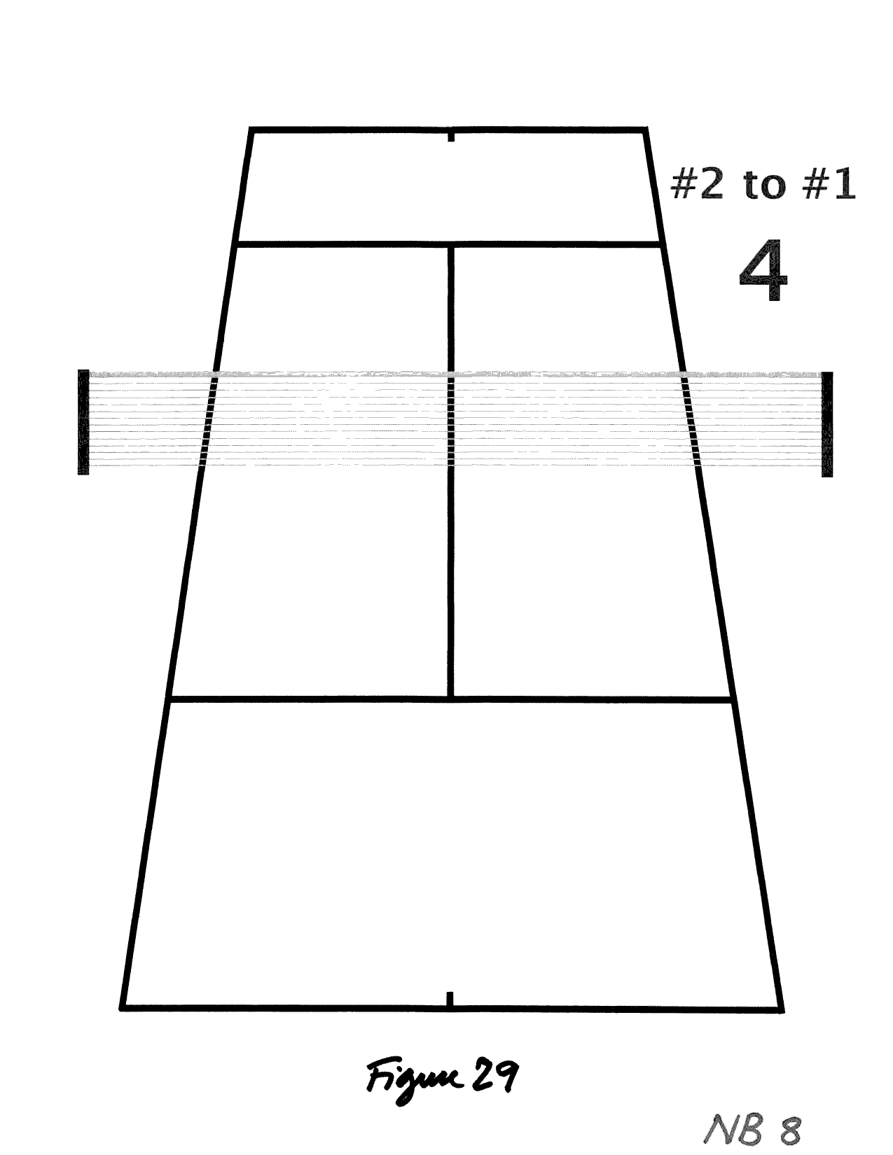

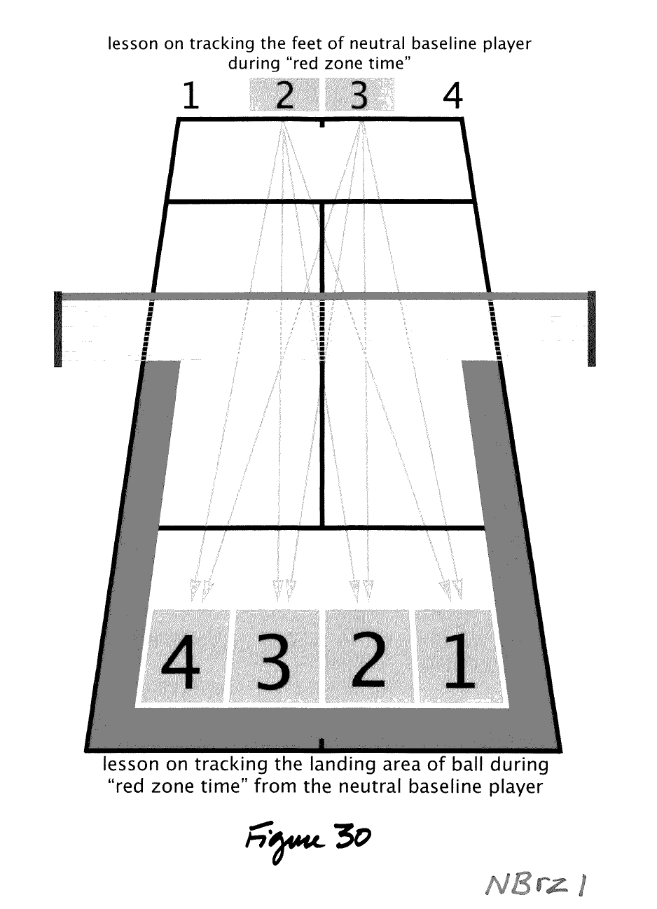

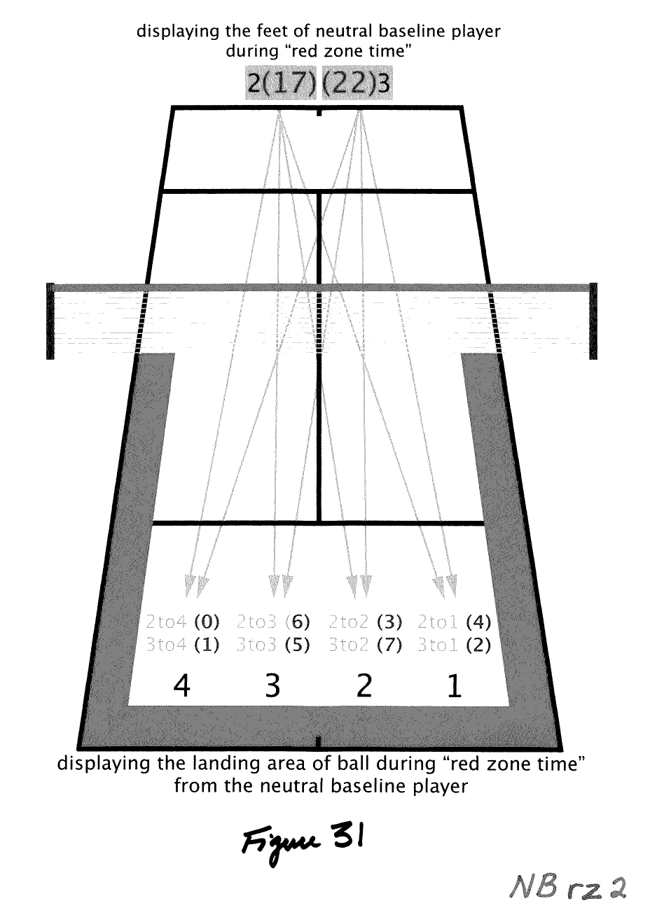

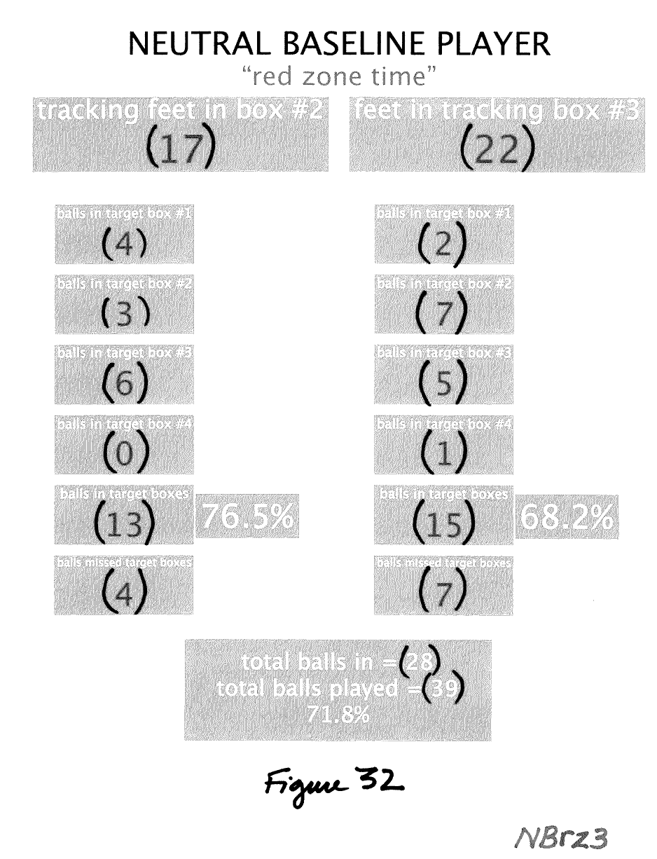

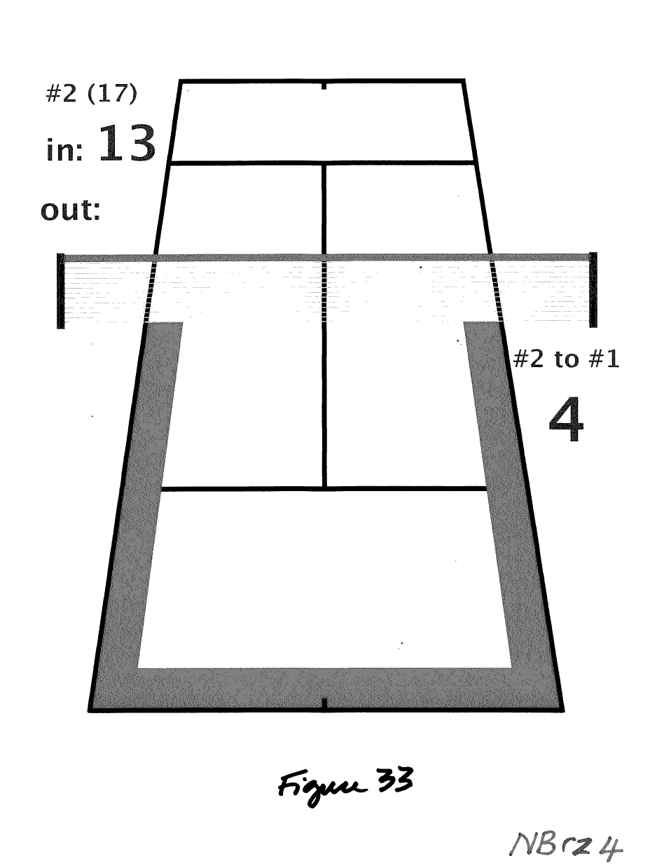

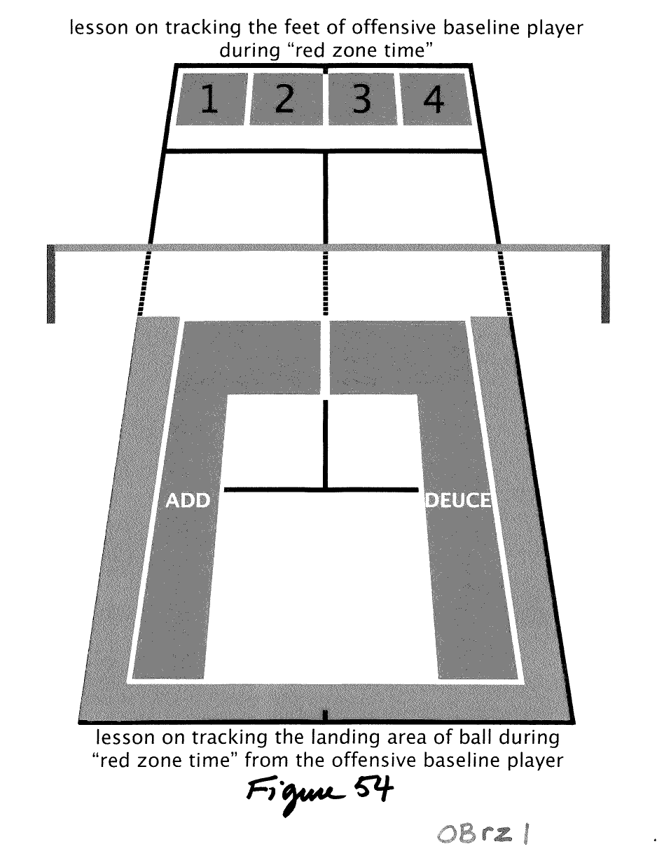

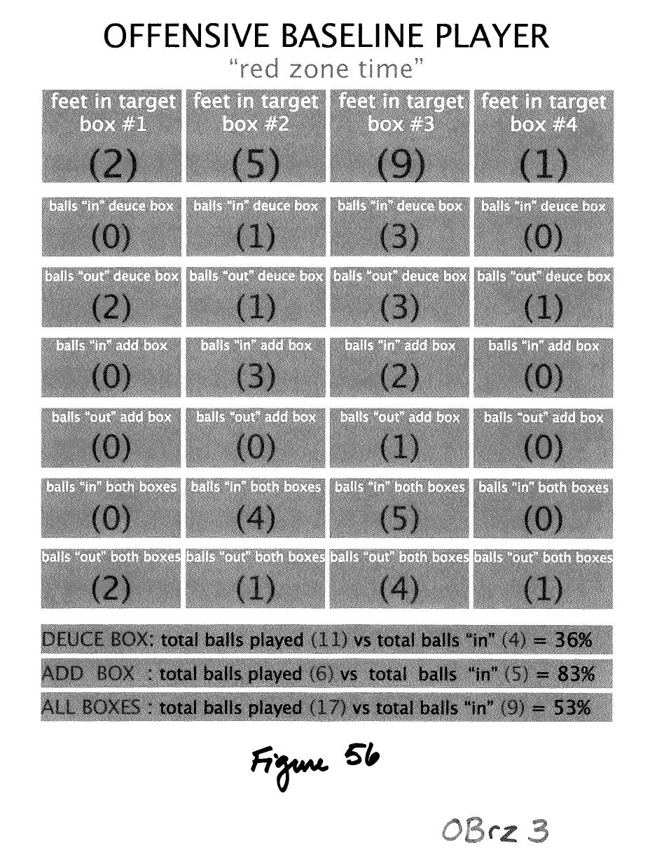

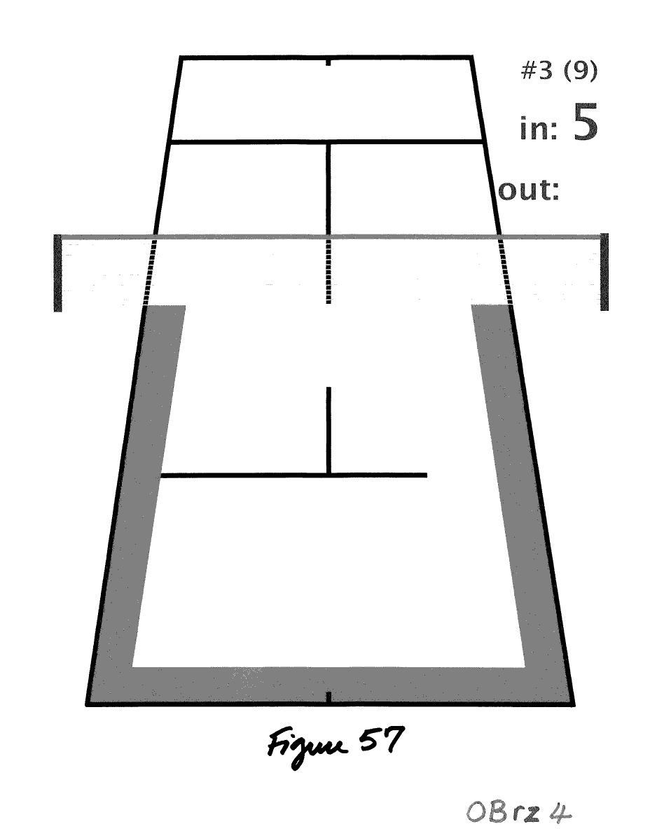

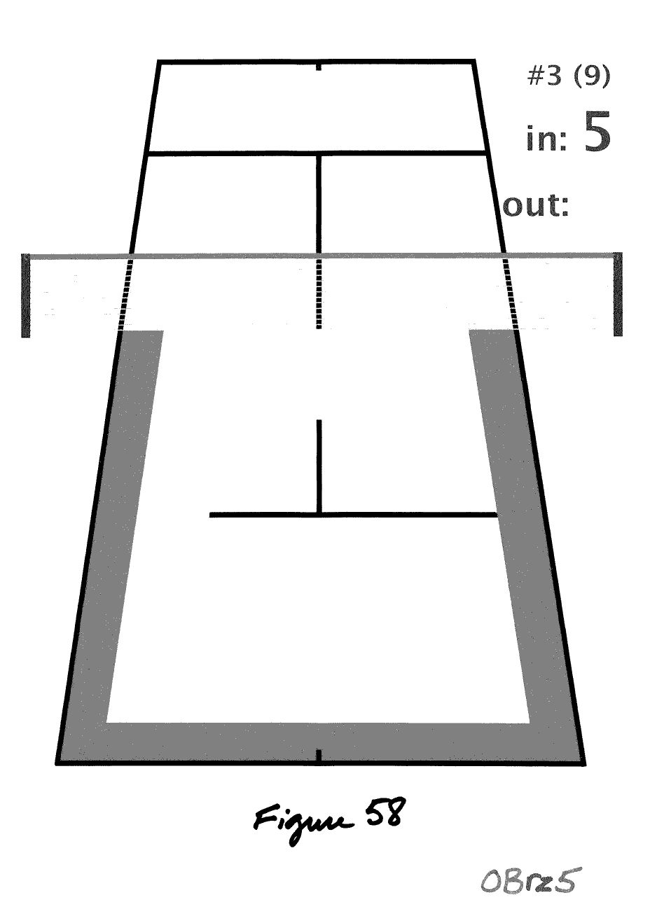

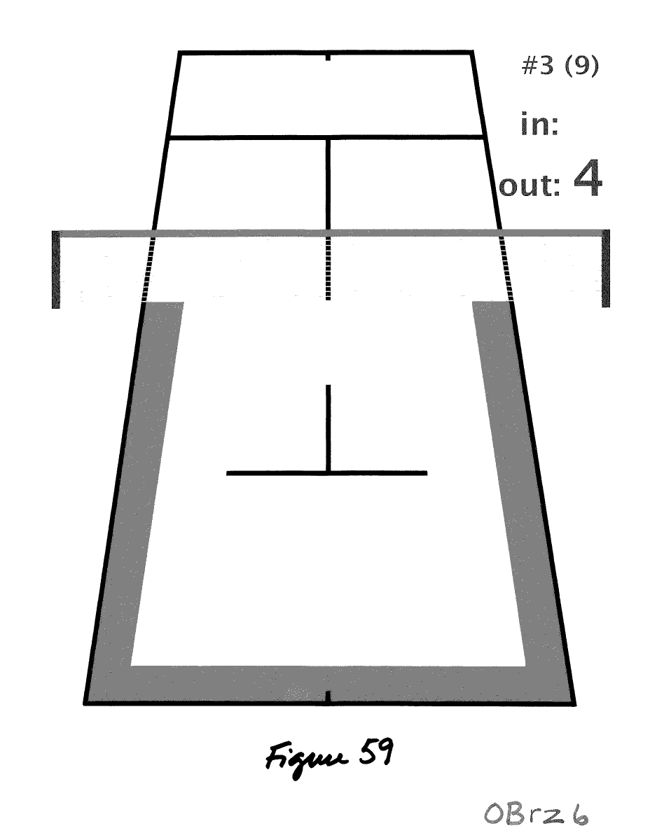

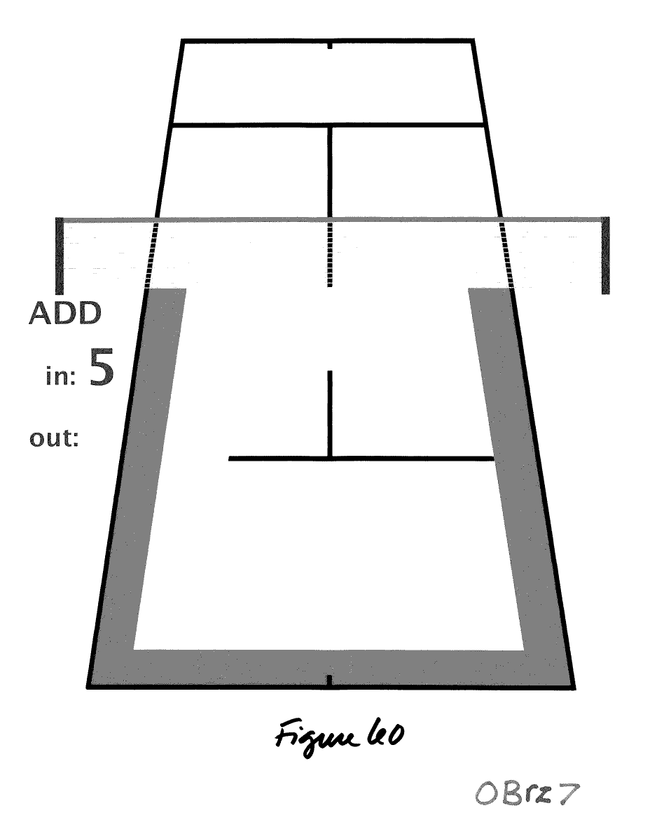

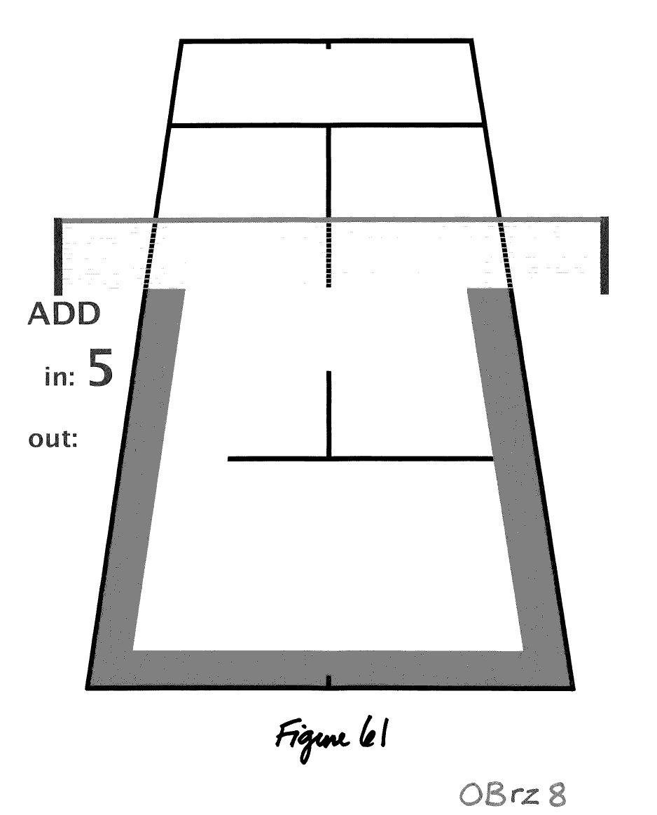

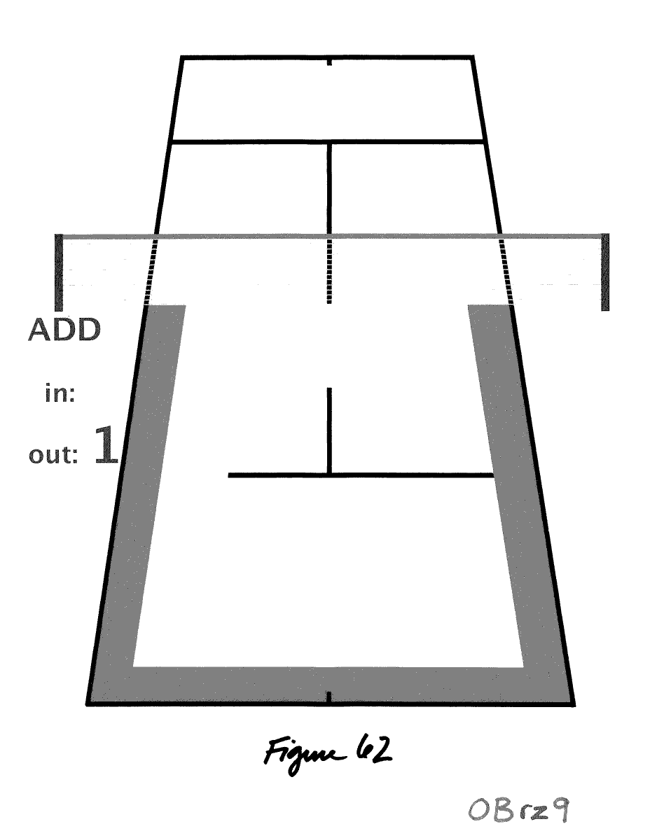

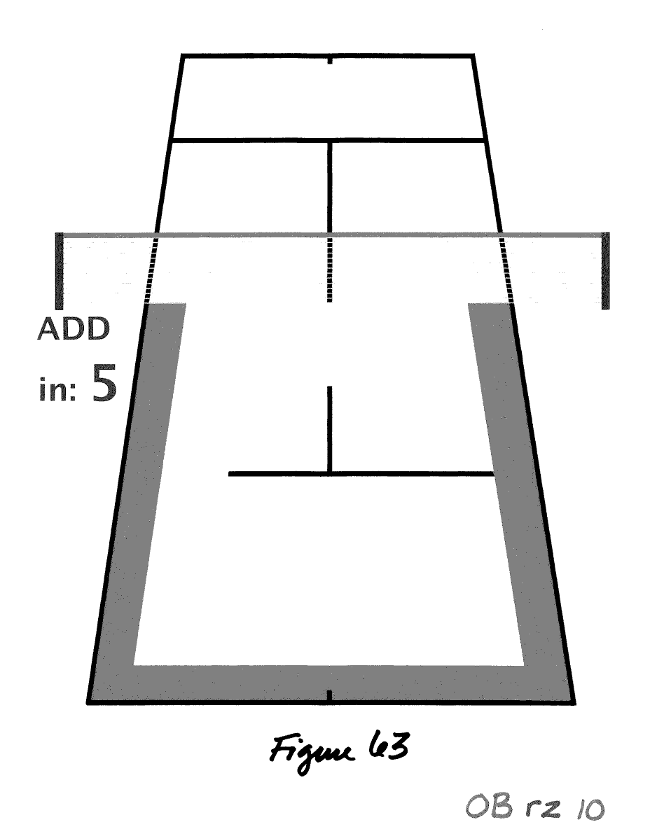

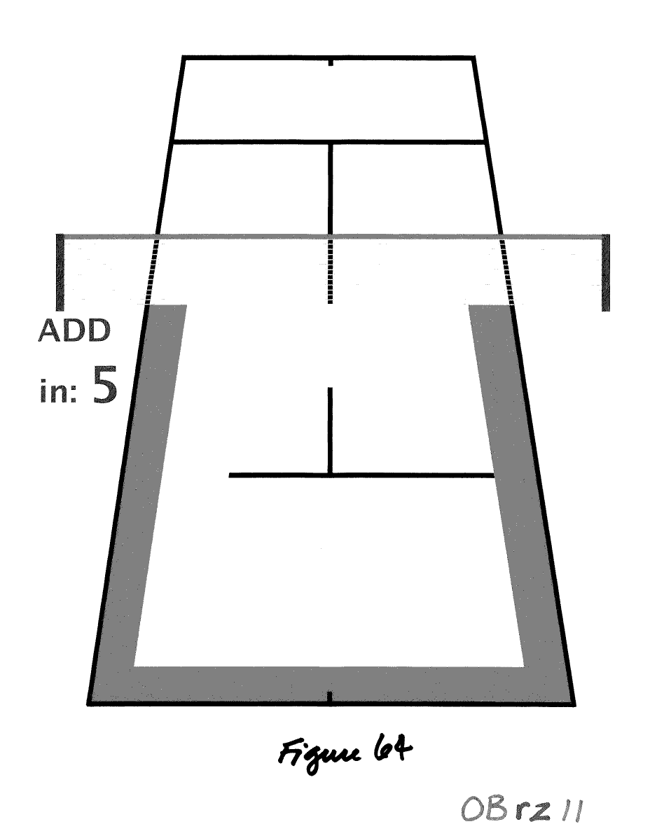

According to further embodiments, the invention may comprise different teaching or training different match strategies, e.g., target ball placement, depending upon the circumstances of the match, for example, the score of the current game and/or the score of the match. Consequently, according to some embodiments, the invention may comprise a defensive baseliner “red zone time” (“DBrz”), a neutral baseliner “red zone time” (“NBrz”) and an offensive baseliner “red zone time” (“OBrz”) lesson or strategy training. See for example, FIGS. 15-21, 30-37, and 54-64.

According to some embodiments, the player may be provided with an analysis of his/her recorded match to understand certain strategies to employ during his or her next match and/or view and gain positive reinforcement of actual shots made by the player during his or her match that fell within a teaching strategy for the circumstance of a match at a given time and score. For example, according to some embodiments as illustrated in FIGS. 15-21, due to the circumstance and/or score of the match, a player may employ a defensive baseliner red zone time strategy—meaning, for example, as illustrated in FIG. 15, the player should possibly avoid hitting the ball into the red zone outlined inside of and along the boundary in the opposite court shown in FIG. 15, i.e., giving himself/herself plenty of room to avoid error waiting for the opposing player to make an error by, e.g., hitting the ball out of bounds. Such a strategy may be useful to employ, for example, when a player is facing match point for his/her opponent.

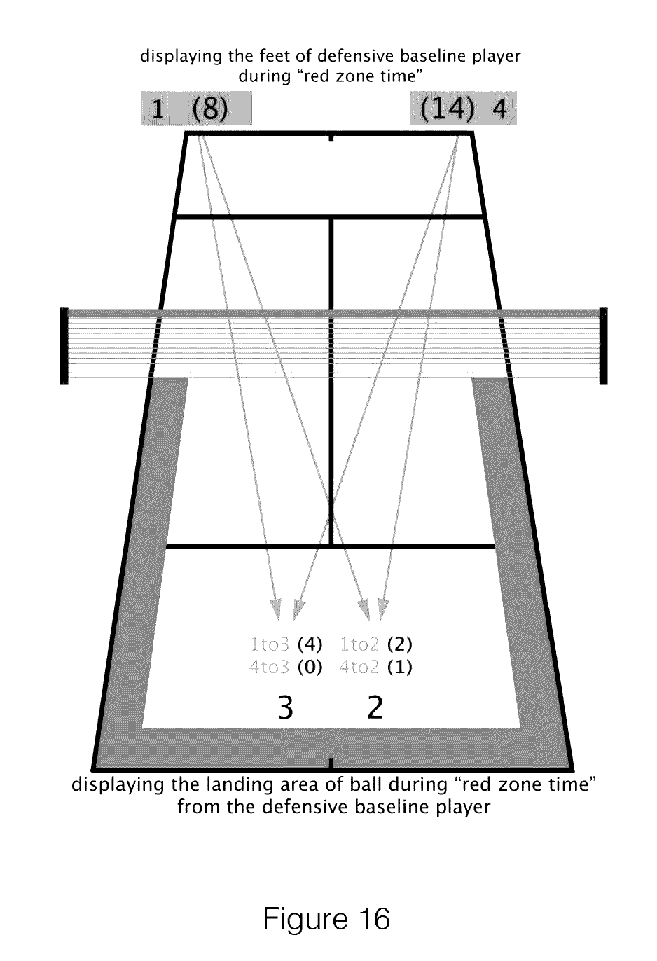

As illustrated, for example in FIGS. 16-21, according to some embodiments of the invention, a player may be linked to or access various training clips or video play back of his/her match by clicking-on or selecting numerals, preferably displayed in blue color and in parentheticals. As discussed above, the lesson and training strategy according to the defensive baseliner red zone time operates in the same way as discussed above. See, for example, FIGS. 15-21 wherein desired target ball placement segments or boxes #2 and #3 are smaller due to the red zone avoidance or danger areas shown in red.

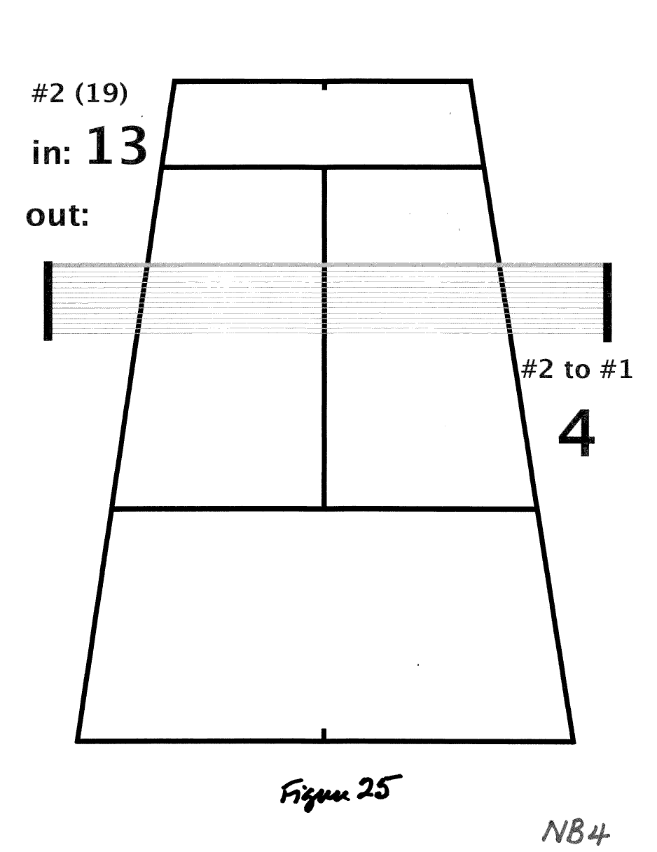

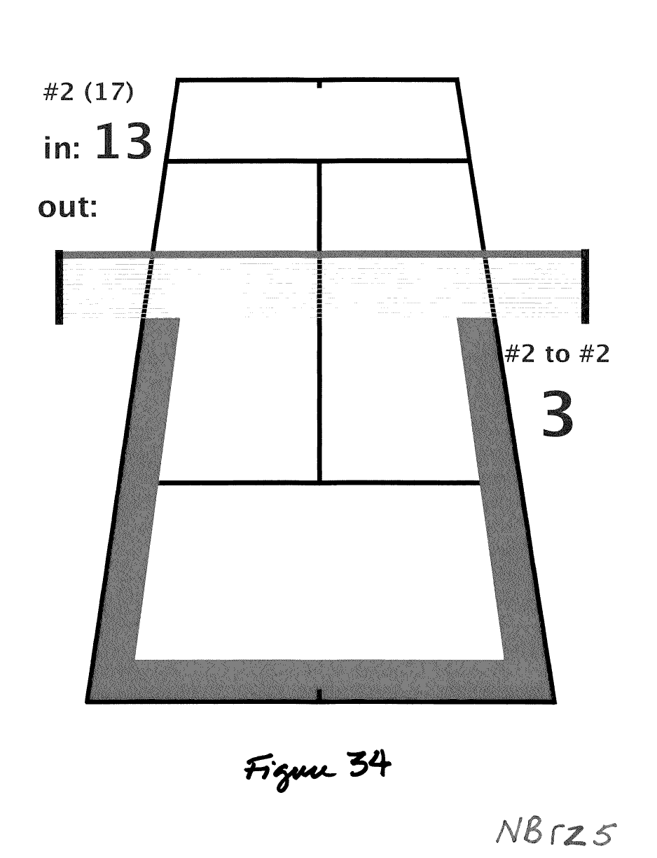

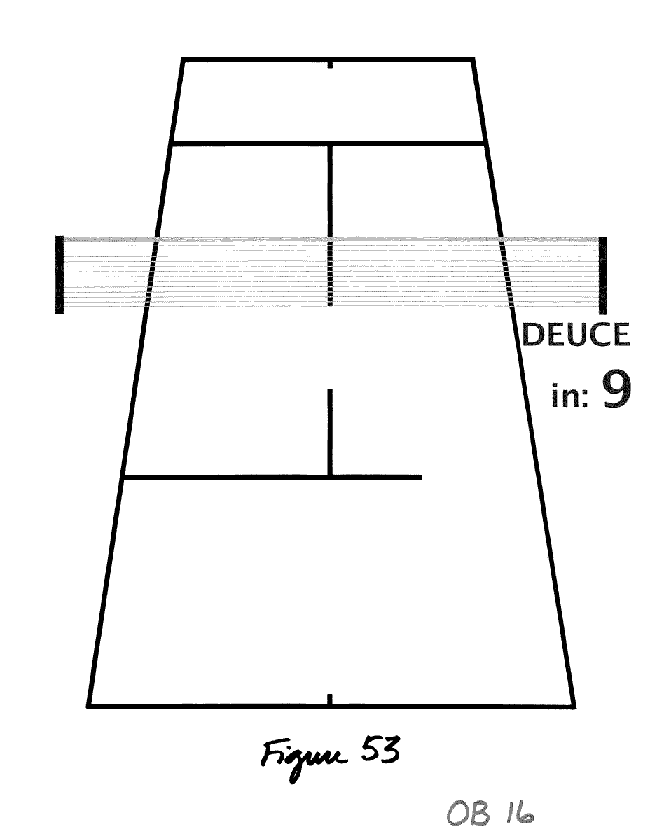

According to further embodiments of the present invention, and operating on the same general principle as discussed above with regard to the defensive baseliner strategy or lesson, the player may access or receive training based upon additional strategies useful to employ during certain times of a match, for example, at certain scores and points during a given match of the player. For example, FIGS. 22-29 illustrate an example embodiment of the invention for a neutral baseline player; FIGS. 30-37 illustrate an example embodiment of the invention for an neutral baseline red zone time player; FIGS. 38-53 illustrate an example embodiment of the invention for an offensive baseline player; and FIGS. 54-64 illustrate an example embodiment of the invention for an offensive red zone time baseline player.

The above described lessons and strategies are mere examples of lessons and strategies that may be provided by various embodiments of the present invention. However, the invention is not meant to be limited by these examples and the invention includes within its scope other training and teaching lessons and strategies not specifically described herein, for example, but not limited to, serve and stroke/return sequences lessons/strategies and service strategies/lessons. The present invention may be advantageously applied to all circumstances and conditions faced by a tennis player during a tennis match and provide training, lessons and strategies by analyzing and then categorizing an actual recording of the player's match into specific clips to train the player, for example, by positive visual video feedback of the player's strokes resulting in a ball landing in a desired target ball placement segment according to a specific lesson or a strategy.

According to a further embodiment, the invention preferably may include positioning at least one elevated mount for a video camera over a tennis court for recording a tennis match of a player to be trained. The invention may also preferably comprise positioning a video camera in the elevated mount and providing a storage device, typically in the camera, for storing a recording of a match made with the mounted video camera. According to another embodiment, the mounted video camera is positioned for recording (i) a player's court location, e.g., the location of a player's feet during different racquet strokes of the player during a match, and (ii) the landing location of struck balls in the court opposite the player. Preferably, the video recording of the player's match and the player's tennis racquet strokes are stored on the storage device.

According to a preferred embodiment, the stored video recording of the player's tennis match is transmitted or uploaded to an analyzer, e.g., remote from the tennis match for playing back the video recording of the tennis match. During play back, the invention may comprise the categorization, e.g., by the analyzer, e.g., preferably using modified software and systems provided by known vendors in the tennis industry, e.g., by PlaySight, Dartfish, or manually, each racquet stroke of the player based upon (i) the player's position, preferably the player's feet location, on the court in an assigned numbered segment, box or colored area of the court outline or diagram according to some embodiments of the invention, and (ii) the resulting landing location of each ball struck by the player in a numbered segment, box or colored area on the side of the tennis court opposite the player, e.g., of the outline or diagram.

According to another further embodiment, the inventive method may include identifying and labeling, according to the player's position, preferably feet position, on the court in a numbered segment, box or colored area of the outline, each racquet stroke of the player that resulted in a ball landing in a numbered segment, box or colored on the side of the court opposite the player, e.g., of the outline. The inventive method according to an embodiment, preferably includes grouping, according to the position of the player in a numbered segment or box of the outline for subsequent display to the player, the portions of the recording of the player's racquet strokes that resulted in a ball landing in a “desired” numbered segment or box on the side of the court opposite the player of the outline.

According to a further preferred embodiment, the present invention may include overlaying the number-segmented/boxed outline of a tennis court over the tennis court of the recorded match of each portion in the video recording wherein the identified and labelled racquet strokes of the player that resulted in a ball landing in a “desired” target ball placement numbered segment or box on the side of the court opposite the player of the outline. The present inventive method may further comprise grouping, for subsequent display to the player, e.g., remote display, of the overlaid video portions of the racquet strokes of the player from a specific numbered foot location segment or box that resulted in a ball landing in a “desired” numbered target ball placement segment or box on the side of the court opposite the player of the outline or diagram. The inventive method preferably further comprises labelling as “desired” for subsequent display, e.g., remote display, to the player, the grouping of the overlaid portions of the video recording wherein racquet strokes of the player that resulted in a ball landing in a “desired” target ball placement numbered segment or box on the side of the court opposite the player of the outline or diagram and preferably storing the groupings of the overlaid portions of the video recording on a storage device or transmitting the same to an analyzer. Preferably, according to another embodiment, the present invention may include transmitting or communicating or granting access to the video portion grouping to the player for display, including remote display, to and training of the player.

According to a further embodiment, the method may further comprise assigning a color code to each numbered segment of the outline; grouping, for subsequent display, e.g., remote display, to the player, the overlaid video recording portions of the racquet strokes of the player from a specific numbered segment that resulted in a ball not landing in a desired numbered segment on the side of the court opposite the player of the outline; and/or another video camera mount and video camera for making of a second or more recording other angles viewing the court. According to a particularly preferred embodiment, the present inventive method may comprise an analyzer that includes additional cameras, a processor and software for categorizing, labelling and grouping during play back, each racquet stroke of the player during a match.

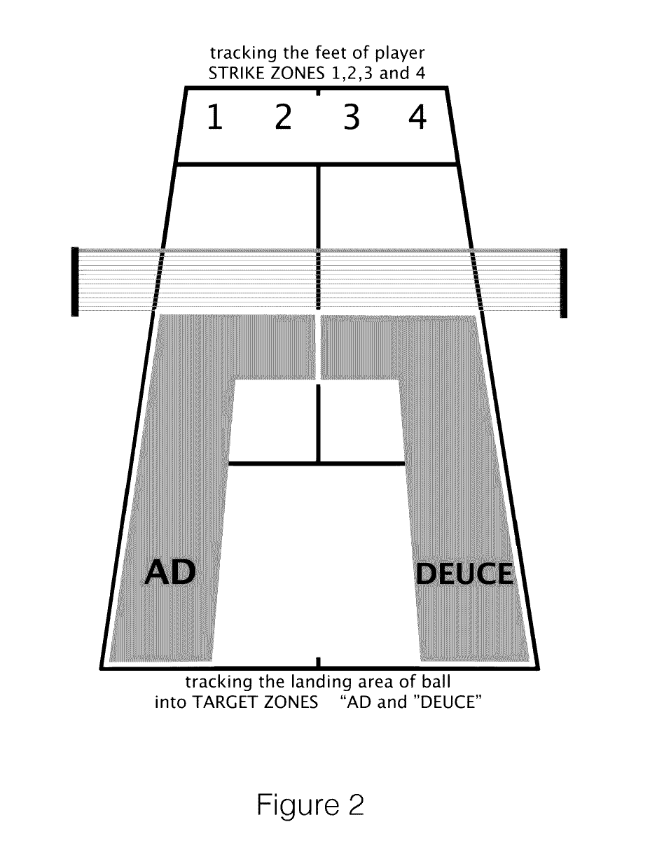

According to another embodiment, the present inventive method is directed to the training of a player, preferably the remote training of a player, based upon the recorded location of a player on a tennis court. According to this embodiment, the present inventive method may comprise training a player wherein the player is located within about 1 to about 10 feet inside the baseline of the tennis court. Preferably, according to an embodiment, the present invention may comprise partitioning and outlining a tennis court opposite the side of a player to be trained into an upside down U-shaped segment extending (i) the entire width of the court in front of the net and for about 5 to about 7 feet away from the net, and (ii) down the side boundaries of the court extending from the boundaries into the court about 5 to about 7 feet on both sides of the tennis court. See for example, FIG. 2. Note, the upside down U-shaped segment may also be thought of as two upside down inwardly facing Ls. See, e.g., FIG. 2.

According to a preferred embodiment, the present inventive method may include partitioning and outlining the area inside of and contiguous with the baseline of the tennis court extending the width of the court on the side of a player to be trained into a single segment. See, for example, FIG. 2. The present inventive method may comprise assigning the upside down u-shaped segment on the side of the court opposite the player to be trained for a ball struck by the player to land in light of the location of the player during the racquet stroke in the single segment of the outline as a “desired target ball placement” segment or box.

Preferably, according to an aspect of the present invention, an elevated mount for a video camera is positioned over a tennis court at a location for recording a tennis match and the tennis racquet strokes of a player to be trained and positioning a video camera in the elevated mount. According to a preferred embodiment, a storage device is provided for storing a recording made with the mounted video camera of (i) the player's court location during different racquet strokes of the player during the match, and (ii) the landing location of balls struck by the player in the court opposite the player.

The present inventive method includes video recording, e.g., with the elevated and mounted video camera, a live tennis match of a player and storing the video recording of the player's match on the storage device. According to a further embodiment, the present invention may include transmitting, communicating or providing access to the stored recording of the player's tennis match to an analyzer, preferably remote from the tennis match location. According to a particularly preferred embodiment, the present invention may include playing back the video recording of the tennis match for the analyzer at a location remote from the match and categorizing, during play back, each racquet stroke of the player based upon (i) the player's position on the court in the single segment, and (ii) the resulting landing location of each ball struck by the player in the “desired” upside down u-shaped segment on the side of the tennis court opposite the player of the outline. Preferably, according to another embodiment, the present invention includes identifying and labeling, according to the player's position on the court in the single segment of the outline, each racquet stroke of the player that resulted in a ball landing in the “desired” upside down u-shaped segment on the side of the court opposite the player of the outline.

According to yet a further embodiment, the present invention includes grouping, according to the position of the player in the single segment of the outline for subsequent display to the player, the portions of the recording of the player's racquet strokes that resulted in a ball landing in the “desired” upside down u-shaped segment on the side of the court opposite the player of the outline. According to a preferred embodiment, the present invention comprises overlaying the segmented outline of a tennis court over the tennis court of the recorded match of each portion in the video recording the identified and labelled racquet strokes of the player that resulted in a ball landing in the desired upside down u-shaped segment on the side of the court opposite the player of the outline.

In accordance with a further embodiment, the present inventive method comprises grouping, for subsequent remote display to the player, the overlaid video portions of the player's racquet strokes from the single segment that resulted in a ball landing in the “desired” upside down u-shaped segment on the side of the court opposite the player of the outline. Preferably, according to some embodiments, the present inventive method includes labelling as “desired” for subsequent display to the player, the grouping of the overlaid portions of the video recording wherein racquet strokes of the player from the single segment of the outline resulted in a ball landing in the desired upside down u-shaped segment on the side of the court opposite the player of the outline. Preferably, storing the groupings of the overlaid portions of the video recording on a storage device and transmitting or providing access to the video portion grouping to the player for display to the player and training of the player, preferably for remote display and remote training of the player.

According to a further embodiment, the method may further comprise assigning a color code to the single segment and the upside down u-shaped segment of the outline; grouping, for subsequent remote display to the player, the overlaid video recording portions of the racquet strokes of the player from the single segment that resulted in a ball not landing in the desired upside down u-shaped segment on the side of the court opposite the player of the outline; and/or another video camera mount and video camera for making a second recording from another angle viewing the court. According to a particularly preferred embodiment, the present inventive method may comprise an analyzer that includes additional cameras at the court, a processor and software for categorizing, labelling and grouping during play back, each racquet stroke of the player during a match.

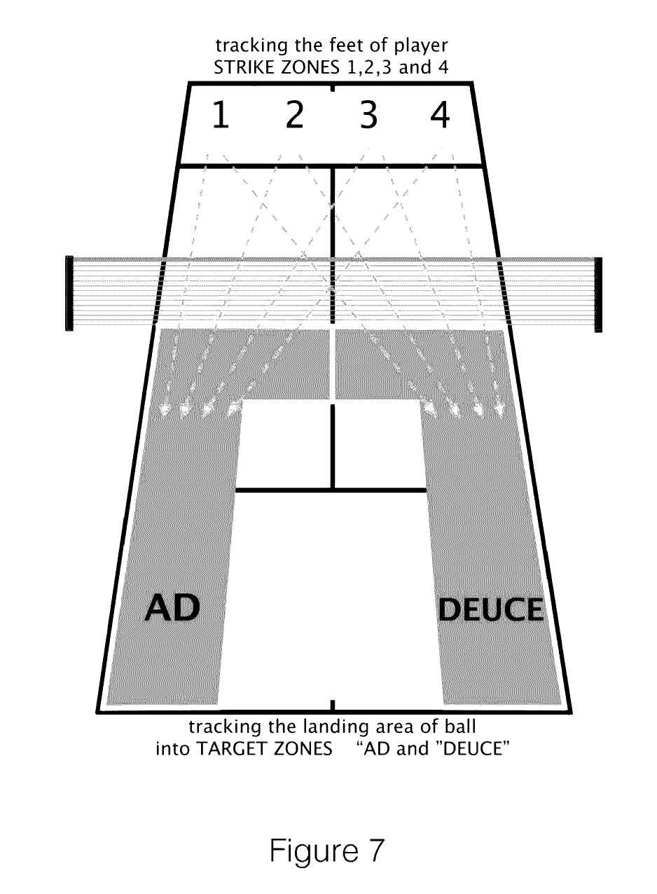

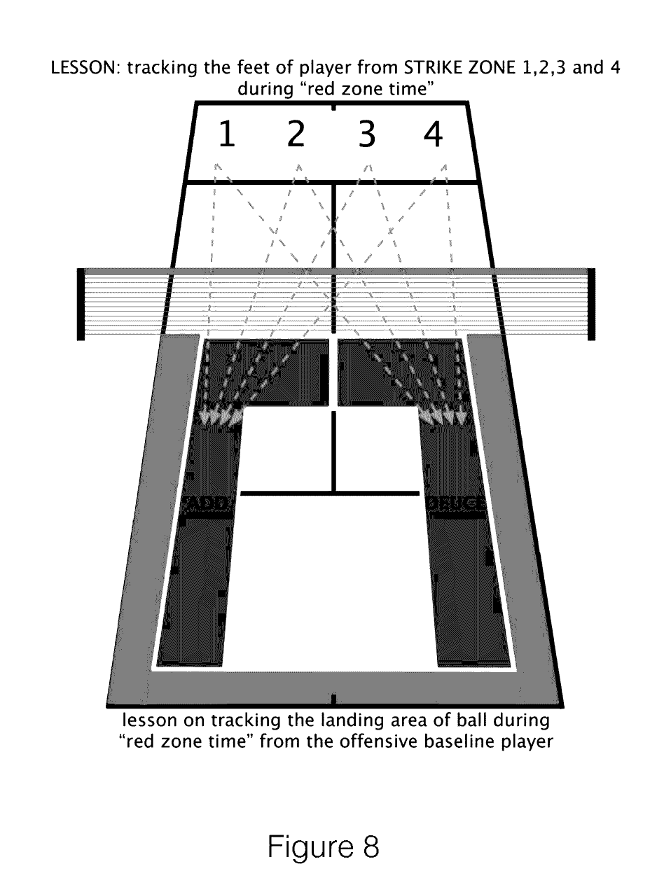

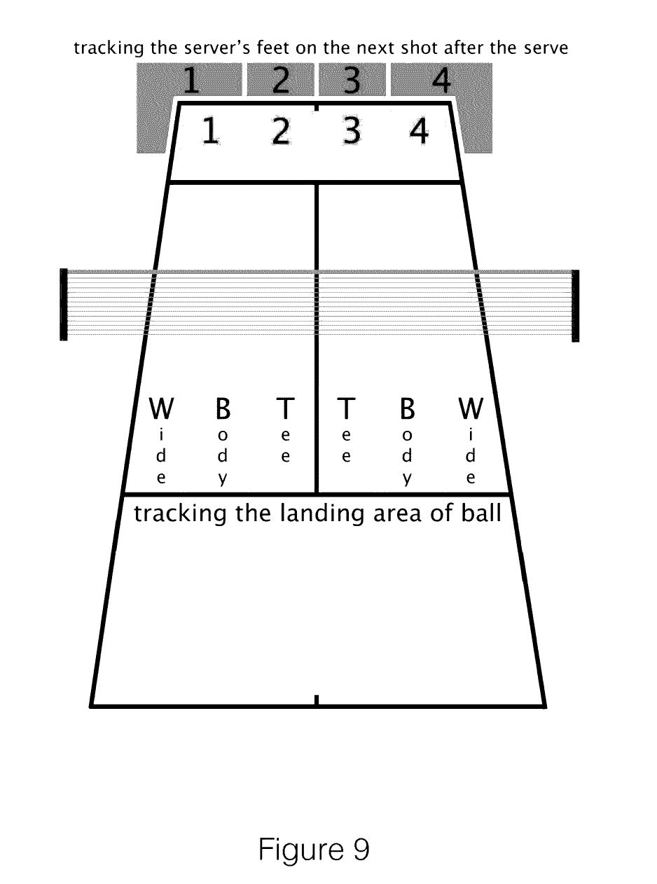

According to further embodiments, the method as described above is basically the same however, these embodiments may comprise partitioning a court into non-numbered colored segments to form an outline. See, for example, FIGS. 2 and 7 and 8. According to further embodiments the methods of the present disclosure may comprise partitioning the court into lettered segments to form an outline. See, for example, FIG. 9. According to still further embodiments, the invention includes methods that may comprise partitioning the court and areas contiguous with the court into numbered and lettered segments to form an outline. See, for example, FIG. 9. And finally, the invention may comprise partitioning a court and areas contiguous with the court into numbered, lettered and/or colored segments. See, for example, also FIG. 9.

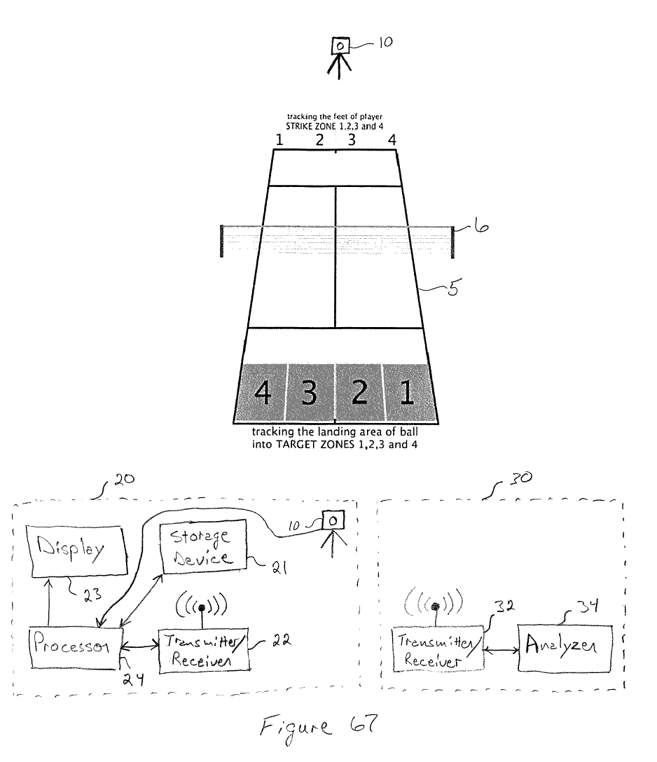

Referring to FIG. 67, a system of the present invention is shown. A camera 10 is positioned near the tennis court 5 so as to capture the field of play. In particular, the camera is positioned behind one of the baselines, along a line that splits the left and right sides of the tennis court 5, as shown in FIG. 67. The system of the present invention comprises a local system 20, and a remote system 30. The local system 20 comprises a camera 10, a storage device 21, a transmitter/receiver 22 and a display 23. The remote system 30 comprises a transmitter/receiver 32 and an analyzer 34. Via the camera 10 and the storage device 21, a video recording may be made of a tennis match between two or more tennis players. The video recording may be communicated from the storage device 21 to the transmitter/receiver 22 for transmission to the transmitter/receiver 32 of the remote system 30. The video recording may then be communicated to the analyzer 34, which segments the video into video clips of the tennis stroke/return sequences, tracks the motion of the players and ball, groups stroke/return sequences statistically, and annotates the video clips. The analyzer 34 compiles the annotated video clips and statistical information into a feedback display. The analyzer 34 then communicates the feedback display to the transmitter/receiver 32 for transmission to the transmitter/receiver 22 of the local system 20. The feedback display may then be stored on the storage device 21 and displayed on the display 23.

The local system 20 may be a device that has a camera, storage, and transmitter/receiver capabilities. The local device 20 may comprise any type of portable or mobile electronics device, such as for example a smartphone, a cell phone, a mobile telephone, personal digital assistant (PDA), laptop computer, tablet-style computer, or any other portable electronics device. For example, in some embodiments, local device 20 may be a smart phone, such as an iPhone by Apple Inc. or an Android by Google, or a phone using an Ios, Android, Microsoft, or Symbian operating system (OS), for example. In some embodiments, mobile device 10 may be a tablet, such as an iPad by Apple, Inc., a Galaxy by Samsung, or Eee Pad Transformer by ASUS, and Latitude ST Tablet PC by Dell, for example.

The local system 20 may further comprise an Tennis Application or APP downloaded from the App Store by Apple, Inc.

The local system 20 may further comprise a storage device 21 may store the Tennis Recording Application, as discussed below. In some embodiments, storage device 21 may comprise any one or more devices suitable for storing electronic data, e.g., RAM, DRAM, ROM, internal flash memory, external flash memory cards (e.g., Multi Media Card (MMC), Reduced-Size MMC (RS-MMC), Secure Digital (SD), MiniSD, MicroSD, Compact Flash, Ultra Compact Flash, Sony Memory Stick, etc.), SIM memory, and/or any other type of volatile or non-volatile memory or storage device. The Tennis Application may be embodied in any combination of software, firmware, and/or any other type of computer-readable instructions.

The local system 20 may further comprise a processor 24. Processor 24 may include a microprocessor, a microcontroller, a digital signal processor (DSP), an application specific integrated controller (ASIC), electrically-programmable read-only memory (EPROM), or a field-programmable gate array (FPGA), or any other suitable processor(s), and may be generally operable to execute the Tennis Application.

The local system 20 may further comprise a display 23. Display 23 may comprise any type of display device for displaying information related to the Tennis Application, such as for example, an LCD screen (e.g., thin film transistor (TFT) LCD or super twisted nematic (STN) LCD), an organic light-emitting diode (OLED) display, or any other suitable type of display. In some embodiments, display 23 may be an interactive display (e.g., a touch screen) that allows a user to interact with the Tennis Application. In other embodiments, display 23 may be strictly a display device, such that all user input is received via other input/output devices a touch screen, physical buttons, sliders, switches, data ports, keyboard, mouse, voice activated interfaces, or any other suitable devices.

The remote system 30 may comprise an analyzer 34. The analyzer 34 may be a standard computer having processor and memory components, similar to those described about for the local device 20. The analyzer 34 may further comprise software modules for: segmenting video into stroke/return sequence video clips, analyzing the stroke/return sequence video clips to identify player positions and ball strike positions, grouping the stroke/return sequence video clips statistically, annotating the stroke/return sequence video clips, and preparing a feedback display.

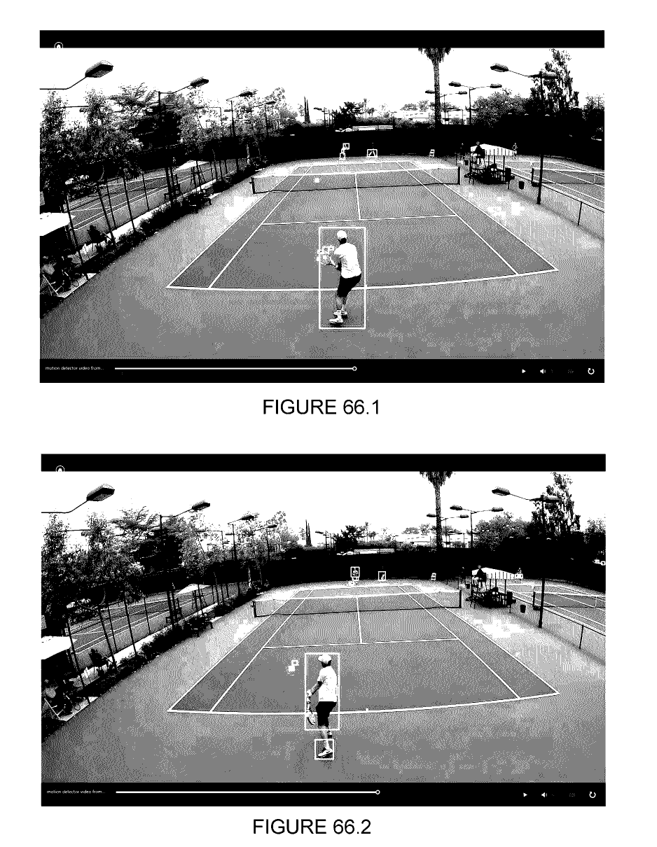

Referring to FIGS. 66.1 and 66.2, a video recording is illustrated wherein motion tracking software is shown identifying objects in motion, including the players and the ball. For example, Open CV using C++ (www.opencv.org) may be used to track motion in video. Further, Visual-Control is a program posted by Microsoft that may be used to recognize objects in a video. One method of video processing may be the method of sequential images, wherein the software: (1) sequentially reads two frames from a camera feed or video; and (2) compares the two frames to see which pixels have changed from frame to frame. As shown in FIGS. 66.1 and 66.2, the software captures both of the tennis players in motion as well as the tennis ball in motion. Additional software may identify the positions of the players to determine in which zone the players are in when they make a play on the ball. By identifying player position, the software allows statistical comparisons to be made of different stroke/return sequences played from the same zones.

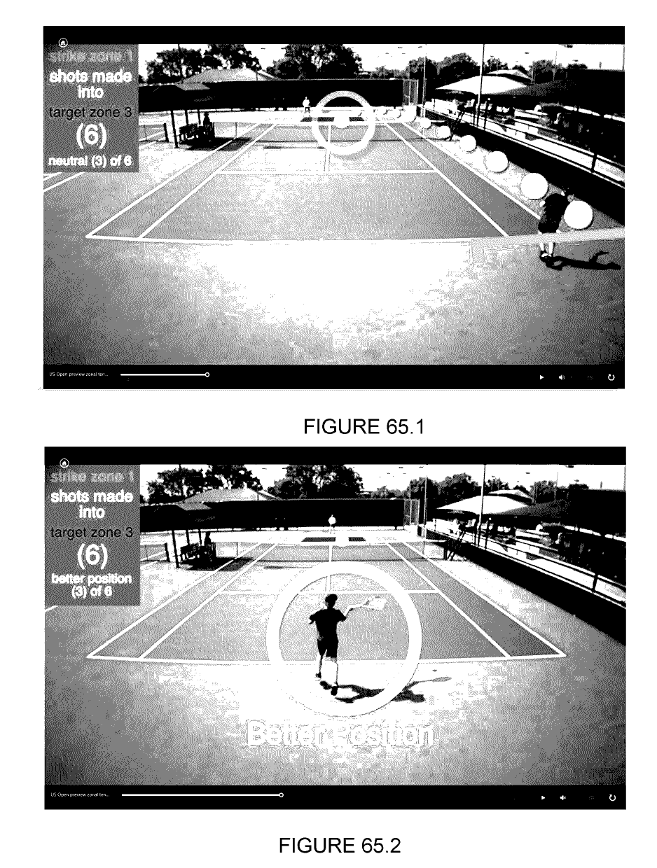

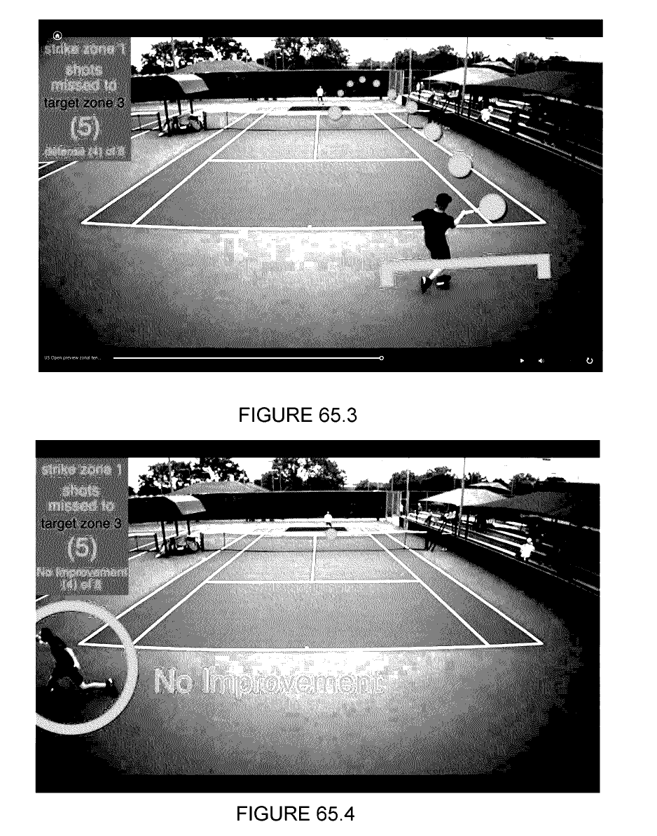

Referring to FIGS. 65.1-65.2, a video recording is illustrated wherein player position, target zones, and ball movement may be annotated directly on the video display. As shown in FIG. 65.1, the tennis player in the foreground has hit the ball from “strike zone 1,” which corresponds to “strike zone 1” illustrated in FIG. 3. FIG. 65.1 further shows that the ball is being hit into the “target zone 3.” FIG. 65.2 shows the same stroke/return sequence video clip wherein the ball has been returned from the “target zone 3” and the player is now in a “Neutral” position to strike the ball in the center of the court at the base line. The statistical analysis at the left indicates that during the tennis match, six shots were hit from “strike zone 1” into “target zone 3,” which resulted in 3 of the 6 shots being returned to a Neutral position.

Referring to FIGS. 65.3-65.4, a video recording is illustrated wherein player position, target zones, and ball movement may be annotated directly on the video display. As shown in FIG. 65.3, the tennis player in the foreground has again hit the ball from “strike zone 1,” which corresponds to “strike zone 1” illustrated in FIG. 3. FIG. 65.1 further shows that the ball is being hit short of the “target zone 3,” which allows the other player to return the ball from mid-court. FIG. 65.4 shows the same stroke/return sequence video clip wherein the ball has been returned from the mid-court position in front of “target zone 3” and the player is now in a “Defense” position to strike the ball at the left of the court well behind the base line. The statistical analysis at the left indicates that during the tennis match, five shots were hit from “strike zone 1” missing “target zone 3,” which resulted in 4 of the 5 shots being returned to a Defense position.

According to one aspect of the invention, the system provides a website to allow customers to interface with the system. This website may accommodate customer accounts so customers can log in as individuals into their private accounts, manage their billing transactions, pull up history of past lessons and watch or download this information onto a device of their choice, whether mobile or desktop. Customers may have 2 options to view all live video. Watch it on the website as it may have its own video player. Second option may be to download the video into a converted file format of their choice to view on their mobile or PC or Mac device and have their own hardcopy. The website may offer filters and searching options for the customer to view only parts of the video or data of their choice. The website may also provide a place for social interaction to share information between other customers and tennis pro staff. The website may provide marketing links to Facebook, Twitter, etc. The website may provide active tabs or hyperlinks to pages or windows for: website/upload; video/download; video/customer; login/subscription; packages/lessons/history archiving/billing/payments/invoices/receipts . . . etc. Through the web site, the customer may upload their video from their digital device. The system then processes the uploaded video from the customer either in a real-time or in batch. The system may then send back an email to confirm receipt of the uploaded video.

Alternatively, the customer interface may comprise a Tennis Application or APP downloaded from the App Store by Apple, Inc., for example.

The system comprises computer software for analyzing a video recording of a tennis match between tennis players. The software looks at the video, and then breaks it apart into video clips comprising stroke/return sequence segments. First, the software finds the corners of the tennis court in the video recording, and second it finds the lines of the tennis court in the video recording. To locate these points and lines, the system software may use color differences. In the digital world, color differences may be called “color pixels.” The software may differentiate between the colors on the court and in tennis most of the time the outside color is different then the inside color of the court. The lines are typically white and the lines will set up the boundaries of the tennis court. The software system may look for a rectangular shape tennis court.

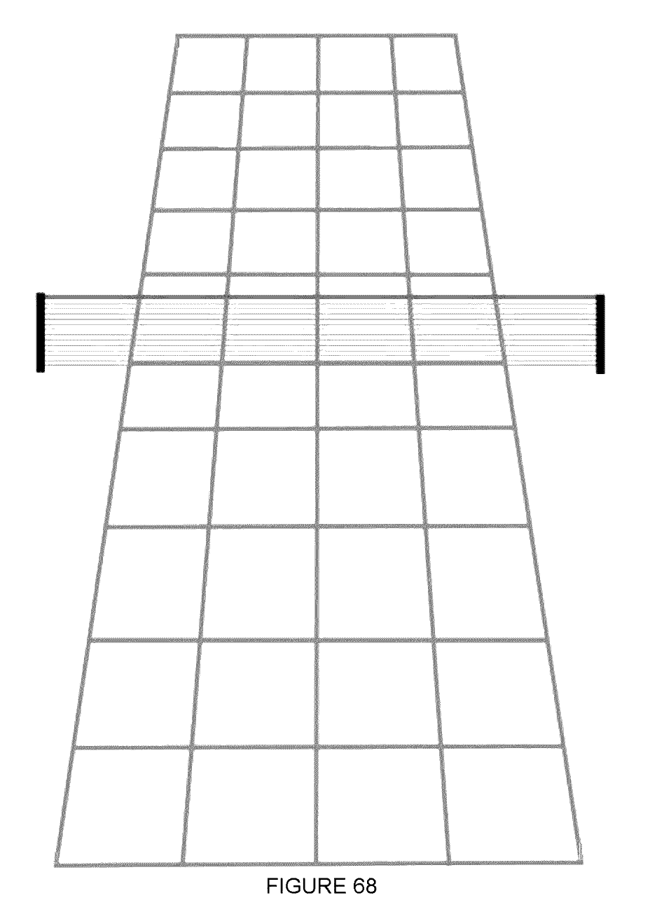

Once the software has identified and located the tennis court in the recorded video, the software divides the court into and 4×5 block grid on each side of the net. In tennis terms, 5 blocks: 2 service blocks, 1 baseline block, 2 doubles alley blocks on either side of the two service blocks and the baseline block. These boundaries will show the software the divisions of the court. Parameters are now set and outlined relative to the court in the recorded video that was uploaded. Now that the court size and the software linked up, this software may break up the surface of the court into layered blocks in the form of “grids” as shown in FIG. 68. This grid sample is how the software will detect where the movement or location of the ball, which the software may track during its movement or flight.

FIG. 1 provides an example of how the the grids may match the zones for a tennis lesson. The software assigns a block grid to take on the same contour of the zones that were assigned for the specific lesson that is being used. The software may now track movement of the ball via moving pixels of color of the ball, frame by frame of where the ball is going or coming.

The place where the ball was hit from we will call the strike zone. The place where the ball is going to is called the target zone. Software will track the trajectory of the ball flight going from strike zone to target zone. The software identifies a starting point of the ball at a contact point with the racket in the strike zone. The software expects the ball to be at another place very soon because the trajectory will not change that quickly when ball is in flight. The software may anticipate a constant movement in a specific direction unless something hits or redirects the ball direction and flight path. The software may expect the ball to be in a specific place a few frames further ahead very soon because of speed. A moving object does not change its trajectory unless something forces it to change. By breaking the court up in grids, this software may track the movement frame by frame and collect the information by knowing where the ball movement is over the blocks of the grid.

The software may track when the ball is in movement/flight. The software of will accumulate the data on the movement of the ball as follows: (1) start at the frame where the ball was hit from (player 1) called the strike zone; (2) frame where ball landed on the opposite side of the court; (3) frame from where opponent (player 2) hit the ball; (4) frame where that ball lands on (player 1) side; (5) frame where (player 1) hit again. All these frames may be linked to the assigned grid to locate/identify the position of the ball, as it moves over the specific zone. FIGS. 65.1 through 65.4 illustrate this process, wherein player 1 is shown in the foreground and player two is shown in the background on the other side of the net.

The software will detect (player 1) in strike zone 1 and it will tell the software to start collecting the frames for inclusion in a stroke/return sequence video clip. The software will know the ball is hit because of the sudden change in flight path in an opposite direction. To identify a change in flight path, the software will constantly determine a trajectory of the tennis ball by comparing a certain number of consecutive video frames, for example 5 frames. The position of the tennis ball in the next consecutive frame is then compared to the trajectory. If the tennis ball is within a certain distance of the projected trajectory, the software will assume the tennis ball has not made contact with anything and will recalculate a projected trajectory based on the current consecutive video frames. If the position of the tennis ball is outside a certain distance from the projected trajectory, the software will assume the tennis ball has positively made contact with something (court, net, racket, etc.) and has changed its flight path. At this stage the software will assign the following information to that frame at the contact point:

1) go back 60 frames and layer the blue target zones on top of the court on the opposite side of the court (the timing of when the blue target zones should appear is similar to when a tennis player will have to know what he/she wants to do with the oncoming ball and also where he/she wants to hit that ball towards the opposite side of the court. (See FIG. 65.1). This usually appears when the opponent's ball crosses the net, coming towards you.

2) freeze (player 1) for 2 seconds and assign a bracket around his/her feet to indicate to the player that he/she is inside the strike zone of the tennis lesson he/she wanted to learn from. (see FIG. 65.1). The particular lesson indicated that this is a “danger” strike zone so RED color was the appropriate color to identify the strike zone.

As the ball travels towards the opposite side of the court the software will memorize the flight path of the ball until the ball changes its trajectory to indicated to the software that the ball: (a) hit the net; (b) bounced on the court; or (c) was hit by the opponent through the air, without bouncing on the other side. The software saves the frames of the recorded video for the above section of the ball's flight. At this stage the color will not be assigned to the dots yet as the software will not know whether the ball landed into the assigned target zones. It will only track the flight path frame by frame. It will sort this ball's flight into a time code of 2 seconds so it would fit into the time slot that was assigned when player 1 that hit the ball was frozen for the 2 seconds, i.e., the video is frozen for the 2 seconds.

As the ball lands on the opposite side of the court the software will track whether the ball landed into the assigned blue target zones. If the ball did land in the blue target zones and as it landed the software saved that frame and assigned the following information to that frame: (a) green dot to indicate where the ball has landed; and (b) green dots to the ball flight from when the ball was struck from strike zone 1 till ball landed at the above frame. (See FIG. 65.1). The software will keep track of the movement of that ball coming back towards player 1 and freeze player 1 again for 2 seconds. At this frame the software will indicate whether the player improved his/her return position or not. As shown in FIG. 65.2, because player 1 hit the ball into the assigned blue target zones and returned to a better return position, the software annotates the video stroke/return sequence clip with a green circle around player land indicates “Better Position.”

If the ball did not land in the blue target zones and as it landed the software saved that frame and assigned the following information to that frame: (a) red dot to indicate where the ball has landed; and (b) red dots to the ball flight from when the ball was struck from strike zone 1 till ball landed at the above frame. (See FIG. 65.3). The software will keep track of the movement of that ball coming back towards player 1 and freeze player 1 again for 2 seconds. At this frame the software will indicate whether the player improved his/her return position or not. As shown in FIG. 65.4, because player 1 missed hitting the ball into the assigned blue target zones and was not able to return to a better return position, the software annotates the video stroke/return sequence clip with a red circle around player 1 and indicates “No Improvement.”

The software stored stroke/return sequences video clips from a recorded video of a tennis match. The software further collects statistical data from the video clips. Examples of data that may be collected by the software include: how many times the player reaches the STRIKE ZONES, how many shots from that STRIKE ZONE reached the designated TARGET ZONES in BLUE, how many shots were missed from that STRIKE ZONE, how many times did the player's position improved on his/her next shot when he/she did and did not hit into the TARGET BLUE ZONES.

A tabulation of percentages together with live video to demonstrate these collective data is what the software is accumulating behind the scenes.

The software may track every time the above occurs and make comparisons by tabulating all the stats/data against the player's shot selection during the video with and without trying to play how the lesson suggests. Software will also compare the above information against other players and archive all this data.

The value of these stats/data is to show improvement or not and to compare how it stacks up against other players of similar skill level. After everything is turned out into stats/data, a recommendation may then be supplied to the customer on how he/she can improve tennis performance. The system comprises a software/robot with certain rules assigned by tennis lessons to get the player to adhere to the rules, which we teach them when they upload a video.

The software automatically detects and tracks a change in trajectory of the tennis ball. A program takes the uploaded video and compare the current frame to the last five frames. The software compares frame six with frames 5, 4, 3, 2, 1, and makes a logical analysis by constantly making comparisons of the previous five frames against the current frame. The software figures out where the ball is, based on the information of the frame it's getting from the X and Y coordinates. It knows the position of that change within the video file, so when the software creates the grid that it overlays on top of the court, it will pin point the position according to the X and Y coordinates. Software will realize where and when there was a change, an unexpected change, because of at different trajectory, because the frame will deviate from its expected path on the X and Y coordinates. A ball will not change drastically its path when it is in flight. Thus, the software may detect when the tennis ball is in flight through the air versus when it has bounced on the court or been hit by a racket.

The software may handle bad video quality where the tennis court lines in the recorded video of a tennis match might not be clear, for example, faded lines. A tennis court corners will not have lines going passed each other because it's always a rectangular box shape. To establish the boundaries of a tennis court automatically for the software will be quite easy as the shape (rectangular) of at tennis court will be set the same mostly with no big drastic changes. Court will never be square or round and boundaries will always be longer top to bottom then side to side. The amount of grids that this software will use will have the option of being independent of the lesson zones called strike zones and targets zones that are defined by the lessons, but could be used in tandem if needed for motion tracking. These grids may or may not be the same size and can be adjusted to compliment the lessons for incorporation in the software.

The software may also track the motion of the players. The software may detect color pixels on the player being tracked and will have the choice when the player hits his 2nd shot, to show us if he's position has improved, by turning him into a red or green colored silhouette. A green silhouette indicates the player has improvement from his/her previous position and red indicates no improvement.

Each tennis lesson will create its own strike zones and landing zones with different locations and sizes. The software will create its own layered blocks called grids, to match these zones that were created by the tennis lesson. The tennis lessons will declare the variables/parameters for these lessons by telling the software how big the zones will be and also the positions of the zones. The software will generate the grid based off the instructions of the tennis lesson's positional zones and sizes of the zones. The grids will match the zones. The software will break up the court within the training program/lessons that is specific to whatever the lesson is teach/tracking. The software program may accept whatever parameters or rules that the training program requires, so that the system may be really flexible for any training program.

Imaginary layer blocks would be developed and overlaid on the court and adjust to the lesson for sizes to create size and location.

Although the disclosed embodiments are described in detail in the present disclosure, it should be understood that various changes, substitutions and alterations can be made to the embodiments without departing from their spirit and scope.

What is claimed is:

1. A method for the training of a player based upon recorded player court location, said method comprising:
partitioning a tennis court opposite a side of a player to be trained into different target ball placement segments and an area outside of and contiguous with the baseline of a tennis court on a side of a player to be trained into different feet location segments to form an outline or diagram;
assigning as desired target ball placement segments on the outline or diagram of the side of the court opposite the player to be trained in which a ball struck by the player lands in light of the location of the player during the racquet stroke in a feet location segment of the outline or diagram;
positioning at least one video camera in view of a tennis court at a location for recording a tennis match of a player to be trained, the match including multiple racquet strokes by the player to be trained;
providing at least one storage device in communication with the video camera for storing at least one video recording made with the at least video camera of (i) the player's court location in a feet location segment during different racquet strokes of the player during the match, and (ii) the landing location of balls struck by the player in a target ball placement segment in the court opposite the player;
video recording with the at least video camera a live tennis match of the player to be trained;
storing the video recording of the player's match on the at least one storage device;
communicating the recording of the player's tennis match to an analyzer;
playing back the video recording of the tennis match for the analyzer;
categorizing, during play back, each racquet stroke of the player based upon
(i) the player's location in a feet location segment of the outline or diagram, and
(ii) the resulting landing location of each ball struck by the player in a target ball placement segment on the side of the tennis court opposite the player on the outline or diagram;
identifying and labeling, according to the player's location in a feet location segment of the outline or diagram, each racquet stroke of the player that resulted in a ball landing in a target ball placement segment on the side of the court opposite the player on the outline or diagram;
grouping, according to the location of the player in a feet location segment of the outline or diagram for subsequent display to the player, the portions of the video recording of the player's racquet strokes that resulted in a ball landing in a desired target ball placement segment on the side of the court opposite the player of the outline or diagram;
optionally, overlaying the segmented outline or diagram of a tennis court over the tennis court in the recorded match of each portion in the video recording wherein the identified and labelled racquet strokes of the player that resulted in a ball landing in a desired target ball placement segment on the side of the court opposite the player on the outline or diagram;
optionally, grouping, for subsequent display to the player, the video portions of the racquet strokes of the player from a specific feet location segment of the outline or diagram that did not result in a ball landing in a desired target ball placement segment on the side of the court opposite the player of the outline or diagram;
labelling as desired shots for subsequent display to the player, the grouping of the portions of the video recording wherein racquet strokes of the player resulted in a ball landing in a desired target ball placement segment on the side of the court opposite the player of the outline or diagram;
storing the groupings of the portions of the video recording on a storage device; and
transmitting or providing access to the video portion grouping to the player for display to the player and training of the player.

2. The method of claim 1, further comprising assigning a number, a color code, or both to each segment.

3. The method of claim 1, further comprising grouping, for subsequent display to the player, the overlaid video recording portions of the racquet strokes of the player from a specific feet location segment that resulted in a ball not landing in a desired target ball placement segment on the side of the court opposite the player of the outline.

4. The method of claim 1, wherein the analyzer comprises software for categorizing, during play back, each racquet stroke of the player originating from a feet location segment.

5. The method of claim 1, wherein the area outside of and contiguous with the baseline of the tennis court on the side of a player to be trained is partitioned into at least four different numbered or colored segments.

6. The method of claim 1, wherein the outline or diagram gives the player to be trained access to video clips of every shot taken by the player from a given feet location segment during the player's recorded match resulting in a ball landing in a desired target ball placement segment in the opposite court while overlaying the outline or diagram of the court with the segments on the actual video footage of the player's shots taken during the match from a given feet location segment to a desired target ball placement segment in the court opposite the player.

7. The method of claim 1, further comprising providing the player to be trained as part of the player's training, an analysis of the player's recorded match including tracking and reporting the number of balls struck by the player from a feet location segment that resulted in a ball landing in a desired target ball placement segment or not landing in a desired target ball placement segment.

8. The method of claim 1, further comprising the capability to give a player access to the video playback of each of the player's shots from a given feet location segment by selecting a number on a display representing the number of shots by the player during the recorded match from a given feet location segment.

9. The method of claim 1, further comprising the capability to give a player access to the video playback of each of the player's shots from a given feet location segment by selecting a number on a display representing the number of shots by the player during the recorded match from a given feet location segment that resulted in a ball landing in a desired target ball placement segment.

10. A method for the training of a player based upon recorded player court location, said method comprising:
partitioning a tennis court opposite the side of a player to be trained into an upside down U-shaped target ball placement segment extending (i) the entire width of the court in front of the net extending from about 5 to 7 feet away from the net, and (ii) down the side boundaries of the court extending from the boundaries into the court from about 5 to about 7 feet, and partitioning the area inside of and contiguous with the baseline of the tennis court on the side of a player to be trained into a feet location segment to form an outline or diagram;
assigning as desired the upside down u-shaped target ball placement segment on the side of the court opposite the player to be trained for a ball struck by the player to land in light of the location of the player during the racquet stroke in a feet location segment;
positioning at least one video camera in view of a tennis court at a location for recording a tennis match of a player to be trained, the match including multiple racquet strokes by the player to be trained;
providing at least one storage device in communication with the video camera for storing at least one recording made with the at least one video camera of (i) the player's court location in a feet location segment during different racquet strokes of the player during the match, and (ii) the landing location of balls struck by the player in the court opposite the player in the upside down u-shaped target ball placement segment;
video recording with the at least one video camera a live tennis match of the player;
storing the video recording of the player's match on the storage device;
transmitting, communicating or providing access to the stored recording of the player's tennis match to an analyzer;
playing back the video recording of the tennis match for the analyzer;
categorizing, during play back, each racquet stroke of the player based upon
(i) the player's position on the court in a feet location segment of the outline or diagram, and
(ii) the resulting landing location of each ball struck by the player in the upside down u-shaped target ball placement segment on the side of the tennis court opposite the player of the outline or diagram;
identifying and labeling, according to the player's location in a feet location segment of the outline, each racquet stroke of the player that resulted in a ball landing in the upside down u-shaped target ball placement segment on the side of the court opposite the player of the outline;
grouping, according to the location of the player in a feet location segment of the outline for subsequent display to the player, the portions of the recording of the player's racquet strokes that resulted in a ball landing in the upside down u-shaped target ball placement segment on the side of the court opposite the player of the outline;
optionally, overlaying the segmented outline of a tennis court over the tennis court of the recorded match of each portion in the video recording wherein the identified and labelled racquet strokes of the player that resulted in a ball landing in the desired upside down u-shaped target ball placement segment on the side of the court opposite the player of the outline;
optionally, grouping, for subsequent display to the player, the overlaid video portions of the racquet strokes of the player from the feet location segment of the outline that resulted in a ball not landing in the desired upside down u-shaped target ball placement segment on the side of the court opposite the player of the outline;
labelling as desired for subsequent display to the player, the grouping of the portions of the video recording wherein racquet strokes of the player from the feet location segment of the outline resulting in a ball landing in the desired upside down u-shaped target ball placement segment on the side of the court opposite the player of the outline;
storing the groupings of the overlaid portions of the video recording on a storage device; and
transmitting, communicating or providing access to the video portion grouping to the player for display to the player and training of the player.

11. The method of claim 10, further comprising assigning a number, a color code, or both to each segment of the outline.

12. The method of claim 10, further comprising grouping, for subsequent display to the player, the overlaid video recording portions of the racquet strokes of the player from a feet location segment of the outline that resulted in a ball not landing in the desired upside down U-shaped target ball placement segment on the side of the court opposite the player of the outline.

13. The method of claim 10, wherein the analyzer comprises software for categorizing during play back, each racquet stroke of the player.

14. The method of claim 10, further comprising the capability to give a player access to the video playback of each of the player's shots from a given feet location segment by selecting a number on a display representing the number of shots by the player during the recorded match from a given feet location segment.

15. The method of claim 10, further comprising the capability to give a player access to the video playback of each of the player's shots from a given feet location segment by selecting a number on a display representing the number of shots by the player during the recorded match from a given feet location segment that resulted in a ball landing in the desired target ball placement segment.

16. The method of claim 10, wherein the lesson strategy received by the player includes an outline or diagram of the court including the total number of shots taken by a player from a given feet location segment.

17. The method of claim 10, wherein the outline or diagram gives the player to be trained access to video clips of every shot taken by the player from a given feet location segment during the player's recorded match resulting in a ball landing in a desired target ball placement segment in the opposite court from the player.

18. A method for the remote training of a player based upon the player's recorded feet location in or outside of a tennis court, said remote training method comprising:
positioning a handheld device in view of a tennis court at a location behind a baseline of the tennis court for recording a tennis match of the player to be trained, the recording including multiple stroke/return sequences between players, the handheld device including: a non-transitory computer readable media having stored thereon a tennis training application, a camera, a touch screen display, and a processor, wherein said processor upon execution of the processing application is configured for:
video recording with the camera tennis stroke/return sequences by the player to be trained;
storing the video recording on the non-transitory computer readable media;
communicating the recording of the player's tennis match to an analyzer;
displaying on the display a feedback video received from the analyzer;
connecting the analyzer in telecommunication with the handheld device, wherein the analyzer includes: a non-transitory computer readable media having stored thereon analyzing software, and a processor, wherein said processor upon execution of the analyzing software is configured for:
identifying the tennis court lines in the video recording to partition the tennis court opposite a side of a player to be trained into different desired target ball placement segments to form a court outline or diagram, and to partition the tennis court on a side of the player to be trained into either (1) different numbered player feet location segments located in an area outside of and contiguous with the baseline of the tennis court, or (2) different numbered player feet location segments located inside of and contiguous with the baseline of the court to form a court outline or diagram;
tracking movement of the tennis ball in the video recording to identify locations in the video recording where the tennis ball has changed direction from a trajectory path caused by a player striking the tennis ball or the tennis ball bouncing off the court;
cutting the video recording into stroke/return sequence clips based on when a player strikes the tennis ball;
identifying and labeling, according to the player's location segment of the court outline or diagram, each racquet stroke of the player that resulted in a ball landing in a desired target ball placement segment on the side of the court opposite the player on the court outline or diagram;
grouping, according to the location of the player in a feet location segment of the outline or diagram for subsequent display to the player, the portions of the video recording of the player's racquet strokes that resulted in a ball landing in a desired target ball placement segment on the side of the court opposite the player of the outline or diagram;
overlaying the segmented court outline or diagram of the tennis court over each portion in the video recording wherein the identified and labelled racquet strokes of the player resulted in a ball landing in a desired target ball placement segment on the side of the court opposite the player on the court outline or diagram;
annotating the trajectory of the tennis ball during separate video clips;
generating a feedback video comprising multiple video clips comprising overlaid target ball placement segments, annotated trajectories, and grouping statistics; and
transmitting the feedback video to the handheld device.

19. The method of claim 18, wherein the tracking movement of the tennis ball in the video recording comprises:
determining a trajectory of the tennis ball by comparing the positions of the tennis ball in consecutive video frames;
projecting a trajectory of the tennis ball to an expected position based on the determined trajectory; and
comparing the actual position of the tennis ball in the next consecutive frame to the projected trajectory, wherein if the actual position of the tennis ball is within a certain distance of the projected trajectory a determination is made that the tennis ball has not changed direction from the trajectory path, wherein if the actual position of the tennis ball is beyond a certain distance of the projected trajectory a determination is made that the tennis ball has changed direction from the trajectory path.
